(19) United States
(12) Patent Application Publication
(10) Pub. No.: US 2013/0184456 A1
(43) Pub. Date: Jul. 18, 2013

(54) HETEROCYCLIC MACROCYCLE TEMPLATED METAL-ORGANIC MATERIALS

(71) Applicants: Michael John ZAWOROTKO, Tampa, FL (US); Zhenjie Zhang, Tampa, FL (US); Randy W. Larsen, Tampa, FL (US); Mohamed Eddaoudi, Tampa, FL (US); Linping Zhang, Tampa, FL (US); Lukasz Wojtas, Tampa, FL (US)

(72) Inventors: Michael John ZAWOROTKO, Tampa, FL (US); Zhenjie Zhang, Tampa, FL (US); Randy W. Larsen, Tampa, FL (US); Mohamed Eddaoudi, Tampa, FL (US); Linping Zhang, Tampa, FL (US); Lukasz Wojtas, Tampa, FL (US)

(73) Assignee: UNIVERSITY OF SOUTH FLORIDA, Tampa, FL (US)

(21) Appl. No.: 13/528,136

(22) Filed: Jun. 20, 2012

Related U.S. Application Data
(60) Provisional application No. 61/499,140, filed on Jun. 20, 2011.

(51) Int. Cl. C07F 15/06; C07F 3/06; C07F 3/02; C07F 13/00; C07F 15/04; C07F 3/08; C07F 15/02

(52) U.S. Cl. CPC C07F 15/065; C07F 3/08; C07F 3/06; C07F 15/025; C07F 13/005; C07F 15/045; C07F 3/02
USPC 540/145

(57) ABSTRACT

A process for the preparation of a heterocyclic macrocycle-templated supramolecular metal organic material, the process comprising preparing a reaction mixture containing a metal, a heterocyclic macrocycle, and organic ligands and forming, in the reaction mixture, a heterocyclic macrocycle-templated metal organic material comprising the metal, the heterocyclic macrocycle and the ligands by template-directed synthesis with the heterocyclic macrocycle serving as the template and being encapsulated within a cage of the template metal organic material.

### CROSS REFERENCE TO RELATED APPLICATIONS

This application claims priority to U.S. Provisional Application Ser. No. 61/499,140, filed Jun. 20, 2011 and additionally claims priority to U.S. application Ser. No. 13/412,308, filed Mar. 5, 2012, which claims priority to U.S. Provisional Application No. 61/448,974, filed Mar. 3, 2011, each of which is incorporated herein by reference in its entirety.

### FIELD OF THE INVENTION

The present invention generally relates to supramolecular assemblies, and their modes of synthesis.

### BACKGROUND OF THE INVENTION

Porphyrins are remarkable and versatile ligands for transition metals and metalloporphyrins have found a wide range of applications in enzymatic reactions and biomimetic/industrial chemistry.¹ Metal-Organic Materials (MOMs) are comprised of metals or metal clusters (“nodes”) coordinated to multi-functional organic ligands (“linkers”)^{2,3} and they offer unparalleled levels of permanent porosity (there are numerous MOMs with BET surface areas in the 3000-6000 m²/g range).⁴ Furthermore, the modular nature of MOMs and their use of known coordination chemistry offer enormous diversity of structures⁵ and properties.⁶⁻⁸

In principle, metal-organic materials (MOMs) that are based upon polyhedral cages⁹⁻¹¹ offer excellent platforms for the development of porph@MOM heterogeneous catalytic systems since certain polyhedral MOMs contain cages with the requisite symmetry and size to accommodate a catalytic metalloporphyrin in a “ship-in-a-bottle” fashion and pores that facilitate ingress of substrate and egress of product.

Porphyrin encapsulation (as opposed to porphyrin walled MOMs prepared from custom-designed porphyrins¹²) and catalytic activity has thus far been demonstrated in only three MOMs: a discrete pillared coordination box,⁹ the prototypal¹¹ polyhedral MOM HKUST-1¹³ and a zeolitic metal-organic framework that exhibits rho-zeolite topology.¹⁴ HKUST-1 is formed via assembly of benzene-1,3,5-tricarboxylate (BTC) anions and Cu²⁺ (HKUST-1-Cu)¹¹, Zn²⁺ (HKUST-1-Zn)¹⁵, Fe²⁺/Fe³⁺ (HKUST-1-Fe)¹⁶ or Ni²⁺ (HKUST-1-Ni)¹⁷ cations, and is well-suited to serve as a platform for catalysis since its topology affords three distinct polyhedral cages capable of entrapping guest molecules. Indeed, HKUST-1-Cu selectively encapsulates polyoxometallate anions and exhibits size selective catalysis of ester hydrolysis.¹⁸ However, the number of metals that can form structures with HKUST-1 topology is rather limited because HKUST-1 is built from a “square paddlewheel” node that is not readily accessible for metals other than Cu²⁺ and Zn²⁺. Meso-tetra(N-methyl-4-pyridyl) porphine tetratosylate (TMPyP) has been widely studied as a catalyst¹⁹ and it can be encapsulated within the medium-sized octahemioctahedral cage of HKUST-1-Cu.¹³

Existing porphyrin catalysts can suffer from the following problems: homogeneous porphyrin catalysts tend not to have long lifetimes because they are reactive; heterogeneous catalysts typically exhibit low rates of reaction because reactions occur only at their surfaces; porph@MOMs were previously limited to a small set of existing MOMs that have the right type of cavity to selectively encapsulate a porphyrin molecule.

Design principles that are based upon the concepts of crystal engineering and self-assembly have recently afforded new classes of crystalline solids that possess important physical properties such as bulk magnetism or porosity. Large-scale molecular networks have been developed to encapsulate other materials and these are playing an ever-increasing role in the pharmaceutical industry and as materials for sensors, and liquid crystals. In addition, with the inclusion of metals within the structures, the large polymers formed by these crystals can possess, among other properties, catalytic, fluorescent, and magnetic attributes.

### SUMMARY OF THE INVENTION

Among the various aspects of the present invention is the provision of a template-directed synthetic process for the preparation of metal organic materials; the provision of such a process for the formation of a product in which any of a class of heterocyclic macrocycles is encapsulated because of shape and/or noncovalent bonds between the heterocyclic macrocycle and the framework of the metal-organic material.

Briefly, therefore, the present invention is directed to a process for the preparation of a heterocyclic macrocycle-templated supramolecular metal organic material. The process comprises preparing a reaction mixture containing a metal, a heterocyclic macrocycle, and organic ligands and forming, in the reaction mixture, a heterocyclic macrocycle-templated metal organic material comprising the metal, the heterocyclic macrocycle and the ligands by template-directed synthesis with the heterocyclic macrocycle serving as the template.

Another aspect of the present invention is a process for the preparation of a heterocyclic macrocycle-templated supramolecular metal organic material. The process comprises (i) preparing a reaction mixture containing a metalated heterocyclic macrocycle, organic ligands and a metal, the metalated heterocyclic macrocycle coordinating a first metal, (ii) forming a metalated heterocyclic macrocycle-templated supramolecular metal organic material comprising the metal, the metalated heterocyclic macrocycle and the ligands in the reaction mixture by template-directed synthesis with the metalated heterocyclic macrocycle serving as the template, and (iii) exchanging the first metal coordinated by the metalated heterocyclic macrocycle of the metalated heterocyclic macrocycle-templated supramolecular metal organic material with a second metal, the first and second metals being different.

Another aspect of the invention is the preparation of metal-organic materials in which a heterocyclic macrocycle is encapsulated rather than part of the metal-organic material. Advantageously, such materials may be used in a wide range of applications including, for example, catalysis, separations, and sensing.

Other objects and features will be in part apparent and in part pointed out hereinafter.

### ABBREVIATIONS AND DEFINITIONS

The following definitions and methods are provided to better define the present invention and to guide those of ordinary skill in the art in the practice of the present invention. Unless otherwise noted, terms are to be understood according to conventional usage by those of ordinary skill in the relevant art.

The following definitions and methods are provided to better define the present invention and to guide those of ordinary skill in the art in the practice of the present invention. Unless otherwise noted, terms are to be understood according to conventional usage by those of ordinary skill in the relevant art.

The terms “acetal” and “ketal,” as used herein alone or as part of another group, denote the moieties represented by the following formulae, respectively:

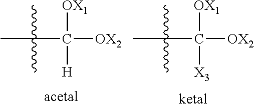

wherein X₁ and X₂ are independently hydrocarbyl, substituted hydrocarbyl, heterocyclo, or heteroaryl, and X₃ is hydrocarbyl or substituted hydrocarbyl, as defined in connection with such terms, and the wavy lines represent the attachment point of the acetal or ketal moiety to another moiety or compound.

The term “acyl,” as used herein alone or as part of another group, denotes the moiety formed by removal of the hydroxy group from the group —COON of an organic carboxylic acid, e.g., X₄C(O)—, wherein X₄ is X¹, X¹O—, X¹X²N—, or X¹S—, X¹ is hydrocarbyl, heterosubstituted hydrocarbyl, or heterocyclo, and R² is hydrogen, hydrocarbyl or substituted hydrocarbyl. Exemplary acyl moieties include acetyl, propionyl, benzoyl, pyridinylcarbonyl, and the like.

The term “acyloxy,” as used herein alone or as part of another group, denotes an acyl group as described above bonded through an oxygen linkage (—O—), e.g., X₄C(O)O— wherein X₄ is as defined in connection with the term “acyl.”

The term “alkoxy,” as used herein alone or as part of another group, denotes an —OX₅ radical, wherein X₅ is hydrocarbyl or substituted hydrocarbyl.

Unless otherwise indicated, the alkyl groups described herein are preferably lower alkyl containing from one to eight carbon atoms in the principal chain and up to 20 carbon atoms. They may be straight or branched chain or cyclic and include methyl, ethyl, propyl, isopropyl, butyl, hexyl and the like.

The term “alkylene,” as used herein alone or as part of another group, denotes a linear saturated divalent hydrocarbon radical of one to eight carbon atoms or a branched saturated divalent hydrocarbon radical of three to six carbon atoms unless otherwise stated. Exemplary alkylene moieties include methylene, ethylene, propylene, 1-methylpropylene, 2-methylpropylene, butylene, pentylene, and the like.

Unless otherwise indicated, the alkenyl groups described herein are preferably lower alkenyl containing from two to eight carbon atoms in the principal chain and up to 20 carbon atoms. They may be straight or branched chain or cyclic and include ethenyl, propenyl, isopropenyl, butenyl, isobutenyl, hexenyl, and the like.

Unless otherwise indicated, the alkynyl groups described herein are preferably lower alkynyl containing from two to eight carbon atoms in the principal chain and up to 20 carbon atoms. They may be straight or branched chain and include ethynyl, propynyl, butynyl, isobutynyl, hexynyl, and the like.

The terms “amine” or “amino,” as used herein alone or as part of another group, represents a group of formula —N(X₈)(X₉), wherein X₈ and X₉ are independently hydrogen, hydrocarbyl, substituted hydrocarbyl, heteroaryl, or heterocyclo, or X₈ and X₉ taken together form a substituted or unsubstituted alicyclic, aryl, or heterocyclic moiety, each as defined in connection with such term, typically having from 3 to 8 atoms in the ring. “Substituted amine,” for example, refers to a group of formula —N(X₈)(X₉), wherein at least one of X₈ and X₉ are other than hydrogen. “Unubstituted amine,” for example, refers to a group of formula —N(X₈)(X₉), wherein X₈ and X₉ are both hydrogen.

The terms “amido” or “amide,” as used herein alone or as part of another group, represents a group of formula —CON(X₈)(X₉), wherein X₈ and X₉ are as defined in connection with the terms “amine” or “amino.” “Substituted amide,” for example, refers to a group of formula —CON(X₈)(X₉), wherein at least one of X₈ and X₉ are other than hydrogen. “Unsubstituted amido,” for example, refers to a group of formula —CON(X₈)(X₉), wherein X₈ and X₉ are both hydrogen

The terms “aryl” or “Ar” as used herein alone or as part of another group denote optionally substituted homocyclic aromatic groups, preferably monocyclic or bicyclic groups containing from 6 to 12 carbons in the ring portion, such as phenyl, biphenyl, naphthyl, substituted phenyl, substituted biphenyl or substituted naphthyl. Phenyl and substituted phenyl are the more preferred aryl.

The term “arylene”, as used herein alone or part of another group refers to a divalent aryl radical of one to twelve carbon atoms. Non-limiting examples of “arylene” include phenylene, pyridinylene, pyrimidinylene and thiophenylene.

The terms “alkaryl” or “alkylaryl,” as used herein alone or as part of another group, denotes an -(arylene)-X₁₁ radical, wherein X₁₁ is as defined in connection with the term “alkyl.”

The term “chlorin” refers to a compound comprising a fundamental skeleton of three pyrrole nuclei and one pyrroline united through the α-positions by methane groups to form the following macrocyclic structure:

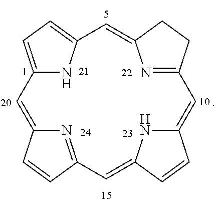 [SMILES: C1=Cc2cc3ccc(cc4nc(cc5ccc(cc1n2)[nH]5)CC4)[nH]3]

The term “corrin” refers to a compound comprising a fundamental skeleton of three pyrrole nuclei and one pyrroline united through the α-positions by methane groups to form the following macrocyclic structure:

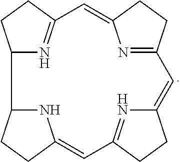

The term “cyano,” as used herein alone or as part of another group, denotes a group of formula —CN.

The term “carbocyclic” as used herein alone or as part of another group refers to a saturated or unsaturated monocyclic or bicyclic ring in which all atoms of all rings are carbon. Thus, the term includes cycloalkyl and aryl rings. The carbocyclic ring(s) may be substituted or unsubstituted. Exemplary substituents include one or more of the following groups: hydrocarbyl, substituted hydrocarbyl, keto, hydroxy, protected hydroxy, acyl, acyloxy, alkoxy, alkenoxy, alkynoxy, aryloxy, halogen, amido, amino, nitro, cyano, thiol, ketals, acetals, esters and ethers.

The term “cycloalkyl,” as used herein alone or as part of another group, denotes a cyclic saturated monovalent bridged or non-bridged hydrocarbon radical of three to ten carbon atoms. Exemplary cycloalkyl moieties include cyclopropyl, cyclobutyl, cyclopentyl, cyclohexyl, or adamantyl. Additionally, one or two ring carbon atoms may optionally be replaced with a —CO— group.

The term “ester,” as used herein alone or as part of another group, denotes a group of formula —COOX₁₂ wherein X₁₂ is alkyl or aryl, each as defined in connection with such term.

The term “ether,” as used herein alone or as part of another group, includes compounds or moieties which contain an oxygen atom bonded to two carbon atoms. For example, ether includes “alkoxyalkyl” which refers to an alkyl, alkenyl, or alkynyl group substituted with an alkoxy group.

The terms “halide,” “halogen” or “halo” as used herein alone or as part of another group refer to chlorine, bromine, fluorine, and iodine.

The term “heteroatom” shall mean atoms other than carbon and hydrogen.

The term “heteroaromatic” or “heteroaryl” as used herein alone or as part of another group denote optionally substituted aromatic groups having at least one heteroatom in at least one ring, and preferably 5 or 6 atoms in each ring. The heteroaromatic group preferably has 1 or 2 oxygen atoms, 1 or 2 sulfur atoms, and/or 1 to 4 nitrogen atoms in the ring, and may be bonded to the remainder of the molecule through a carbon or heteroatom. Exemplary heteroaromatics include furyl, thienyl, pyridyl, oxazolyl, pyrrolyl, indolyl, quinolinyl, or isoquinolinyl and the like. Exemplary substituents include one or more of the following groups: hydrocarbyl, substituted hydrocarbyl, keto (i.e., ═O), hydroxy, protected hydroxy, acyl, acyloxy, alkoxy, alkenoxy, alkynoxy, aryloxy, halogen, amido, amino, nitro, cyano, thiol, ketals, acetals, esters and ethers.

The term “heteroarylene” as used herein alone or as part of another group refers to a divalent heteroaryl radical. Non-limiting examples of “heteroarylene” include furylene, thienylene, pyridylene, oxazolylene, pyrrolylene, indolylene, quinolinylene, or isoquinolinylene and the like.

The terms “heterocyclo” or “heterocyclic” as used herein alone or as part of another group denote optionally substituted, fully saturated or unsaturated, monocyclic or bicyclic, aromatic or nonaromatic groups having at least one heteroatom in at least one ring, and preferably 5 or 6 atoms in each ring. The heterocyclo group preferably has 1 or 2 oxygen atoms, 1 or 2 sulfur atoms, and/or 1 to 4 nitrogen atoms in the ring, and may be bonded to the remainder of the molecule through a carbon or heteroatom. Exemplary heterocyclo include heteroaromatics such as furyl, thienyl, pyridyl, oxazolyl, pyrrolyl, indolyl, quinolinyl, or isoquinolinyl and the like. Exemplary substituents include one or more of the following groups: hydrocarbyl, substituted hydrocarbyl, keto, hydroxy, protected hydroxy, acyl, acyloxy, alkoxy, alkenoxy, alkynoxy, aryloxy, halogen, amido, amino, nitro, cyano, thiol, ketals, acetals, esters and ethers.

The terms “hydrocarbon” and “hydrocarbyl” as used herein describe organic compounds or radicals consisting exclusively of the elements carbon and hydrogen. These moieties include alkyl, alkenyl, alkynyl, and aryl moieties. These moieties also include alkyl, alkenyl, alkynyl, and aryl moieties substituted with other aliphatic or cyclic hydrocarbon groups, such as alkaryl, alkenaryl and alkynaryl. Unless otherwise indicated, these moieties preferably comprise 1 to 20 carbon atoms.

The term “hydroxy,” as used herein alone or as part of another group, denotes a group of formula —OH.

The term “keto,” as used herein alone or as part of another group, denotes a double bonded oxygen moiety (i.e., ═O).

The term “meso” refers to the position on the porphyrin, porphyrazin, chlorin, corrin and porphyrinogen structure adjacent to the reduced pyrrole ring, i.e., positions 5, 10, 15, and 20 of the porphyrin macrocycle (and the corresponding carbon or nitrogen atoms in the porphyrazin, chlorin, corrin and porphyrinogen macrocyclic structures). Stated differently, a “meso-porphyrin” is a porphyrin compound comprising substituent groups at the 5, 10, 15, and 20 position, or combinations thereof, a “meso-porphyrazin” is a porphyrazin compound comprising substituent groups at the nitrogen atoms adjacent the pyrrole rings, a “meso-chlorin” is a chlorin compound comprising substituent groups at the carbon atoms adjacent the pyrrole rings, a “meso-corrin” is a corrin compound comprising substituent groups at the carbon atoms adjacent the pyrrole rings, and “meso-pyrophyrinogen” is a pyrophyrinogen compound comprising substituent groups at the carbon atoms adjacent the pyrrole rings.

The term “metalated heterocyclic macrocycle” as used herein denotes a heterocyclic macrocycle containing a coordinated metal, the metal being coordinated, for example, by two or more of the nitrogen atoms at the 21, 22, 23, or 24 position of a porphyrin (a metalated porphyrin) or the corresponding nitrogen atoms of a porphyrazin (a metalated porphyrazin), a chlorin (a metalated chlorin), a corrin (a metalated corrin) and a porphyrinogen (a metalated porphyrinogen).

The term “metalloporphyrin” as used herein is used interchangeably with metalated porphyrin.

The term “nitro,” as used herein alone or as part of another group, denotes a group of formula —NO₂.

The term “porphyrazin” refers to a compound comprising a fundamental skeleton of four pyrrole nuclei united through the α-positions by four amine groups to form the following macrocyclic structure:

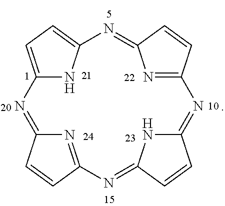 [SMILES: C1=Cc2nc1nc1ccc(nc3nc(nc4ccc(n2)[nH]4)C=C3)[nH]1]

The term “porphyrin” refers to a compound comprising a fundamental skeleton of four pyrrole nuclei united through the α-positions by four methane groups to form the following macrocyclic structure:

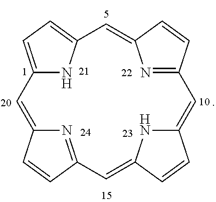 [SMILES: C1=Cc2cc3ccc(cc4nc(cc5ccc(cc1n2)[nH]5)C=C4)[nH]3]

The term “porphyrinogen” refers to a compound comprising a fundamental skeleton of four pyrrole nuclei united through the α-positions by four methane groups to form the following macrocyclic structure:

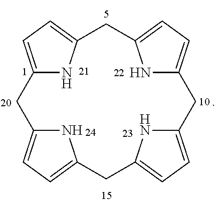 [SMILES: c1cc2[nH]c1Cc1ccc([nH]1)Cc1ccc([nH]1)Cc1ccc([nH]1)C2]

The “substituted hydrocarbyl” moieties described herein are hydrocarbyl moieties which are substituted with at least one atom other than carbon, including moieties in which a carbon chain atom is substituted with a hetero atom such as nitrogen, oxygen, silicon, phosphorous, boron, sulfur, or a halogen atom. These substituents include halogen, heterocyclo, alkoxy, alkenoxy, alkynoxy, aryloxy, hydroxy, protected hydroxy, keto, acyl, acyloxy, nitro, amino, amido, nitro, cyano, thiol, ketals, acetals, esters, ethers, and thioethers.

The term “thioether,” as used herein alone or as part of another group, denotes compounds and moieties that contain a sulfur atom bonded to two different carbon or hetero atoms (i.e., —S—), and also includes compounds and moieties containing two sulfur atoms bonded to each other, each of which is also bonded to a carbon or hetero atom (i.e., dithioethers (—S—S—)). Examples of thioethers include, but are not limited to, alkylthioalkyls, alkylthioalkenyls, and alkylthioalkynyls. The term “alkylthioalkyls” includes compounds with an alkyl, alkenyl, or alkynyl group bonded to a sulfur atom that is bonded to an alkyl group. Similarly, the term “alkylthioalkenyls” and alkylthioalkynyls” refer to compounds or moieties where an alkyl, alkenyl, or alkynyl group is bonded to a sulfur atom that is covalently bonded to an alkynyl group.

The term “thiol,” as used herein alone or as part of another group, denotes a group of formula —SH.

### BRIEF DESCRIPTION OF THE DRAWINGS

FIG. 1 is Cambridge Structural Database analysis of the occurrence (# of hits) of four examples of molecular building blocks that can serve as nodes for construction of porph@MOMs.

FIG. 2 is a three dimensional framework of Por@MOM-1 as described more fully in Example 1.

FIG. 3 is a three dimensional framework of Por@MOM-2 as described more fully in Example 2.

FIG. 4 is a three dimensional framework of Por@MOM-3 as described more fully in Example 3.

FIG. 5 is a three dimensional framework of Por@MOM-4 as described more fully in Example 4.

FIG. 6 is a three dimensional framework of Por@MOM-5 as described more fully in Example 5.

FIG. 7 is a three dimensional framework of Por@MOM-6 as described more fully in Example 6.

FIG. 8 is a three dimensional framework of Por@MOM-7 as described more fully in Example 7.

FIG. 9 is a three dimensional framework of Por@MOM-8 as described more fully in Example 8.

FIG. 10 is a three dimensional framework of Por@MOM-9 as described more fully in Example 9.

FIG. 11 is a three dimensional framework of Por@MOM-11 as described more fully in Example 11.

FIG. 12 is a three dimensional framework of Por@MOM-12 as described more fully in Example 12.

FIG. 13 is a three dimensional framework of Por@MOM-13 as described more fully in Example 13.

FIG. 14 is a three dimensional framework of Por@MOM-14 as described more fully in Example 14.

FIG. 15 is a three dimensional framework of Por@MOM-15 as described more fully in Example 15.

FIG. 16 is a three dimensional framework of Por@MOM-16 as described more fully in Example 16.

FIG. 17 is a three dimensional framework of Por@MOM-17 as described more fully in Example 17.

FIG. 18 is a three dimensional framework of Por@MOM-18 as described more fully in Example 18.

FIG. 19 is a three dimensional framework of Por@MOM-19 as described more fully in Example 19.

### DETAILED DESCRIPTION OF THE INVENTION

In accordance with one aspect of the present invention, a porphyrin serves as a template in a template-directed synthesis of a metal organic material with a heterocyclic macrocycle template being encapsulated in cages present in the final product. Without being bound to any particular theory, and based upon evidence to-date, the heterocyclic macrocycle template appears to “hold” the reactive sites of the reactants close together, facilitating the creation of a cage that is customized for the particular heterocyclic macrocycle template. Advantageously, this synthetic approach may be used to prepare metal organic materials that cannot be made by other synthetic methods because, for example, the desired cage structure is thermodynamically or kinetically disfavored; it may also serve to minimize side reactions, lowering the activation energy of the reaction, and producing desired stereochemistry. The template effect is well-known in zeolite chemistry wherein the template is sometimes called a structure directing agent.

Independent of any theory, in a typical process a heterocyclic macrocycle, a metal, and an organic ligand are combined in a solvent system to form a reaction mixture and the reaction mixture is preferably heated to form the heterocyclic macrocycle-templated supramolecular metal organic material. As described in greater detail herein, the metal is preferably introduced to the mixture in form of a metal salt, a metal oxide, or a combination thereof, and the heterocyclic macrocycle is introduced to the mixture as a metalated heterocyclic macrocycle, a non-metalated heterocyclic macrocycle (i.e., a heterocyclic macrocycle not having a metal coordinated by two or more of the atoms of the heterocyclic macrocycle, e.g., by the nitrogen atoms at the 21, 22, 23, or 24 position of a porphyrin or the corresponding carbon or nitrogen atoms of a porphyrazin, chlorin, corrin or porphyrinogen), or a combination thereof. The resulting metal organic material comprises molecular building blocks, derived from the metal and organic ligands in the reaction mixture, and cavities enclosed by the molecular building blocks, in which a metalated heterocyclic macrocycle resides. In one embodiment, the metal ions comprised by the molecular building blocks and the metal ions comprised by the metalated heterocyclic macrocycle are the same. In another embodiment, the metal ions comprised by the molecular building blocks and the metal ions comprised by the metalated heterocyclic macrocycle in the supramolecular assembly are different. In yet another embodiment, the molecular building blocks and the metalated heterocyclic macrocycle in the supramolecular assembly independently comprise two or more different metal ions.

In one embodiment, the heterocyclic macrocycle-templated supramolecular metal organic material heterocyclic macrocycle is derived from a reaction mixture comprising a metalated heterocyclic macrocycle, a metal (preferably in the form of a metal salt, metal oxide or combination thereof), and organic ligand and, after the supramolecular metal organic material heterocyclic macrocycle is formed, the metal coordinated by the metalated heterocyclic macrocycle is exchanged with another (different) metal. For example, the metalated heterocyclic macrocycle introduced to the reaction mixture may comprise a first metal selected, for example, from Groups 1, 2, 3, 4, 5, 6, 7, 8, 9, 10, 11, 12, 13, 14, 15, and 16 (according to the IUPAC Group numbering format) or Groups IA, IIA, IIIB, IVB, VB, VIIB, VIIB, VIII, IB, IIB, IIIA, IVA, VA, and VIA (according to the Chemical Abstracts Service (CAS) numbering format) of the periodic table and after the supramolecular metal organic material heterocyclic macrocycle is formed, the metal coordinated by the metalated heterocyclic macrocycle is exchanged with a second (different) metal selected, for example, from Groups 1, 2, 3, 4, 5, 6, 7, 8, 9, 10, 11, 12, 13, 14, 15, and 16 (according to the IUPAC Group numbering format) or Groups IA, IIA, IIIB, IVB, VB, VIIB, VIIB, VIII, IB, IIB, IIIA, IVA, VA, and VIA (according to the Chemical Abstracts Service (CAS) numbering format) of the periodic table and after the supramolecular metal organic material heterocyclic macrocycle is formed, the metal coordinated by the metalated heterocyclic macrocycle is exchanged with another (different) metal. By way of further example, in one embodiment the first metal, i.e., the metal coordinated by the metalated heterocyclic macrocycle comprised by the reaction mixture is cadmium, and the second metal, i.e., the metal coordinated by the metalated heteocyclic macrocycle of the supramolecular metal organic material formed in the reaction is magnesium or a transition metal.

Another aspect of the present invention is a process for the preparation of a heterocyclic macrocycle-templated supramolecular metal organic material. The process comprises (i) preparing a reaction mixture containing a metalated heterocyclic macrocycle, organic ligands and a metal, (ii) forming, in the reaction mixture, a metalated heterocyclic macrocycle-templated metal organic material comprising the metal, the metalated heterocyclic macrocycle and the ligands by template-directed synthesis with the metalated heterocyclic macrocycle serving as the template, and (iii) exchanging the metal coordinated by the metalated heterocyclic macrocycle with a second metal.

In general, the molecular building blocks are comprised of metals or metal clusters with three or more connection points (nodes) and they are coordinated to multi-functional exodentate organic ligands. If the organic ligands are bifunctional and their only role is to connect two adjacent nodes then they serve as “linkers” whereas polyfunctional ligands that connect three or more nodes also serve as nodes. In general, the cavities in the supramolecular assemblies will have the requisite shape, size and symmetry to encapsulate a particular metalated heterocyclic macrocycle and will have windows that allow ingress reaction substrates and egress of reaction products.

Reaction temperatures will typically be in the range of about 0 to 200° C. More typically, the reaction temperature will be in the range of about 20 to 120° C. Alternatively, or additionally, in some embodiments the reaction mixture may be microwaved to induce the formation of the supramolecular assembly.

The reaction mixture solvent system will typically comprise a suitable organic solvent. It may additionally comprise water. Exemplary organic solvents include, but are not limited to, aprotic dipolar solvents (such as acetone, acetonitrile, dimethylformamide, dimethylacetamide, dimethylsulfoxide, 1-methyl-2-pyrrolidinone, and the like), alcohols (such as methanol, ethanol, tert-butanol, isopropanol, and the like), combinations thereof, and the like. Preferred reaction mixture solvent systems comprise dimethylacetamide (“DMA”), dimethylformamide (“DMF”), and/or “DEF” with or without water.

Organic Ligands

The organic ligands generally serve as linkers or nodes in the heterocyclic macrocycle-templated assembly of the molecular building blocks. In general, the organic ligands are linear, branched or cyclic and polyvalent to coordinate with metals (including metal ions and metal oxides). Typically, the organic ligands will be linear, branched, monocyclic, bicyclic or tricyclic and contain at least two coordinating groups. For example, in one embodiment, the organic ligand is a linker, containing two metal coordinating groups. In other embodiments, the organic ligand is a node, containing at least 3 metal coordinating groups. In other embodiments, the organic ligand is a node, containing at least 4 metal coordinating groups. In other embodiments, the organic ligand is a node, containing at least 6 metal coordinating groups. In other embodiments, the organic ligand is a node, containing at least 8 metal coordinating groups. In other embodiments, the organic ligand is a node, containing at least 12 metal coordinating groups. In other embodiments, the organic ligand is a node, containing at least 24 metal coordinating groups.

In one embodiment, the ligand compound corresponds to Formula (1):

R₁-L₁-AL₃-R₃)ₙ (1)

wherein

A is a bond or a monocyclic ring or polycyclic ring system;

L₁ and each L₃ is a linker moiety;

n is at least 1; and

R₁ and each R₃ is independently a functional group capable of coordinately bonding to at least one metal ion.

In one exemplary embodiment, the organic ligand corresponds to Formula 1, n is 1, A is a bond, L₁ and L₃ are linkers, and the organic ligand contains two metal coordinating groups, R₁ and R₃.

In another exemplary embodiment, n is 1 or 2, A is a monocyclic or polycyclic ring system, L₁ and L₃ are linkers, and the organic ligand contains one R₁ metal coordinating groups and one or two R₃ metal coordinating groups. In general, when A is a ring system, the A ring system may comprise any saturated or unsaturated carbocyclic or heterocyclic ring structure. The A ring may be monocyclic, or may be a bicyclic, tricyclic, hexacyclic, or otherwise polycyclic ring system, provided that the polycyclic ring system is capable of being substituted in the manner described and illustrated in connection with Formula 1. In one embodiment in which the A ring is a polycyclic ring system, the A ring has the structure:

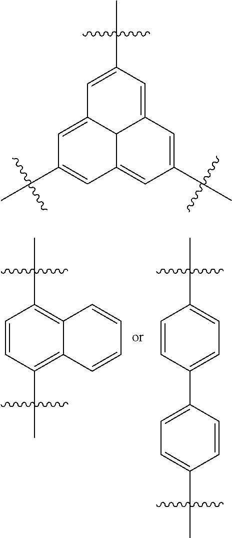

wherein the wavy lines represent the attachment point of the A ring to the remainder of the ligand compound (i.e., at L₁ and L₃) of each substituent arm).

In certain embodiments, A is a six-membered ring moiety. In general, the six-membered A ring may be any saturated or unsaturated six-membered carbocyclic or heterocyclic ring structure. Cationic forms of the carbocyclic or heterocyclic A ring are also contemplated; that is, a free electron pair of a carbon or heteroatom may be involved in the skeletal bonding of the ring system, e.g., in the formation of the ring or in the double bond system of the ring.

In one embodiment, A ring is a six-membered carbocyclic or heterocyclic ring having the structure:

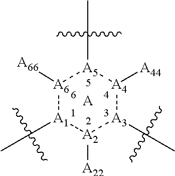

wherein

the atoms defining the ring, A₁, A₂, A₃, A₄, A₅, and A₆, are independently selected from carbon, nitrogen, oxygen, boron, and sulfur atoms (including cations thereof);

the A₁, A₃, and A₅ ring atoms are substituted with the -L₁-R₁, and -L₃-R₃ ring moieties (as described in connection with Formula (1);

A₂₂, A₄₄, and A₆₆ are independently -L₃-R₃ (as previously defined in connection with Formula 1) or any atom or group of atoms that do not otherwise affect the substituent arms;

the dashed lines represent single or double bonds, or collectively form a conjugated bond system that is unsaturated to a degree of aromaticity; and

the wavy lines represent the attachment point of the A ring to the remainder of the ligand compound (i.e., at L₁ or L₃ of each substituent arm).

In general, the A₂₂, A₄₄, and A₆₆ substituents are selected such that they will not adversely affect other substituents on the ligand compound and/or will not affect assembly of the desired ligands and further assembly of the molecular building blocks. Suitable substituents for A₂₂, A₄₄, and A₆₆ include, for example, one or more of the following chemical moieties: —H, —OH, —OR, —COOH, —COOR, —CONH₂, —NH₂, —NHR, —NRR, —SH, —SR, —SO₂R, —SO₂H, —SOR, and halo (including F, Cl, Br, and I), wherein each occurrence of R may be hydrocarbyl or substituted hydrocarbyl (e.g., substituted or unsubstituted alkyl, substituted or unsubstituted aryl, or substituted or unsubstituted araklyl). Alternatively, one or more of A₂₂, A₄₄, and A₆₆ may be -L₃-R₃ (as previously defined in connection with Formula 1).

In one embodiment, n is 1 or 2 and A is a six-membered aromatic ring. Alternatively, the A ring may be a six-membered non-aromatic ring. In one embodiment, for example, the six-membered A ring is selected from benzene, pyridine, pryridinium, pyrimidine, pyrimidinium, triazine, triazinium, pyrylium, boroxine, diborabenzene, and triborabenzene rings. Thus, for example, when n is 1 or 2 the A ring may correspond to one of the following exemplary six-membered rings:

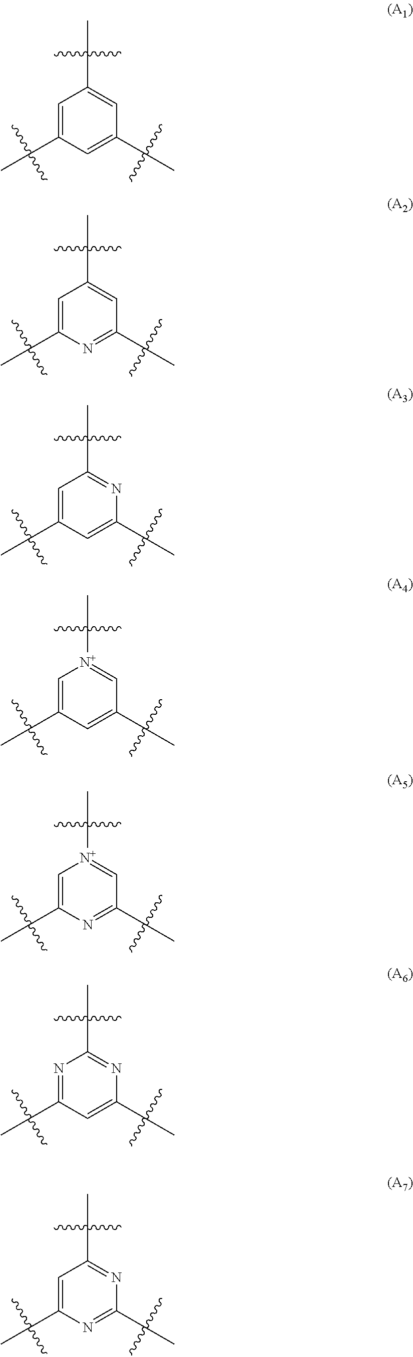

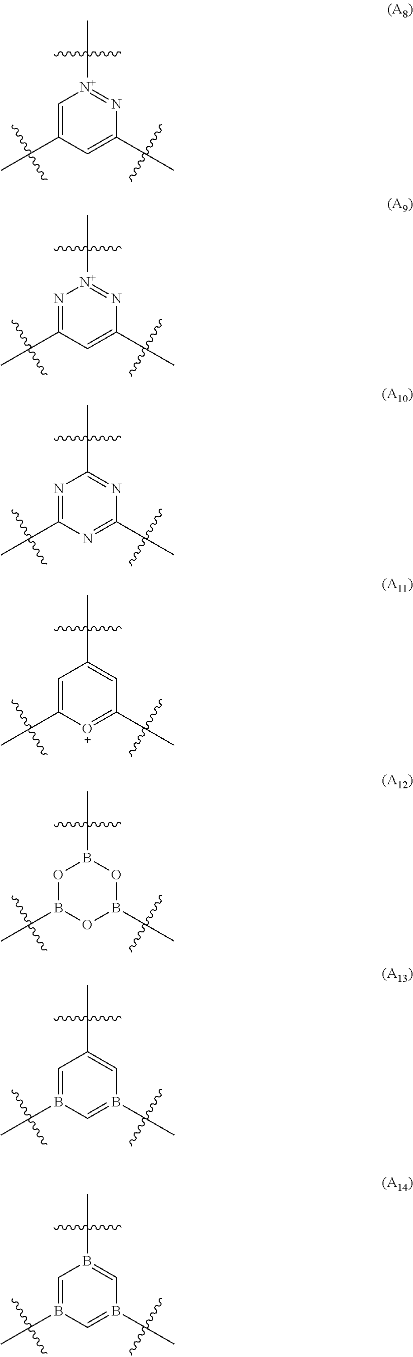

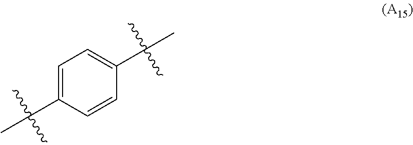 [SMILES: *c1ccc(*)cc1]

wherein the wavy lines represent the attachment point of the A ring to the remainder of the ligand compound corresponding to Formula (1) (i.e., at L₁ or L₃ of each substituent arm).

In one embodiment, n is 1 or 2, and A is a six-membered benzene, boroxine, pyridyl or triazine ring. According to this embodiment, therefore, the A ring is selected from:

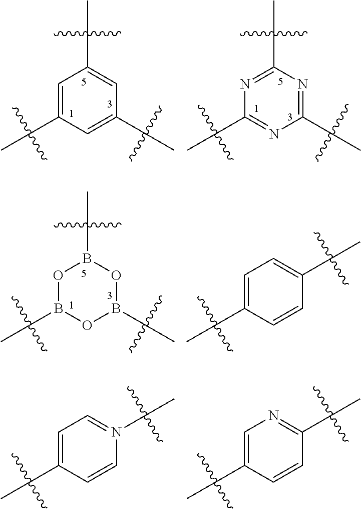

wherein the wavy lines represent the attachment point of the A ring to the remainder of the ligand compound corresponding to Formula (1) (i.e., at L₁ or L₃ of each substituent arm). In one preferred embodiment, A ring is a benzene ring. According to this embodiment, therefore, the A ring has the formula:

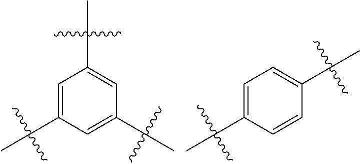 [SMILES: *c1cc(*)cc(*)c1 ; *c1ccc(*)cc1]

wherein the wavy lines represent the attachment point of the benzene ring to the remainder of the ligand compound corresponding to Formula (1) (i.e., at L₁ or L₃ of each substituent arm).

In one embodiment, the organic ligand corresponds to Formula 1 and n is 1. In another embodiment, n is 2. In another embodiment, n is 3. In another embodiment, n is 4. In another embodiment, n is at least 6. In another embodiment, n is at least 8. In another embodiment, n is at least 12. In another embodiment, n is at least 24.

The ligand compounds of Formula (1) also possess the L₁ and L₃ linking moieties, which join the R₁ and R₃ substituents to the A moiety. In each of the ligand compounds described herein, the L₁ and L₃ linking moieties may comprise covalent bonds, coordinate covalent bonds, noncovalent bonds, or a combination thereof. In certain embodiments, L₁ and/or each L₃ comprise direct chemical bonds. In certain other embodiments, L₁ and/or each L₃ may comprise organic linking moieties. In still other embodiments, L₁ and each L₃ may independently comprise coordinating bonds.

In general, the dimension, pore size, free volume, and other properties of the molecular building blocks and metal-organic frameworks including the ligands described herein can be correlated to the linker moieties, L₁ and L₃ of the ligand compound. For example, expanded structures can result from expanding the series of linkers (e.g., as a series of phenylene moieties), and the pore size can be reduced by the selection of functional groups on the linkers that point towards the inner cavities of the building blocks. In addition, other functional properties of the resulting building blocks can be selected by the appropriate selection of substituents (e.g., fluorescent or catalytic moieties) on the linking subunits.

The L₁ and L₃ linking moieties are generally the same and link the R₁ and R₃ substituents to the A moiety at the 1 and 3 positions, respectively.

Typically, L₁ is a bond or -(L₁₁)ₘ-, wherein L₁₁ is heterocyclene, hydrocarbylene, or substituted hydrocarbylene and m is a positive integer, L₃ is a bond or -(L₃₃)ₘ-, wherein L₃₃ is hydrocarbylene or substituted hydrocarbylene and n is a positive integer, with L₁ and L₃ being the same, and m is a positive integer. In one particular embodiment, L₁ and L₃ are each bonds.

Where L₁ and/or L₃ are -(L₁₁)ₘ- and -(L₃₃)ₘ-, respectively, although L₁₁ and L₃₃ may be heterocyclene, hydrocarbylene, or substituted hydrocarbylene, in certain embodiments L₁₁ and L₃₃ are substituted or unsubstituted alkylene, alkenylene, alkynylene, arylene, or heterocyclene. Where L₁₁ and L₃₃ are alkylene or alkenylene, for example, they may be straight, branched, or cyclic, preferably straight or cyclic. The L₁₁ and L₃₃ moieties may also be alkynyl, such as ethynyl. In one preferred embodiment, L₁ and L₃ are -(L₁₁)ₘ- and -(L₃₃)ₘ-, respectively, wherein L₁₁ and L₃₃ are substituted or unsubstituted alkylene, alkynyl, substituted or unsubstituted arylene, or heterocyclene.

In a particularly preferred embodiment, L₁ and L₃ are each bonds or are -(L₁₁)ₘ- and -(L₃₃)ₘ-, respectively, wherein L₁₁ and L₃₃ correspond to one of the following structures:

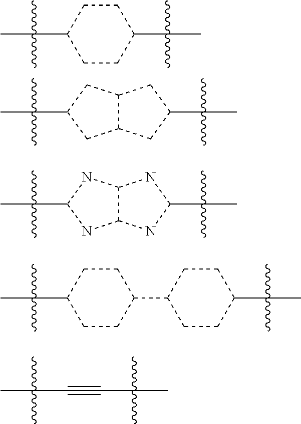

wherein

the dashed lines represent single or double bonds, or collectively form a conjugated bond system that is unsaturated to a degree of aromaticity;

the wavy lines represent the attachment point of the L₁₁ or L₃₃ moiety to the A moiety and another L₁₁ or L₃₃ moiety (i.e., when m is 2 or more) or to the A moiety and R₁ or R₃; and

each m is a positive integer.

In another preferred embodiment, L₁ and L₃ are each bonds or are -(L₁₁)ₘ- and -(L₃₃)ₘ-, respectively, wherein L₁₁ and L₃₃ are substituted or unsubstituted arylene; more preferably in this embodiment, L₁₁ and L₃₃ are substituted or unsubstituted phenylene.

Where L₁₁ and/or each L₃₃ is substituted hydrocarbylene (e.g., substituted alkylene or substituted arylene, more preferably substituted phenylene), the substituents may be any of a variety of substituents to impart a desired effect or property to the ligand compound, molecular building block, or the resulting supramolecular building block or metal-organic framework comprising such ligands and building blocks. As noted above, the substituent(s) for the linker moieties may be selected to impart various desired properties, such as magnetic activity, luminescent activity, phosphorescent activity, fluorescent activity, and catalytic and redox activity to the building blocks and assembled structures comprising these components. Exemplary substituents which may be found on the substituted alkylene or substituted arylene (e.g., substituted phenylene) moieties of L₁₁ and L₃₃ include, but are not limited to, one or more of the following chemical moieties: —OH, —OR, —COOH, —COOR, —CONH₂, —NH₂, —NHR, —NRR, —SH, —SR, —SO₂R, —SO₂H, —SOR, and halo (including F, Cl, Br, and I), wherein each occurrence of R may be hydrocarbyl or substituted hydrocarbyl (e.g., substituted or unsubstituted alkyl, substituted or unsubstituted aryl, or substituted or unsubstituted araklyl).

Although L₁₁ and L₃₃ are generally the same, when these moieties are substituted hydrocarbylene they may not necessarily carry the same substituents on each hydrocarbylene moiety. For instance, L₁₁ may be substituted phenylene carrying a particular halo substituent (e.g., F, Cl, Br, and/or I), or a combination thereof, while L₃₃ may be substituted phenylene carrying a different halo substituent (or a different combination of halo substituents), or different substituents altogether (e.g., —OH or NH₂). Thus, in various embodiments L₁₁ and L₃₃ are independently:

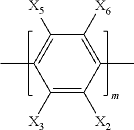

wherein m is a positive integer and each X₂, X₃, X₅, and X₆ is independently —H, —OH, —OR, —COOH, —COOK, —CONH₂, —NH₂, —NHR, —NRR, —SH, —SR, —SO₂R, —SO₂H, —SOR, or halo. In these and other embodiments, L₅₅ may be:

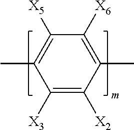

wherein m is a positive integer and each X₂, X₃, X₅, and X₆ is independently —H, —OH, —OR, —COOH, —COOR, —CONH₂, —NH₂, —NHR, —NRR, —SH, —SR, —SO₂R, —SO₂H, —SOR, or halo. The substituents on a substituted hydrocarbylene L₅₅ moiety may be the same or different from those of a substituted or unsubstituted hydrocarbylene L₁₁ and/or L₃₃ moiety.

Where L₁ and L₃ are -(L₁₁)ₘ- and -(L₃₃)ₘ-respectively, the number of L₁₁ and L₃₃ repeat units, m, is a positive integer. As noted above, L₁ and L₃ are generally the same, so the number of repeat units, m, for these moieties will be the same. The number of repeat units for L₅₅, however, may be the same or different than the number of repeat units for the L₁₁ and L₃₃ moieties. Generally speaking, compounds carrying more than ten (10) L₁₁ and/or L₃₃ repeat units tend to be less desired, as the substituent arms can lose rigidity and lack the proper orientation for assembly into larger molecular and molecular building blocks and metal-organic frameworks. Typically, where present, each m is 1 to 10 (e.g., 1, 2, 3, 4, 5, 6, 7, 8, 9, or 10). In one embodiment, L₁ and L₃ are -(L₁₁)ₘ- and -(₃₃)ₘ-, respectively, wherein L₁₁ and L₃₃ are substituted or unsubstituted phenylene and each m is 1, 2, 3, 4, or 5; more preferably, each m is 1, 2, or 3.

In addition to the A moiety, L₁ and L₃, the ligand compound corresponding to Formula (1) carries the R₁ and R₃ substituents. Generally, the R₁ and R₃ substituents are functional groups capable of coordinately bonding to at least one metal (including metal ions and metal oxides). The functional groups for R₁ and R₃ are preferably at least bidentate, and may be tridentate, or otherwise polydentate. In one embodiment, R₁ and R₃ are bidentate functional groups.

In particular, the R₁ and R₃ groups are capable of coordinately bonding to at least one metal (including metal ions and metal oxides) and typically at least two metals (which may be either the same or different) to form the molecular building block. Thus, for example, while the R₁ and R₃ groups may be initially be a functional group, when combined with metal(s) in the formation of the molecular building block the R₁ and R₃ groups become coordinating groups with the metal ions or oxides.

Representative functional groups capable of coordinately binding to at least one metal include, but are not limited to, the following: —CO₂H, —CS₂H, —NO₂, —SO₃H, —Si(OH)₃, —Ge(OH)₃, —Sn(OH)₃, —Si(SH)₄, —Ge(SH)₄, —Sn(SH)₃, —PO₃H, —AsO₃H, —AsO₄H, —P(SH)₃, —As(SH)₃, —CH(SH)₂, —C(SH)₃, —CH(NH₂)₂, —C(NH₂)₂, —CH(OH)₂, —C(OH)₃, —CH(CN)₂ and —C(CN)₃, —CH(RSH)₂, —C(RSH)₃, —CH(RNH₂)₂, —C(RNH₂)₃, —CH(ROH)₂, —C(ROH)₃, —CH(RCN)₂, and —C(RCN)₃, wherein each R is independently an alkyl or alkenyl group having from 1 to 5 carbon atoms, or an aryl group consisting of 1 to 2 phenyl rings. Other functional groups capable of coordinately binding to at least one metal include, but are not limited to, nitrogen donors such as, for example, cyano (—CN), amino, pyrazole, imidazole, pyridine, and functional groups containing such moieties. See, e.g., Tominaga et al., Angew. Chem. Int. Ed. 2004, 43, 5621-5625.

In one preferred embodiment, R₁ and R₃ are carboxylic acid (—CO₂H) groups. According to this embodiment, when the organic ligand is combined with one or more metals during the formation of a molecular building block, the carboxylic acid moieties become carboxylate moieties which coordinately bond with two metals in the following (bidentate) manner:

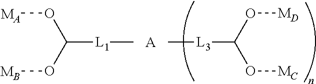

wherein n is at least 1, M_{A} and M_{B} and each M_{C} and M_{D} are metal ions (including metal oxides) and the dashed lines represent coordination bonds, with other coordination being possible with the metals and other moieties not specifically illustrated (e.g., between M_{A} and M_{B}, between M_{C} and M_{D}, and/or between M_{A}, M_{B}, M_{C}, and/or M_{D} an other moieties (for example, additional ligand compounds)), and the A moiety, L₁ and L₃ are as defined in connection with Formula (1) above.

In one preferred embodiment, the organic ligand corresponds to Formula (1) and contains at least carboxylate moieties, at least two heteroaromatic amine moieties, or at least two phenoxy moieties. Alternatively, the organic ligands may contain combinations of at least one carboxylate moiety, at least one heteroaromatic amine moiety, and/or at least one phenoxy moiety.

Metals

As discussed above, the metal organic materials of the present invention comprise molecular building blocks, derived from the metal and organic ligands, and cavities enclosed by the molecular building blocks, in which a metalated heterocyclic macrocycle, such as a metalated porphyrin, resides. The metals comprised by the molecular building blocks and the metals comprised by the metalated heterocyclic macrocycles may be the same or different. In one embodiment, they are the same. In another embodiment, they are different. In yet another embodiment, the molecular building blocks comprise organic ligands coordinating two or more different metals.

In general, the organic ligands of the molecular building blocks can coordinate with metal ions from Groups 1, 2, 3, 4, 5, 6, 7, 8, 9, 10, 11, 12, 13, 14, 15, and 16 (according to the IUPAC Group numbering format) or Groups IA, IIA, IIIB, IVB, VB, VIIB, VIIB, VIII, IB, IIB, IIIA, IVA, VA, and VIA (according to the Chemical Abstracts Service (CAS) numbering format) of the periodic table. This includes, for example, metal ions from the alkali metals, alkaline earth metals, transition metals, Lanthanides, Actinides, and other metals. In order to form building blocks of the desired shape and orientation, a metal ion is selected having the appropriate coordination geometry (e.g., linear, trigonal planar, tetrahedral, square planar, trigonal bipyramidal, square pyramidal, octahedral, trigonal prismatic, pentagonal bipyramidal, cubic, dodecahedral, hexagonal bipyramidal, icosahedron, cuboctahedron, etc.).

The bond angle between the ligands and the metal ion generally dictates the topology of the molecular building block, while the functional groups on the ligands coordinate with metal ions to form the molecular building block. For example, in one embodiment the molecular building block is triangular and the metal ions are transition metals. In one particular embodiment, the molecular building block metal ions are selected from first row transition metals. In another particular embodiment, the molecular building block metal ions are selected from second row transition metals. In another particular embodiment, the molecular building block metal ions are selected from third row transition metals. In another embodiment, molecular building block metal ions are selected from the group consisting of Ag⁺, Al³⁺, Au⁺, Cu²⁺, Cu⁺, Fe²⁺, Fe³⁺, Hg²⁺, Li⁺, Mn³⁺, Mn²⁺, Nd³⁺, Ni²⁺, Ni⁺, Pd²⁺, Pd⁺, Pt²⁺, Pt⁺, Tl³⁺, Yb²⁺ and Yb³⁺, along with the corresponding metal salt counterion (if present). In one preferred embodiment, molecular building block metal ions are the same and are selected from the group consisting of Ag⁺, Au⁺, Cu²⁺, Cu⁺, Fe²⁺, Fe³⁺, Hg²⁺, Li⁺, Mn³⁺, Mn²⁺, Ni²⁺, Ni⁺, Pd²⁺, Pd⁺, Pt²⁺, and Pt⁺, along with the corresponding metal salt counterion (if present). In another preferred embodiment, molecular building block metal ions are copper, chromium, iron or zinc ions along with the corresponding metal salt counterion (if present). Suitable counterions include, for example, F⁻, Cl⁻, Br⁻, I⁻, ClO⁻, ClO₂⁻, ClO₃⁻, ClO₄⁻, OH⁻, NO₃⁻, NO₂⁻, SO₄²⁻, SO₃²⁻, PO₄³⁻, and CO₃²⁻.

In another embodiment, the molecular building block has square pyramidal geometry and the metal ions are transition metals. For example, in one such embodiment, the molecular building block metal ions are first row transition metals. In another such embodiment, the molecular building block metal ions the metal ions are second row transition metals. In another such embodiment, the molecular building block metal ions are third row transition metals. In another such embodiment, the molecular building block metal ions are selected from the group consisting of Al³⁺, Bi⁵⁺, Bi³⁺, Bi⁺; Cd²⁺, Cu²⁺, Cu⁺, Co³⁺, Co²⁺, Cr³⁺, Eu²⁺, Eu³⁺, Fe³⁺, Fe³⁺, Gd³⁺, Mo³⁺, Ni²⁺, Ni⁺, Os³⁺, Os²⁺, Pt²⁺, Pt⁺, Re³⁺, Re²⁺, Rh²⁺, Rh⁺, Ru³⁺, Ru²⁺, Sm²⁺, Sm³⁺, Tc⁴⁺, Tc⁶⁺, Tc⁷⁺, W³⁺, Y³⁺, and Zn²⁺, along with the corresponding metal salt counterion (if present). In another such embodiment, the molecular building block metal ions are the same and are selected from the group consisting of Bi⁵⁺, Bi³⁺, Bi⁺; Cd²⁺, Cu²⁺, Cu⁺, Co³⁺, Co²⁺, Cr³⁺, Fe³⁺, Fe³⁺, Mo³⁺, Ni²⁺, Ni⁺, Pt²⁺, Pt⁺, Re³⁺, Re²⁺, Rh²⁺, Rh⁺, Ru³⁺, Ru²⁺, W³⁺, Y³⁺, and Zn²⁺, along with the corresponding metal salt counterion (if present). Suitable counterions include, for example, F⁻, Cl⁻, Br⁻, I⁻, ClO⁻, ClO₂⁻, ClO₃⁻, ClO₄⁻, OH⁻, NO₃⁻, NO₂⁻, SO₄²⁻, SO₃²⁻, PO₄³⁻, and CO₃²⁻.

Other suitable coordinating metals include those described in U.S. Pat. No. 5,648,508 (hereby incorporated by reference herein in its entirety). In addition to the metal ions and metal salts described above, other metallic and metal-like compounds may be used, such as sulfates, phosphates, and other complex counterion metal salts of the main- and subgroup metals of the periodic table of the elements. Metal oxides, mixed metal oxides, with or without a defined stoichiometry may also be employed.

It will be understood that all metal ions in a given molecular building block can be in the same transition state or in more than one transition state. In some instances, for example, a counterion may be present to balance the charge. The counterions themselves may, or may not, be coordinated to the metal. Suitable counterions are described elsewhere herein.

In general, the heterocyclic macrocycles, in general, and the porphyrins, in particular, can coordinate with metal ions from Groups 1, 2, 3, 4, 5, 6, 7, 8, 9, 10, 11, 12, 13, 14, 15, and 16 (according to the IUPAC Group numbering format) or Groups IA, IIA, IIIB, IVB, VB, VIIB, VIIB, VIII, IB, IIB, IIIA, IVA, VA, and VIA (according to the Chemical Abstracts Service (CAS) numbering format) of the periodic table. This includes, for example, metal ions from the alkali metals, alkaline earth metals, transition metals, Lanthanides, Actinides, and other metals. In one embodiment, the metal atom coordinated by the metalated heterocyclic macrocycle is preferably a transition metal. For example, the metalated heterocyclic macrocycle may coordinate any of the 30 metals in the 3d, 4d and 5d transition metal series of the Periodic Table of the Elements, including the 3d series that includes Sc, Ti, V, Cr, Mn, Fe, Co, Ni, Cu, and Zn; the 4d series that includes Y, Zr, Nb, Mo, Tc, Ru, Rh, Pd, Ag and Cd; and the 5d series that includes Lu, Hf, Ta, W, Re, Os, Ir, Pt, Au and Hg. In some embodiments, the metal is from the 3d series. In some embodiments, the metal is selected from Co, Cd, Mn, Zn, Fe, and Ni.

Heterocyclic Macrocycles

The heterocyclic macrocycles employed as structure directing agents in the process of the present invention may be any of a wide range of heteroatom-containing macrocycles, and metalated heterocyclic macrocycles, known in the art. In one embodiment, the metalated heterocyclic macrocycle is a meso-porphyrin, including metalated meso-porphyrins, a meso-porphyrazin, including metalated meso-porphyrazins, a meso-chlorin, including metalated meso-chlorins, a meso-corrin, including metalated meso-corrins, and meso-porphyrinogen, including metalated meso-porphyrinogens.

Porphyrins

The porphyrins employed as structure directing agents in the process of the present invention may be any of a wide range of porphyrins, including metalated porphyrins, known in the art. In one embodiment, the porphyrin is a meso-porphyrin, including metalated meso-porphyrins.

In one embodiment, the porphyrin complex is a porphyrin corresponding to Formula P-1:

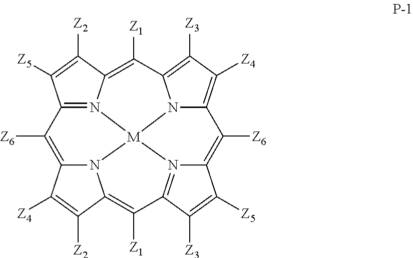

wherein M is present or absent and, when present, is H₂ or a coordinated metal, and each Z₁, Z₂, Z₃, Z₄, Z₅ and Z₆ is independently selected from the group consisting of hydrogen, hydrocarbyl, substituted hydrocarbyl, heterocyclo, alkoxy and amino. In one embodiment, Z₂, Z₃, Z₄ and Z₅ are hydrogen and Z₁ and Z₆ are independently hydrogen, hydrocarbyl, substituted hydrocarbyl, heterocyclo, alkoxy or amino. For example, in one embodiment, Z₂, Z₃, Z₄ and Z₅ are hydrogen and Z₁ and Z₆ are independently hydrocarbyl, substituted hydrocarbyl, or heterocyclo. By way of further example, in one embodiment, Z₂, Z₃, Z₄ and Z₅ are hydrogen and Z₁ and Z₆ are the same and are hydrocarbyl, substituted hydrocarbyl, or heterocyclo. By way of further example, in one embodiment, Z₂, Z₃, Z₄ and Z₅ are hydrogen and Z₁ and Z₆ are different and are hydrocarbyl, substituted hydrocarbyl, or heterocyclo. By way of further example, in one embodiment, Z₂, Z₃, Z₄ and Z₅ are hydrogen and Z₁ and Z₆ are the same and are heterocyclo. By way of further example, in one embodiment, Z₂, Z₃, Z₄ and Z₅ are hydrogen and Z₁ and Z₆ are the different and are optionally substituted aryl. By way of further example, in one embodiment, Z₂, Z₃, Z₄ and Z₅ are hydrogen, Z₁ is optionally substituted aryl, e.g., optionally substituted phenyl, and Z₆ is optionally substituted aryl, e.g., optionally substituted phenyl, and the porphyrin is a chiral porphyrin. By way of further example, in one embodiment, Z₂, Z₃, Z₄ and Z₅ are hydrogen, Z₁ is optionally substituted heterocyclo, e.g., optionally substituted pyridyl, and Z₆ is optionally substituted heterocyclo, e.g., optionally substituted pyridyl, and the porphyrin is a chiral porphyrin. By way of further example, in one embodiment, Z₂, Z₃, Z₄ and Z₅ are hydrogen, Z₁ is optionally substituted aryl or heterocyclo, Z₆ is optionally substituted aryl or heterocyclo, and the porphyrin has D₂-symmetry. In each of the foregoing embodiments, M may be a metal selected from Co, Cd, Mn, Zn, Fe, and Ni.

In one exemplary embodiment, a preferred embodiment, Z₁ is

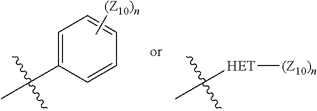

wherein

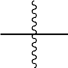

denotes the point of attachment of Z₁ to the porphyrin, HET is a 5- or 6-membered heterocyclo, n is 0-5, each Z₁₀ is hydrocarbyl, substituted hydrocarbyl, alkoxy or amino. For example, in one such embodiment, HET is a 5- or 6-membered heteroaromatic, n is 0 or 1, and Z₁₀ is hydrocarbyl, substituted hydrocarbyl, alkoxy or amino. By way of further example, in one such embodiment, HET is a pyridyl, pyrimidinyl, pyrazinyl, pyrrolyl, imidazolyl, or oxazolyl, n is 0 or 1, and Z₁₀ is hydrocarbyl, substituted hydrocarbyl, alkoxy or amino. By way of further example, in one such embodiment, Z₁ is selected from the group consisting of

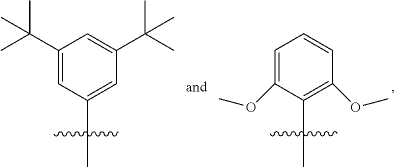

wherein

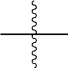

denotes the point of attachment of Z₁ to the porphyrin. In each of the foregoing embodiments, M may be a metal selected from Co, Cd, Mn, Zn, Fe, and Ni.

In one exemplary embodiment, a preferred embodiment, Z₆ is

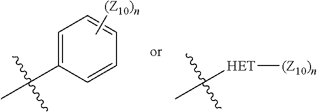

wherein

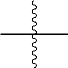

denotes the point of attachment of Z₆ to the porphyrin, HET is a 5- or 6-membered heterocyclo, n is 0-5, each Z₁₀ is hydrocarbyl, substituted hydrocarbyl, alkoxy or amino. For example, in one such embodiment, HET is a 5- or 6-membered heteroaromatic, n is 0 or 1, and Z₁₀ is hydrocarbyl, substituted hydrocarbyl, alkoxy or amino. By way of further example, in one such embodiment, HET is a pyridyl, pyrimidinyl, pyrazinyl, pyrrolyl, imidazolyl, or oxazolyl, n is 0 or 1, and Z₁₀ is hydrocarbyl, substituted hydrocarbyl, alkoxy or amino. By way of further example, in one such embodiment, Z₆ is selected from the group consisting of

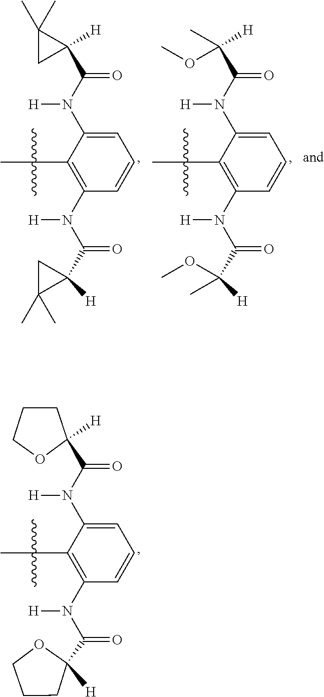 [SMILES: *c1c(NC(=O)[C@H]2CC2(C)C)cccc1NC(=O)[C@H]1CC1(C)C ; *c1c(NC(=O)[C@H](C)OC)cccc1NC(=O)[C@H](C)OC ; *c1c(NC(=O)[C@@H]2CCCO2)cccc1NC(=O)[C@@H]1CCCO1]

wherein

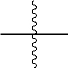

denotes the point of attachment of Z₆ to the porphyrin. In each of the foregoing embodiments, M may be a metal selected from Co, Cd, Mn, Zn, Fe, and Ni.

Exemplary metalated porphyrins include the following porphyrins, designated P11, P12, P13, P14, P15, P16, P17 and P18:

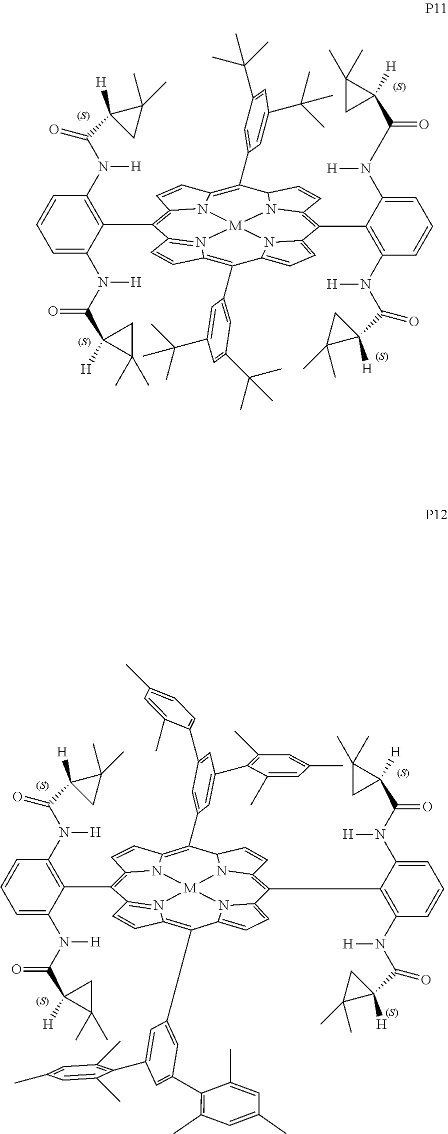

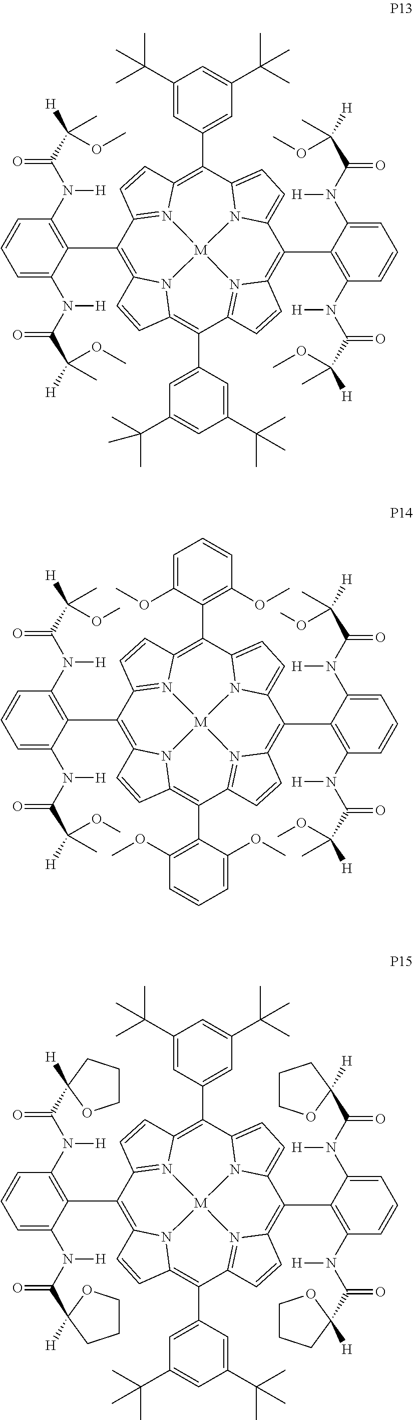

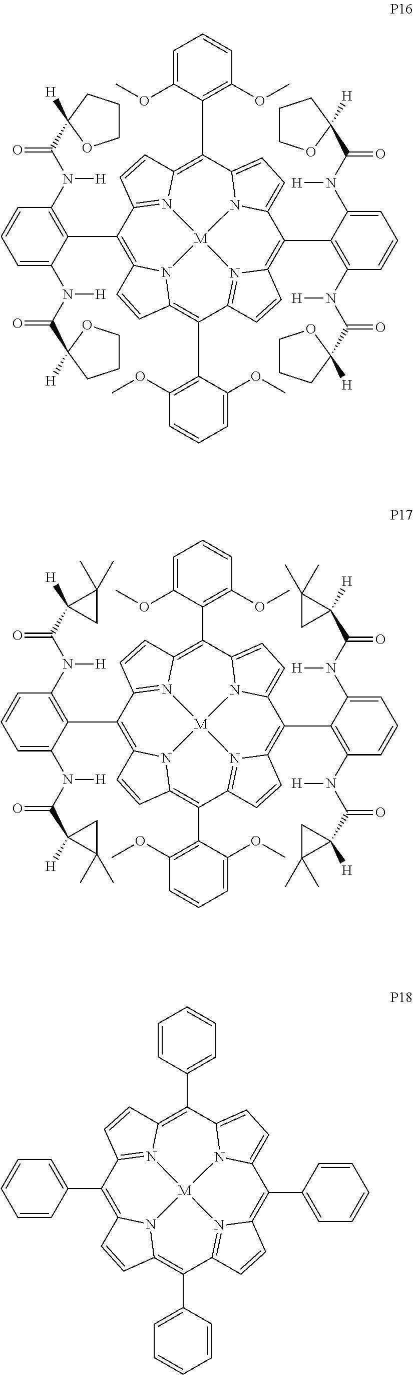

In one such embodiment, the porphyrin is a metalated porphyrin corresponding in structure to P11, P12, P13, P14, P15, P16, or P17 and M is Co(II). In another such embodiment, the porphyrin is a metalated porphyrin corresponding in structure to P11, P12, P13, P14, P15, P16, or P17 and M is Cd, Mn, Zn, Fe, or Ni.

Porphyrazins

The porphyrazins employed as structure directing agents in the process of the present invention may be any of a wide range of porphyrazins, including metalated porphyrazins, known in the art. In one embodiment, the porphyrin is a meso-porphyrazin, including metalated meso-porphyrazins.

In one embodiment, the porphyrin complex is a porphyrazin corresponding to Formula P-21:

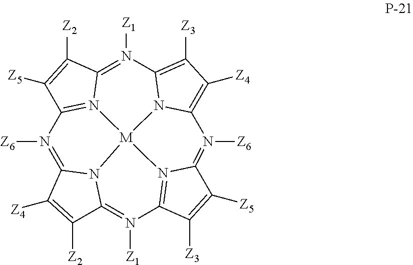

wherein M is present or absent and, when present, is H₂ or a coordinated metal, and each Z₁, Z₂, Z₃, Z₄, Z₅ and Z₆ is independently selected from the group consisting of hydrogen, hydrocarbyl, substituted hydrocarbyl, heterocyclo, alkoxy and amino. In one embodiment, Z₂, Z₃, Z₄ and Z₅ are hydrogen and Z₁ and Z₆ are independently hydrogen, hydrocarbyl, substituted hydrocarbyl, heterocyclo, alkoxy or amino. For example, in one embodiment, Z₂, Z₃, Z₄ and Z₅ are hydrogen and Z₁ and Z₆ are independently hydrocarbyl, substituted hydrocarbyl, or heterocyclo. By way of further example, in one embodiment, Z₂, Z₃, Z₄ and Z₅ are hydrogen and Z₁ and Z₆ are the same and are hydrocarbyl, substituted hydrocarbyl, or heterocyclo. By way of further example, in one embodiment, Z₂, Z₃, Z₄ and Z₅ are hydrogen and Z₁ and Z₆ are different and are hydrocarbyl, substituted hydrocarbyl, or heterocyclo. By way of further example, in one embodiment, Z₂, Z₃, Z₄ and Z₅ are hydrogen and Z₁ and Z₆ are the same and are heterocyclo. By way of further example, in one embodiment, Z₂, Z₃, Z₄ and Z₅ are hydrogen and Z₁ and Z₆ are the different and are optionally substituted aryl. By way of further example, in one embodiment, Z₂, Z₃, Z₄ and Z₅ are hydrogen, Z₁ is optionally substituted aryl, e.g., optionally substituted phenyl, and Z₆ is optionally substituted aryl, e.g., optionally substituted phenyl, and the porphyrazin is a chiral porphyrazin. By way of further example, in one embodiment, Z₂, Z₃, Z₄ and Z₅ are hydrogen, Z₁ is optionally substituted heterocyclo, e.g., optionally substituted pyridyl, and Z₆ is optionally substituted heterocyclo, e.g., optionally substituted pyridyl, and the porphyrazin is a chiral porphyrazin. By way of further example, in one embodiment, Z₂, Z₃, Z₄ and Z₅ are hydrogen, Z₁ is optionally substituted aryl or heterocyclo, Z₆ is optionally substituted aryl or heterocyclo, and the porphyrazin has D₂-symmetry. In each of the foregoing embodiments, M may be a metal selected from Co, Cd, Mn, Zn, Fe, and Ni.

In one exemplary embodiment, a preferred embodiment, Z₁ is

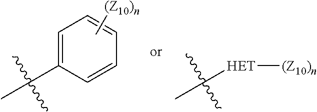

wherein

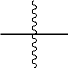

denotes the point of attachment of Z₁ to the porphyrazin, HET is a 5- or 6-membered heterocyclo, n is 0-5, each Z₁₀ is hydrocarbyl, substituted hydrocarbyl, alkoxy or amino. For example, in one such embodiment, HET is a 5- or 6-membered heteroaromatic, n is 0 or 1, and Z₁₀ is hydrocarbyl, substituted hydrocarbyl, alkoxy or amino. By way of further example, in one such embodiment, HET is a pyridyl, pyrimidinyl, pyrazinyl, pyrrolyl, imidazolyl, or oxazolyl, n is 0 or 1, and Z₁₀ is hydrocarbyl, substituted hydrocarbyl, alkoxy or amino. By way of further example, in one such embodiment, Z₁ is selected from the group consisting of

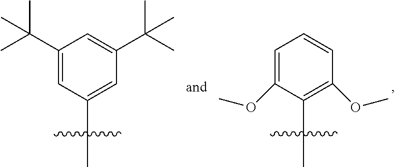

wherein

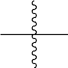

denotes the point of attachment of Z₁ to the porphyrazin. In each of the foregoing embodiments, M may be a metal selected from Co, Cd, Mn, Zn, Fe, and Ni.

In one exemplary embodiment, a preferred embodiment, Z₆ is

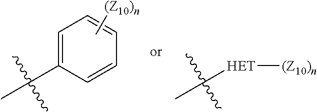

wherein

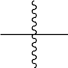

denotes the point of attachment of Z₆ to the porphyrazin, HET is a 5- or 6-membered heterocyclo, n is 0-5, each Z₁₀ is hydrocarbyl, substituted hydrocarbyl, alkoxy or amino. For example, in one such embodiment, HET is a 5- or 6-membered heteroaromatic, n is 0 or 1, and Z₁₀ is hydrocarbyl, substituted hydrocarbyl, alkoxy or amino. By way of further example, in one such embodiment, HET is a pyridyl, pyrimidinyl, pyrazinyl, pyrrolyl, imidazolyl, or oxazolyl, n is 0 or 1, and Z₁₀ is hydrocarbyl, substituted hydrocarbyl, alkoxy or amino. By way of further example, in one such embodiment, Z₆ is selected from the group consisting of

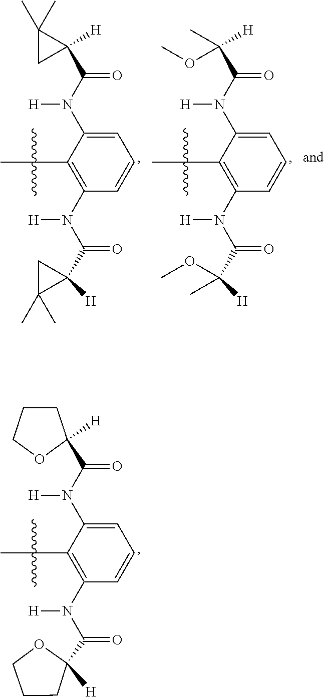 [SMILES: *c1c(NC(=O)[C@H]2CC2(C)C)cccc1NC(=O)[C@H]1CC1(C)C ; *c1c(NC(=O)[C@H](C)OC)cccc1NC(=O)[C@H](C)OC ; *c1c(NC(=O)[C@@H]2CCCO2)cccc1NC(=O)[C@@H]1CCCO1]

wherein

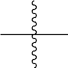

denotes the point of attachment of Z₆ to the porphyrazin. In each of the foregoing embodiments, M may be a metal selected from Co, Cd, Mn, Zn, Fe, and Ni.

Chlorins

The chlorins employed as structure directing agents in the process of the present invention may be any of a wide range of chlorins, including metalated chlorins, known in the art. In one embodiment, the chlorin is a meso-chlorin, including metalated meso-chlorins.

In one embodiment, the chlorin complex is a chlorin corresponding to Formula P-31:

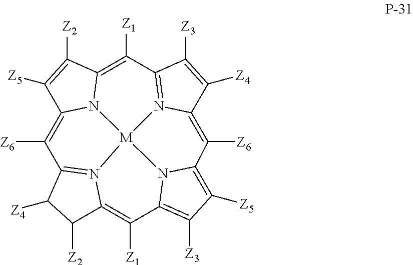

wherein M is present or absent and, when present, is H₂ or a coordinated metal, and each Z₁, Z₂, Z₃, Z₄, Z₅ and Z₆ is independently selected from the group consisting of hydrogen, hydrocarbyl, substituted hydrocarbyl, heterocyclo, alkoxy and amino. In one embodiment, Z₂, Z₃, Z₄ and Z₅ are hydrogen and Z₁ and Z₆ are independently hydrogen, hydrocarbyl, substituted hydrocarbyl, heterocyclo, alkoxy or amino. For example, in one embodiment, Z₂, Z₃, Z₄ and Z₅ are hydrogen and Z₁ and Z₆ are independently hydrocarbyl, substituted hydrocarbyl, or heterocyclo. By way of further example, in one embodiment, Z₂, Z₃, Z₄ and Z₅ are hydrogen and Z₁ and Z₆ are the same and are hydrocarbyl, substituted hydrocarbyl, or heterocyclo. By way of further example, in one embodiment, Z₂, Z₃, Z₄ and Z₅ are hydrogen and Z₁ and Z₆ are different and are hydrocarbyl, substituted hydrocarbyl, or heterocyclo. By way of further example, in one embodiment, Z₂, Z₃, Z₄ and Z₅ are hydrogen and Z₁ and Z₆ are the same and are heterocyclo. By way of further example, in one embodiment, Z₂, Z₃, Z₄ and Z₅ are hydrogen and Z₁ and Z₆ are the different and are optionally substituted aryl. By way of further example, in one embodiment, Z₂, Z₃, Z₄ and Z₅ are hydrogen, Z₁ is optionally substituted aryl, e.g., optionally substituted phenyl, and Z₆ is optionally substituted aryl, e.g., optionally substituted phenyl, and the chlorin is a chiral chlorin. By way of further example, in one embodiment, Z₂, Z₃, Z₄ and Z₅ are hydrogen, Z₁ is optionally substituted heterocyclo, e.g., optionally substituted pyridyl, and Z₆ is optionally substituted heterocyclo, e.g., optionally substituted pyridyl, and the chlorin is a chiral chlorin. By way of further example, in one embodiment, Z₂, Z₃, Z₄ and Z₅ are hydrogen, Z₁ is optionally substituted aryl or heterocyclo, Z₆ is optionally substituted aryl or heterocyclo, and the chlorin has D₂-symmetry. In each of the foregoing embodiments, M may be a metal selected from Co, Cd, Mn, Zn, Fe, and Ni.

In one exemplary embodiment, a preferred embodiment, Z₁ is

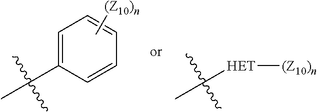

wherein

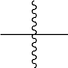

denotes the point of attachment of Z₁ to the chlorin, HET is a 5- or 6-membered heterocyclo, n is 0-5, each Z₁₀ is hydrocarbyl, substituted hydrocarbyl, alkoxy or amino. For example, in one such embodiment, HET is a 5- or 6-membered heteroaromatic, n is 0 or 1, and Z₁₀ is hydrocarbyl, substituted hydrocarbyl, alkoxy or amino. By way of further example, in one such embodiment, HET is a pyridyl, pyrimidinyl, pyrazinyl, pyrrolyl, imidazolyl, or oxazolyl, n is 0 or 1, and Z₁₀ is hydrocarbyl, substituted hydrocarbyl, alkoxy or amino. By way of further example, in one such embodiment, Z₁ is selected from the group consisting of

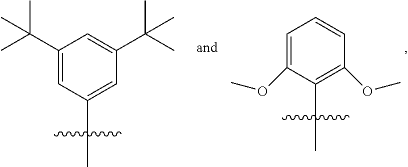

wherein

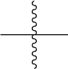

denotes the point of attachment of Z₁ to the chlorin. In each of the foregoing embodiments, M may be a metal selected from Co, Cd, Mn, Zn, Fe, and Ni.

In one exemplary embodiment, a preferred embodiment, Z₆ is

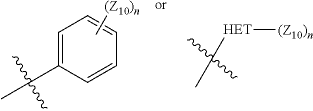

wherein

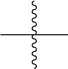

denotes the point of attachment of Z₆ to the chlorin, HET is a 5- or 6-membered heterocyclo, n is 0-5, each Z₁₀ is hydrocarbyl, substituted hydrocarbyl, alkoxy or amino. For example, in one such embodiment, HET is a 5- or 6-membered heteroaromatic, n is 0 or 1, and Z₁₀ is hydrocarbyl, substituted hydrocarbyl, alkoxy or amino. By way of further example, in one such embodiment, HET is a pyridyl, pyrimidinyl, pyrazinyl, pyrrolyl, imidazolyl, or oxazolyl, n is 0 or 1, and Z₁₀ is hydrocarbyl, substituted hydrocarbyl, alkoxy or amino. By way of further example, in one such embodiment, Z₆ is selected from the group consisting of

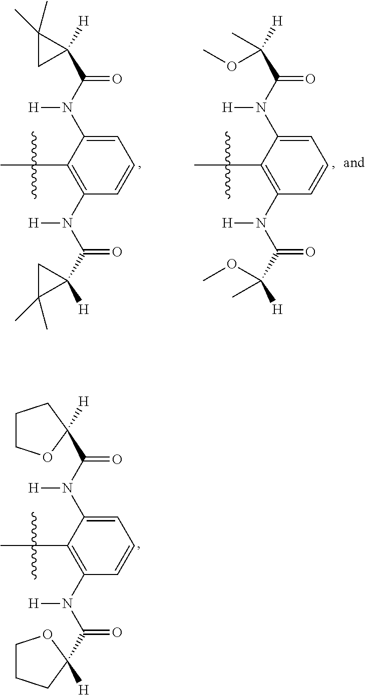 [SMILES: *c1c(NC(=O)[C@H]2CC2(C)C)cccc1NC(=O)[C@H]1CC1(C)C ; *c1c(NC(=O)[C@H](C)OC)cccc1NC(=O)[C@H](C)OC ; *c1c(NC(=O)[C@@H]2CCCO2)cccc1NC(=O)[C@@H]1CCCO1]

wherein

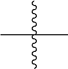

denotes the point of attachment of Z₆ to the chlorin. In each of the foregoing embodiments, M may be a metal selected from Co, Cd, Mn, Zn, Fe, and Ni.

Corrins

The corrins employed as structure directing agents in the process of the present invention may be any of a wide range of corrins, including metalated corrins, known in the art. In one embodiment, the corrin is a meso-corrin, including metalated meso-corrins.

In one embodiment, the corrin complex is a corrin corresponding to Formula P-41:

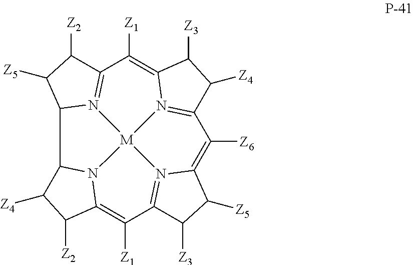

wherein M is present or absent and, when present, is H₂ or a coordinated metal, and each Z₁, Z₂, Z₃, Z₄, Z₅ and Z₆ is independently selected from the group consisting of hydrogen, hydrocarbyl, substituted hydrocarbyl, heterocyclo, alkoxy and amino. In one embodiment, Z₂, Z₃, Z₄ and Z₅ are hydrogen and Z₁ and Z₆ are independently hydrogen, hydrocarbyl, substituted hydrocarbyl, heterocyclo, alkoxy or amino. For example, in one embodiment, Z₂, Z₃, Z₄ and Z₅ are hydrogen and Z₁ and Z₆ are independently hydrocarbyl, substituted hydrocarbyl, or heterocyclo. By way of further example, in one embodiment, Z₂, Z₃, Z₄ and Z₅ are hydrogen and Z₁ and Z₆ are the same and are hydrocarbyl, substituted hydrocarbyl, or heterocyclo. By way of further example, in one embodiment, Z₂, Z₃, Z₄ and Z₅ are hydrogen and Z₁ and Z₆ are different and are hydrocarbyl, substituted hydrocarbyl, or heterocyclo. By way of further example, in one embodiment, Z₂, Z₃, Z₄ and Z₅ are hydrogen and Z₁ and Z₆ are the same and are heterocyclo. By way of further example, in one embodiment, Z₂, Z₃, Z₄ and Z₅ are hydrogen and Z₁ and Z₆ are the different and are optionally substituted aryl. By way of further example, in one embodiment, Z₂, Z₃, Z₄ and Z₅ are hydrogen, Z₁ is optionally substituted aryl, e.g., optionally substituted phenyl, and Z₆ is optionally substituted aryl, e.g., optionally substituted phenyl, and the corrin is a chiral corrin. By way of further example, in one embodiment, Z₂, Z₃, Z₄ and Z₅ are hydrogen, Z₁ is optionally substituted heterocyclo, e.g., optionally substituted pyridyl, and Z₆ is optionally substituted heterocyclo, e.g., optionally substituted pyridyl, and the corrin is a chiral corrin. By way of further example, in one embodiment, Z₂, Z₃, Z₄ and Z₅ are hydrogen, Z₁ is optionally substituted aryl or heterocyclo, Z₆ is optionally substituted aryl or heterocyclo, and the corrin has D₂-symmetry. In each of the foregoing embodiments, M may be a metal selected from Co, Cd, Mn, Zn, Fe, and Ni.

In one exemplary embodiment, a preferred embodiment, Z₁ is

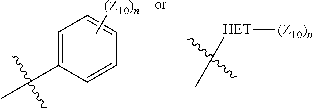

wherein

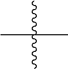

denotes the point of attachment of Z₁ to the corrin, HET is a 5- or 6-membered heterocyclo, n is 0-5, each Z₁₀ is hydrocarbyl, substituted hydrocarbyl, alkoxy or amino. For example, in one such embodiment, HET is a 5- or 6-membered heteroaromatic, n is 0 or 1, and Z₁₀ is hydrocarbyl, substituted hydrocarbyl, alkoxy or amino. By way of further example, in one such embodiment, HET is a pyridyl, pyrimidinyl, pyrazinyl, pyrrolyl, imidazolyl, or oxazolyl, n is 0 or 1, and Z₁₀ is hydrocarbyl, substituted hydrocarbyl, alkoxy or amino. By way of further example, in one such embodiment, Z₁ is selected from the group consisting of

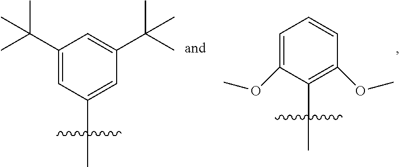

wherein

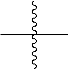

denotes the point of attachment of Z₁ to the corrin. In each of the foregoing embodiments, M may be a metal selected from Co, Cd, Mn, Zn, Fe, and Ni.

In one exemplary embodiment, a preferred embodiment, Z₆ is

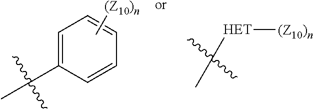

wherein

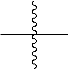

denotes the point of attachment of Z₆ to the corrin, HET is a 5- or 6-membered heterocyclo, n is 0-5, each Z₁₀ is hydrocarbyl, substituted hydrocarbyl, alkoxy or amino. For example, in one such embodiment, HET is a 5- or 6-membered heteroaromatic, n is 0 or 1, and Z₁₀ is hydrocarbyl, substituted hydrocarbyl, alkoxy or amino. By way of further example, in one such embodiment, HET is a pyridyl, pyrimidinyl, pyrazinyl, pyrrolyl, imidazolyl, or oxazolyl, n is 0 or 1, and Z₁₀ is hydrocarbyl, substituted hydrocarbyl, alkoxy or amino. By way of further example, in one such embodiment, Z₆ is selected from the group consisting of

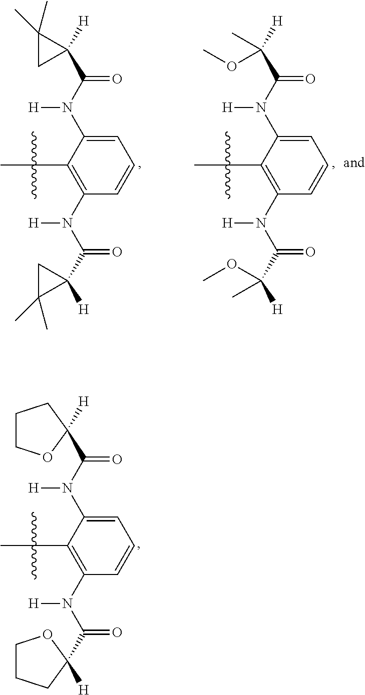 [SMILES: *c1c(NC(=O)[C@H]2CC2(C)C)cccc1NC(=O)[C@H]1CC1(C)C ; *c1c(NC(=O)[C@H](C)OC)cccc1NC(=O)[C@H](C)OC ; *c1c(NC(=O)[C@@H]2CCCO2)cccc1NC(=O)[C@@H]1CCCO1]

wherein

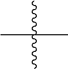

denotes the point of attachment of Z₆ to the corrin. In each of the foregoing embodiments, M may be a metal selected from Co, Cd, Mn, Zn, Fe, and Ni.

Porphyrinogens

The porphyrinogens employed as structure directing agents in the process of the present invention may be any of a wide range of porphyrinogens, including metalated porphyrinogens, known in the art. In one embodiment, the porphyrinogen is a meso-porphyrinogen, including metalated meso-porphyrinogens.

In one embodiment, the porphyrinogen complex is a porphyrinogen corresponding to Formula P-51:

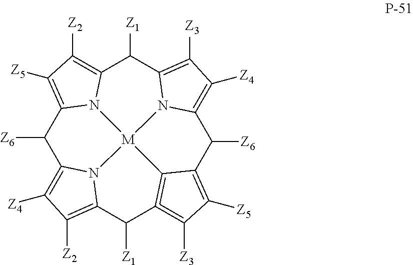

wherein M is present or absent and, when present, is H₂ or a coordinated metal, and each Z₁, Z₂, Z₃, Z₄, Z₅ and Z₆ is independently selected from the group consisting of hydrogen, hydrocarbyl, substituted hydrocarbyl, heterocyclo, alkoxy and amino. In one embodiment, Z₂, Z₃, Z₄ and Z₅ are hydrogen and Z₁ and Z₆ are independently hydrogen, hydrocarbyl, substituted hydrocarbyl, heterocyclo, alkoxy or amino. For example, in one embodiment, Z₂, Z₃, Z₄ and Z₅ are hydrogen and Z₁ and Z₆ are independently hydrocarbyl, substituted hydrocarbyl, or heterocyclo. By way of further example, in one embodiment, Z₂, Z₃, Z₄ and Z₅ are hydrogen and Z₁ and Z₆ are the same and are hydrocarbyl, substituted hydrocarbyl, or heterocyclo. By way of further example, in one embodiment, Z₂, Z₃, Z₄ and Z₅ are hydrogen and Z₁ and Z₆ are different and are hydrocarbyl, substituted hydrocarbyl, or heterocyclo. By way of further example, in one embodiment, Z₂, Z₃, Z₄ and Z₅ are hydrogen and Z₁ and Z₆ are the same and are heterocyclo. By way of further example, in one embodiment, Z₂, Z₃, Z₄ and Z₅ are hydrogen and Z₁ and Z₆ are the different and are optionally substituted aryl. By way of further example, in one embodiment, Z₂, Z₃, Z₄ and Z₅ are hydrogen, Z₁ is optionally substituted aryl, e.g., optionally substituted phenyl, and Z₆ is optionally substituted aryl, e.g., optionally substituted phenyl, and the porphyrinogen is a chiral porphyrinogen. By way of further example, in one embodiment, Z₂, Z₃, Z₄ and Z₅ are hydrogen, Z₁ is optionally substituted heterocyclo, e.g., optionally substituted pyridyl, and Z₆ is optionally substituted heterocyclo, e.g., optionally substituted pyridyl, and the porphyrinogen is a chiral porphyrinogen. By way of further example, in one embodiment, Z₂, Z₃, Z₄ and Z₅ are hydrogen, Z₁ is optionally substituted aryl or heterocyclo, Z₆ is optionally substituted aryl or heterocyclo, and the porphyrinogen has D₂-symmetry. In each of the foregoing embodiments, M may be a metal selected from Co, Cd, Mn, Zn, Fe, and Ni.

In one exemplary embodiment, a preferred embodiment, Z₁ is

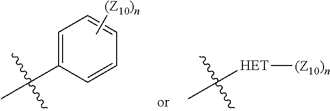

wherein

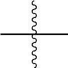

denotes the point of attachment of Z₁ to the porphyrinogen, HET is a 5- or 6-membered heterocyclo, n is 0-5, each Z₁₀ is hydrocarbyl, substituted hydrocarbyl, alkoxy or amino. For example, in one such embodiment, HET is a 5- or 6-membered heteroaromatic, n is 0 or 1, and Z₁₀ is hydrocarbyl, substituted hydrocarbyl, alkoxy or amino. By way of further example, in one such embodiment, HET is a pyridyl, pyrimidinyl, pyrazinyl, pyrrolyl, imidazolyl, or oxazolyl, n is 0 or 1, and Z₁₀ is hydrocarbyl, substituted hydrocarbyl, alkoxy or amino. By way of further example, in one such embodiment, Z₁ is selected from the group consisting of

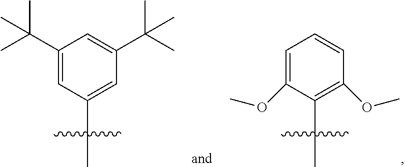

wherein

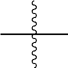

denotes the point of attachment of Z₁ to the porphyrinogen. In each of the foregoing embodiments, M may be a metal selected from Co, Cd, Mn, Zn, Fe, and Ni.

In one exemplary embodiment, a preferred embodiment, Z₆ is

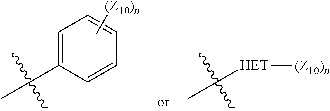

wherein

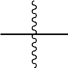

denotes the point of attachment of Z₆ to the porphyrinogen, HET is a 5- or 6-membered heterocyclo, n is 0-5, each Z₁₀ is hydrocarbyl, substituted hydrocarbyl, alkoxy or amino. For example, in one such embodiment, HET is a 5- or 6-membered heteroaromatic, n is 0 or 1, and Z₁₀ is hydrocarbyl, substituted hydrocarbyl, alkoxy or amino. By way of further example, in one such embodiment, HET is a pyridyl, pyrimidinyl, pyrazinyl, pyrrolyl, imidazolyl, or oxazolyl, n is 0 or 1, and Z₁₀ is hydrocarbyl, substituted hydrocarbyl, alkoxy or amino. By way of further example, in one such embodiment, Z₆ is selected from the group consisting of

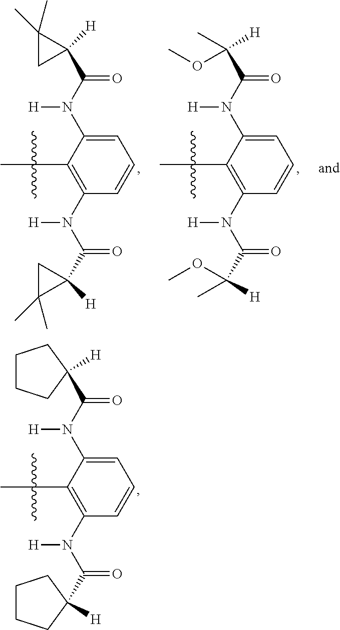

wherein

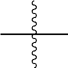

denotes the point of attachment of Z₆ to the porphyrinogen. In each of the foregoing embodiments, M may be a metal selected from Co, Cd, Mn, Zn, Fe, and Ni.

Supramolecular Metal Organic Material

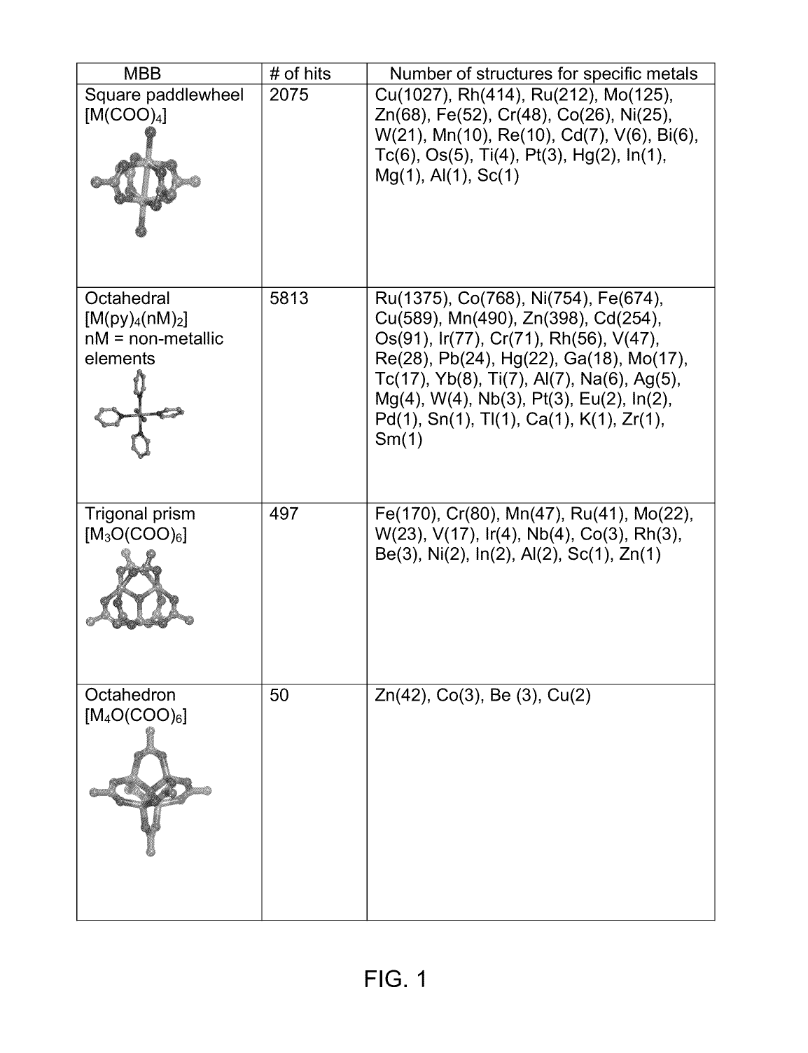

The organic ligands, metals and heterocyclic macrocycles may be combined to form any of a range of molecular building blocks. Exemplary molecular building blocks include those shown in FIG. 1.

Examples of this new class of material, porph@MOMs, were prepared solvothermally and all exhibit cage-containing structures that are not afforded if synthesis is attempted under the same conditions but in the absence of porphyrin. Several of the new porph@MOMs exhibit structures in which the porphyrin is accessible via micropores and they could therefore represent a new paradigm for biomimetic and industrial chemistry since they inherently combine the advantages of homogeneous catalysis (high reactivity/turnover rate) and heterogeneous catalysis (recycling of catalyst, facile isolation of product) within a single catalytic system. The porph@MOMs also exhibit variable loading of metalloporphyrin because the template effect can occur even if low amounts of porphyrin are used during synthesis and the resulting cages are not fully occupied.

Although the proof-of-concept catalytic studies we report are based upon oxidation catalysis, these are by no means the only catalytic processes that porph@MOMs might effect. In particular porph@MOMs should also enable photocatalytic reactions that are known to catalysed by metalloporphyrins. Molecular recognition and self-assembly may be used with reactive species in order to pre-organize a system for a chemical reaction (to form one or more covalent bonds). It may be considered a special case of supramolecular catalysis. Since TMPyP has the appropriate symmetry and size to fit the cuboctahedral cage of HKUST-1, we have investigated whether it might template new variants of HKUST-1. Reaction of M(II)Cl₂ (M═Mn, Fe and Co) with BTC and TMPyP in DMF and H₂O at 85° C. for 12 h afforded dark cubic crystals of MTMPyP@HKUST-1-M that adopt space group Fm-3m with a=26.5985(17) Å, 26.5985(17) Å and 26.4301(11) Å for M=Mn, Fe and Co, respectively. Reaction of Ni(OAC)₂ with BTC and TMPyP under the same conditions afforded red octahedral crystals of NiTMPyP@HKUST-1′-Ni, a structure with the same space group and tbo topology as HKUST-1 but with a=27.478(2) Å. The disordered building blocks in NiTMPyP@HKUST-1′-Ni are modeled to be a combination of dimetallic [M₂(H₂O)(carboxylate)₄] and monometallic [M(carboxylate)₄]²⁻ 4-connected nodes. Mg(OAC)₂ afforded a powder with the same PXRD pattern as NiTMPyP@HKUST-1′-Ni but single crystals could not be obtained under the synthesis conditions used (see supplemental information for full details). The porphyrin molecules in these five porph@MOMs are statistically disordered because of the cage symmetry (with the exception of central metal atoms) but the porphyrin planes are clearly resolvable as the D₄ₕ symmetry of the porphyrin's core is a subgroup of the cage symmetry and the core is located on the symmetry plane and axes. Variation in the reaction conditions led to porphyrin loading between 12% and 88% as determined by site occupancy refinement of the metal atom and UV spectroscopy. Notably, the same reactions conducted under the same conditions but in the absence of porphyrin yielded different products.

We assessed the catalytic activity of FeTMPyP@HKUST-1-Fe (50% loading, experimentally measured surface area of 423 m²/g) and observed that it catalyses size selective olefin oxidation, a classic catalysis reaction of heme enzymes.²⁰ The conversion of styrene (4.2 Å×7.0 Å cross-section) reached ˜85% (turnover frequency (TOF)=269 h−1) after 10 hrs, compared to conversion of only ˜35% for an equivalent amount of FeTMPyP in solution. Styrene oxide and benzaldehyde were identified as the major products (30% and 57%, respectively). This is consistent with selectivity previously reported by Maurya.²¹ In contrast, trans-stilbene (4.2 Å×11.4 Å cross-section) was only ˜40% converted under the same conditions (TOF=126 h−1) with trans-stilbene oxide being the major product (70% selectivity), compared to conversion of ˜34% for FeTMPyP in solution. The conversion of triphenylethylene (9.0 Å×11.4 Å cross-section) by FeTMPyP@HKUST-1-Fe was <5% (TOF=15 h⁻¹) under the same conditions whereas FeTMPyP in solution exhibited ˜14% conversion with diphenylmethanone and benzaldehyde being the major products. These observations are consistent with the oxidation reaction occurring in the cages of FeTMPyP@HKUST-1-Fe since the pore (˜9 Å×9 Å) in MTMPyP@HKUST-1-M is the window of the cuboctahedral cages. The reaction solutions were filtered after the catalytic reaction. The filtrate showed no detectable metalloporphyrin species via UV whereas the filtrant was recycled and even after seven 10 hr cycles we observed >55% conversion of styrene.

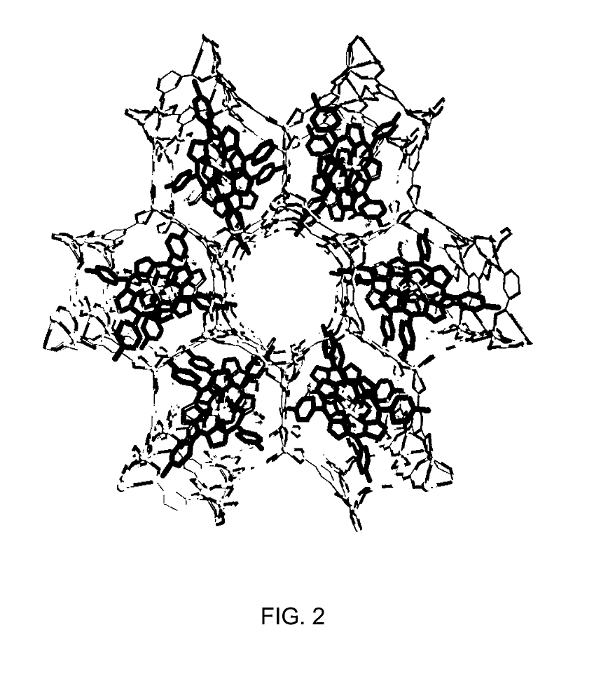

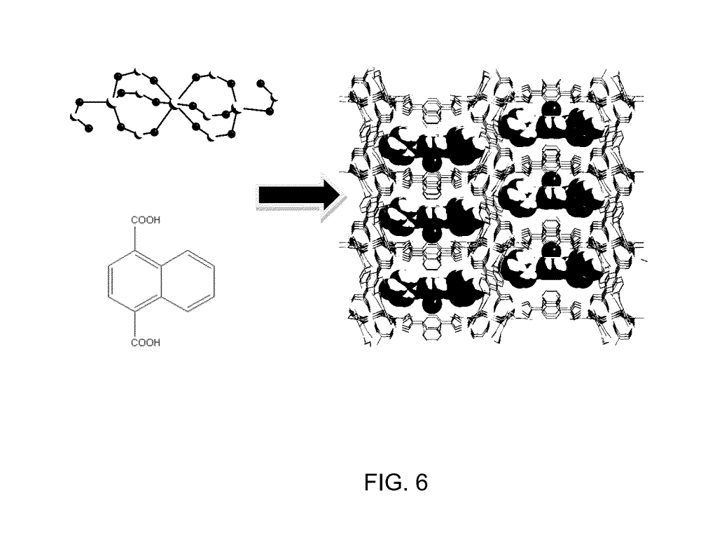

HKUST-1 type nets are clearly well-suited to serve as platforms for porph@MOMs but it is unlikely that they are the only MOMs suitable for porphyrin encapsulation or that they will offer optimal performance. We therefore explored whether or not TMPyP might serve as a template for MOM structures with novel cage-containing topologies. Template directed synthesis has been widely used in the context of zeolite²² and mesoporous material synthesis²³ and it has also been used in MOMs, including upon HKUST-1-Cu.²⁴ Five novel crystalline porph@MOMs (porph@MOM-1 to porph@MOM-5) were indeed isolated. [Cd₁₄(BTC)₁₂(H₂O)₁₂]·3CdTMPyP·4Cl, porph@MOM-1, [Zn₄O_{1.5}(BPDA)_{4.5}]·ZnTMPyP (BPDA=4,4′-biphenyldicarboxylic), porph@MOM-4, and [Zn₆(1,4-NPD)₈]·ZnTMPyP (1,4-NPD=1,4-naphthalene dicarboxylate), porph@MOM-5, are particularly noteworthy. All three MOMs are anionic and cationic metalloporphyrins are 100% loaded into cavities that are templated by MTMPyP cations. Porph@MOM-1 crystallizes in the trigonal space group P-3 with a=b=30.4643(6) Å and c=10.0841(4) Å; V=8104.9(4) Å3. It exhibits a novel honeycomb-like 3D structure built from 3-connected [Cd(COO)₃]— and 5-connected [Cd₂(COO)₅]— nodes (FIG. 2). Notably, the porphyrin moieties coordinate to Cd(II) cations and are located in one set of channels (the nearest distance to adjacent metalloporphyrins is ca. 1 nm) and every metalloporphyrin is exposed to a second set of channels that represent 39.3% of the volume of the unit cell (PLATON²⁵ was used to measure free volume for all structures described herein). The solvent channels and the lability of the Cd cations facilitated metal ion exchange by soaking crystals of Cd-porph@MOM-1 for four days in a MeOH solution of MnCl₂ as verified by disappearance of the UV Soret band of CdTMPyP at ˜430 nm and appearance of strong Soret bands for Mn(III)TMPyP at ˜460 nm (see supplementary information). Mn-porph@MOM-1 catalyses styrene oxidation: after 10 hrs 61% conversion was observed (TOF=404 h−1), compared to conversion of only ˜5% for an equivalent amount of Cd-porph@MOM-1. Benzaldehyde, styrene oxide and 1-phenylethanone were the major products with 57%, 21% and 19% selectivity, respectively. The filtrant can be recycled and even after four 10 hr cycles we observed >55% conversion of styrene. Porph@MOM-4 crystallizes in the monoclinic space group P2/c with a=17.245(5) Å; b=17.025(5) Å; c=45.462(11) Å; β=106.981(9)°; V=12766(6) Å³. There are two different building blocks in the structure, [Zn₄(O)(COO)₈]²⁻ and [Zn₂(O)(COO)₅]³⁻, which can be simplified as 6- and 5-connected nodes that connect BPDA ligands into a 2D net that exhibits 2D to 3D parallel interpenetration.² Metalloporphyrins are located within the interlayers of two interpenetrating nets with adjacent porphyrins oriented face-to-face fashion at a distance of ˜7.2 Å. Removal of solvent molecules would create an accessible free volume of 5017.9 Å³ or 39.3% of the volume of the unit cell. Porph@MOM-5 crystallizes in the orthorhombic space group=Cmcm with a=20.525(15) Å; b=21.985(17) Å; c=36.043(13) Å; V=16263(22) Å3. It exhibits a pcu net that is based upon 6-connected [Zn₃(COO)₈]²⁻ clusters. As shown in FIG. 6, the metalloporphyrin molecules are located in every other cavity of the pcu net. π . . . π stacking interactions between naphthalene moieties and metalloporphyrins means that metalloporphyrins are ordered from a crystallographic perspective and calculations indicate that 34.5% of the volume of the unit cell is accessible.

To summarize, the templated porph@MOMs described herein represent a general class of compounds that addresses these problems as follows: the metalloporphyrin (or other metalated heterocyclic macrocycle described herein catalyst is trapped in a pocket that prevents or slows down its decomposition; the high porosity of MOMs means that a large number of catalyst sites are exposed to solution and reaction rates are therefore relatively high; the use of porphyrins (and other metalated heterocyclic macrocycles described herein) as templates enables the creation of novel MOMs that exhibit a cavity that is templated by the porphyrin (or other heterocyclic macrocycle); each porph@MOM is capable of variable loading of the encapsulated porphyrin (or other heterocyclic macrocycle) in order to fine tune the porosity and catalytic activity; catalyst recycling can be accomplished in a facile manner via filtration.

Having described the invention in detail, it will be apparent that modifications and variations are possible without departing the scope of the invention defined in the appended claims. Furthermore, it should be appreciated that all examples in the present disclosure are provided as non-limiting examples.

The following non-limiting examples are provided to further illustrate the present invention. It should be appreciated by those of skill in the art that the techniques disclosed in the examples that follow represent approaches the inventors have found function well in the practice of the invention, and thus can be considered to constitute examples of modes for its practice. However, those of skill in the art should, in light of the present disclosure, appreciate that many changes can be made in the specific embodiments that are disclosed and still obtain a like or similar result without departing from the spirit and scope of the invention.

### Example 1

### Templated Synthesis of POR@MOM-1

A. Reaction with Porphyrin as Template

| CdCl₂ | | |
|---|---|---|
| 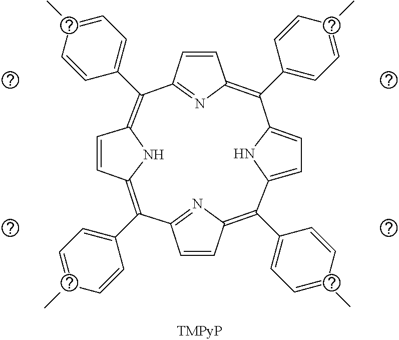 | 3.0 mL DMF 0.5 mL H₂O 85° C. → | por@MOM-1 [Cd₇(BTC)₆] · 1.5CdTMPyP(H₂O) · 2Cl Crystal system = Trigonal Space group = P-3 a = b = 30.5069(8) Å; c = 10.1233(5) Å; α = β = 90°; γ = 120°; V = 8159(19) Å³ |
| 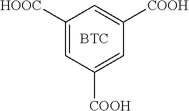 | | |

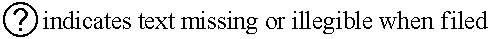

B. Reaction without Porphyrin

| CdCl₂ | | |
|---|---|---|
| 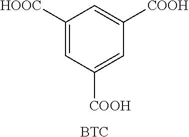 | 3.0 mL DMF 0.5 mL H₂O 85° C. → | Needle-like colorless crystals of a compound that exhibits a different PXRD pattern to that of por@MOM-1 were obtained. |

C. Procedure for Preparation of por@MOM-1

CdCl₂.4H₂O (Fisher Scientific, 36.7 mg, 0.20 mmol), 1,3,5-benzenetricarboxylic acid (BTC) (Fisher Scientific, 21.0 mg, 0.10 mmol) and meso-tetra(N-methyl-4-pyridyl) porphine tetratosylate (TMPyP) (Frontier Scientific, 4.0 mg, 0.0044 mmol) were added to a 3.5 mL solution of DMF (3.0 mL) and H₂O (0.5 mL) in a 7.0 mL scintillation vial and heated at 85° C. for 12 hrs. The reaction mixture was cooled to room temperature and dark prism crystals of por@MOM-1 were harvested and washed with methanol. Yield=5.5 mg (˜7.0%, based on CdCl₂). Crystals of por@MOM-1 were characterized by FT-IR spectroscopy (Nicolet Avatar 320 FTIR, diffuse reflectance, thermogravimetric analysis (Perkin Elmer STA 6000) and powder x-ray diffraction (a Bruker D8 Advance X-ray diffractometer at 20 kV, 5 mA for Cu_{kR} (λ=1.5418 Å). When this reaction was conducted under the same conditions but in the absence of TMPyP, tiny needle-like colorless crystals of different PXRD pattern to por@MOM-1 were obtained.

D. Crystal Structure of por@MOM-1

Data were collected for a single crystal of por@MOM-1 on a Bruker-AXS SMART APEX/CCD diffractometer using Cu_{kα} radiation (λ=1.5418 Å, T=100(2) K). Data integration and reduction were performed using SaintPlus 6.01. Absorption correction was performed by multi-scan method implemented in SADABS. Space group was determined using XPREP implemented in APEX2. The crystal structure was solved using SHELXS-97, expanded using Fourier methods and refined on F² using nonlinear least-squares techniques with SHELXL-97 contained in APEX2 and WinGX v1.70.01 program packages. por@MOM-1 adopts the trigonal space group P-3 and exhibits a honeycomb-like structure. There are two different cadmium building blocks, [Cd(COO)₃]⁻ and [Cd₂(COO)₅]⁻, which can be simplified as 3- and 5-connected nodes to link the BTC ligands into a 3, 3, 3, 5-connected net. Porphyrin molecules are located in one type of channel whereas a second channel contains disordered guest molecules or ions. The distance between two adjacent porphyrin molecules is ca. 1 nm (FIG. 2).

### Example 2

### Templated Synthesis of POR@MOM-2

A. Reaction with Porphyrin as Template

| Zn(NO₃)₂ | | |
|---|---|---|
| 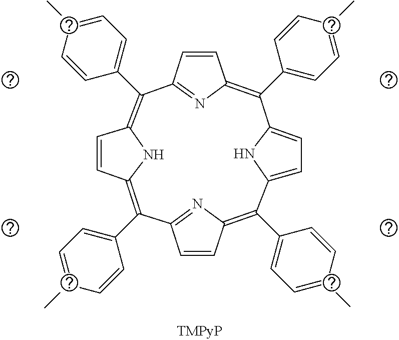 | 3.0 mL DMA 0.5 mL H₂O 85° C. → | por@MOM-2 [Zn₁₈(OH)₄(BTC)₁₂(H₂O)₁₆] · ZnTMPyP Crystal system = Orthorhombic Space group = Cmmm a = 19.623(8) Å; b = 44.246(18) Å c = 14.550(7) Å; V= 12633(9) Å³ |
| 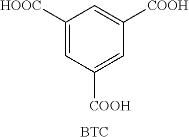 | | |

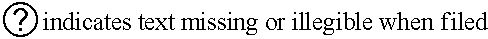

B. Reaction without Porphyrin

| | | |
|---|---|---|
| 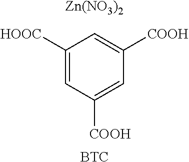 | 3.0 mL DMA 0.5 mL H₂O 85° C. → | Triangular shaped colorless crystals of a compound that exhibits a different PXRD pattern to that of por@MOM-2 were obtained. |

C. Procedure for Preparation of por@MOM-2

Zn(NO₃)₂.6H₂O (Fisher Scientific, 59.5 mg, 0.20 mmol), 1,3,5-benzenetricarboxylic acid (BTC) (Fisher Scientific, 21.0 mg, 0.10 mmol) and meso-tetra(N-methyl-4-pyridyl) porphine tetratosylate (TMPyP) (Frontier Scientific, 3.0 mg, 0.0033 mmol) were added to a 3.5 mL solution of DMA (3.0 mL) and H₂O (0.5 mL) in a 7.0 mL scintillation vial and heated at 85° C. for 48 hrs. The reaction mixture was cooled to room temperature and dark block crystals of por@MOM-2 were harvested and washed with methanol. Yield=22.0 mg (˜62.0%, based on Zn(NO₃)₂). Crystals of por@MOM-2 were characterized by FT-IR spectroscopy (Nicolet Avatar 320 FTIR, diffuse reflectance), thermogravimetric analysis (Perkin Elmer STA 6000) and powder x-ray diffraction (a Bruker D8 Advance X-ray diffractometer at 20 kV, 5 mA for Cu_{kR} (λ=1.5418 Å)). When this reaction was conducted under the same conditions but in the absence of TMPyP, triangular colorless crystals of a compound with a different PXRD pattern to that of por@MOM-2 were obtained.

D. Crystal Structure of por@MOM-2

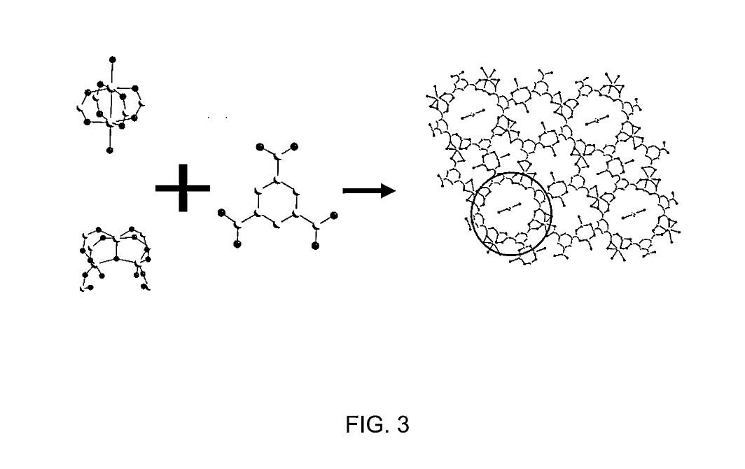

Data was collected for a single crystal of por@MOM-2 placed on a Bruker-AXS SMART APEX/CCD diffractometer using Cu_{kα} radiation (λ=1.5418 Å, T=100(2) K). Structure was solved using Patterson methods, expanded using Fourier methods and refined using nonlinear least-squares techniques on F². Indexing was performed using APEX2. Data integration and reduction were performed using SaintPlus 6.01. Absorption correction was performed by multi-scan method implemented in SADABS. Space group was determined using XPREP implemented in APEX2. The crystal structure was solved using SHELXS-97, expanded using Fourier methods and refined on F² using nonlinear least-squares techniques with SHELXL-97 contained in APEX2 and WinGX v1.70.01 programs packages. por@MOM-2 crystallizes in the orthorhombic space group Cmmm and exhibits a three-dimensional structure. As shown in FIG. 3, there are two different zinc building blocks, [Zn₂(COO)₄] and [Zn₃(OH)(COO)₆(H₂O)₂]⁻, which link the BTC ligands into a net with a new topology, a 3, 3, 4, 4, 6-connected net. Metalloporphyrin molecules are located within cavities to balance the anionic framework.

### Example 3

### Templated Synthesis of POR@MOM-3

A. Reaction with Porphyrin as Template

| | | |
|---|---|---|
| 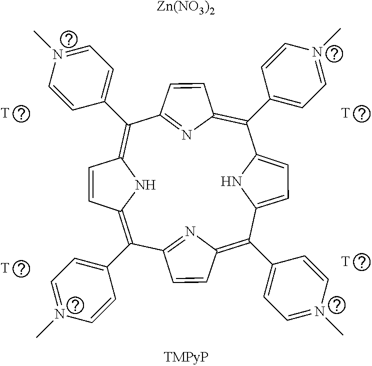 | 3.0 mL DMF 0.5 mL H₂O 85° C. → | por@MOM-3 [Zn₁₆O₄(1,4-NPD)₁₄]•ZnTMPyP Crystal system = Orthorhombic Space group = Cmca a = 17.6321(5) Å; b = 18.7219(4) Å c = 41.5804(1) Å; V = 13726.0(6) Å³ |
| 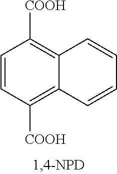 [SMILES: O=C(O)c1ccc(C(=O)O)c2ccccc12] | | |

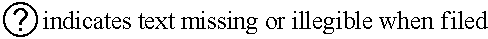

B. Reaction without Porphyrin

| | | |
|---|---|---|
| 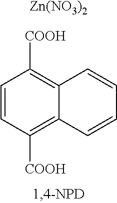 [SMILES: "Zn(NO3)2" ; O=C(O)c1ccc(C(=O)O)c2ccccc12] | 3.0 mL DMF 0.5 mL H₂O 85° C. → | Clear solution, no solid. |

C. Procedure for Preparation of por@MOM-3

Zn(NO₃)₂.6H₂O (Fisher Scientific, 59.5 mg, 0.20 mmol), 1,4-naphthalene dicarboxylate (1,4-NPD) (Fisher Scientific, 21.6 mg, 0.10 mmol) and meso-tetra(N-methyl-4-pyridyl) porphine tetratosylate (TMPyP) (Frontier Scientific, 3.0 mg, 0.0033 mmol) were added to a 3.5 mL solution of DMF (3.0 mL) and H₂O (0.5 mL) in a 7.0 mL scintillation vial and heated at 85° C. for 48 hrs. The reaction mixture was cooled to room temperature and dark block crystals of por@MOM-3 were harvested and washed with methanol. Yield=9.3 mg (˜16.2%, based on Zn(NO₃)₂). Crystals of por@MOM-3 were characterized by FT-IR spectroscopy (Nicolet Avatar 320 FTIR, diffuse reflectance), thermogravimetric analysis (Perkin Elmer STA 6000) and powder x-ray diffraction (a Bruker D8 Advance X-ray diffractometer at 20 kV, 5 mA for Cu_{kR} (λ=1.5418 Å)). When this reaction was conducted under the same conditions but in the absence of TMPyP, no solids were formed.

D. Crystal Structure of por@MOM-3

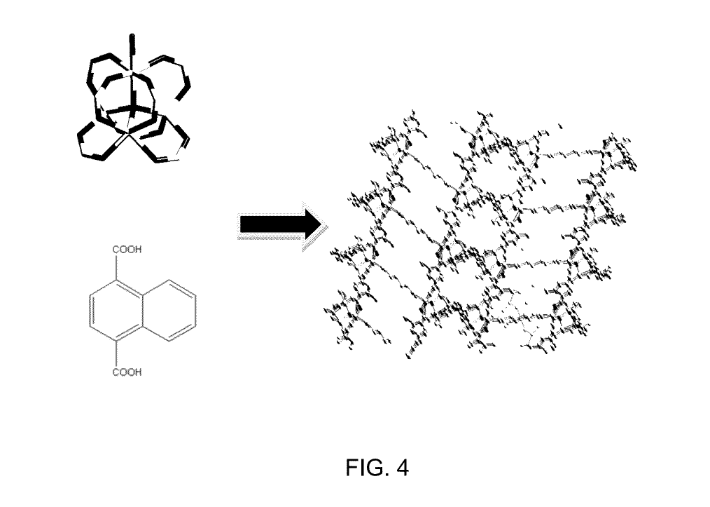

Data was collected for a single crystal of por@MOM-3 placed on a Bruker-AXS SMART APEX/CCD diffractometer using Cu_{kR} radiation (λ=1.5418 Å, T=100(2) K). Indexing was performed using APEX2. Data integration and reduction were performed using SaintPlus 6.01. Absorption correction was performed by multi-scan method implemented in SADABS. Space group was determined using XPREP implemented in APEX2. The crystal structure was solved using SHELXS-97, expanded using Fourier methods and refined on F² using nonlinear least-squares techniques with SHELXL-97 contained in APEX2 and WinGX v1.70.01 program packages. por@MOM-3 adopts the orthorhombic space group Cmca and exhibits a 3D structure that is based upon a novel building block, [Zn₄O(H₂O)(COO)₇]⁻ (FIG. 4). This building block serves as a 7-connected node to link the 1,4-NPD ligands into a ‘SEV’ net . Metalloporphyrin molecules are located the cavities to balance the anionic framework.

### Example 4

### Templated Synthesis of POR@MOM-4

A. Reaction with Porphyrin as Template

| | | |
|---|---|---|
| 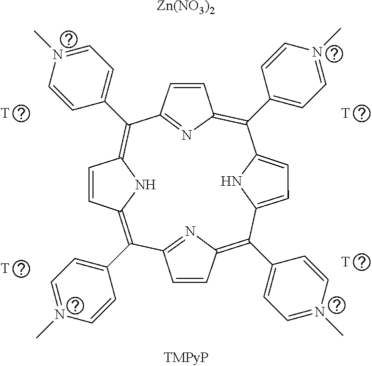 | 3.0 mL DMF 0.5 mL H₂O 85° C. → | por@MOM-4 [Zn₄O_{1.5}(BPDA)_{4.5}]•ZnTMPyP Crystal system = Monoclinic Space group = P2/c a = 17.245(5) Å; b = 17.025(5) Å; c = 43.661(12) Å; α = γ = 90°; β = 95.214(5)°; V = 13726.0(6) Å³ |
| 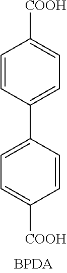 [SMILES: O=C(O)c1ccc(-c2ccc(C(=O)O)cc2)cc1] | | |

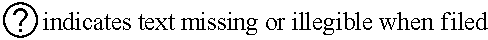

B. Reaction without Porphyrin

| | | |
|---|---|---|
| 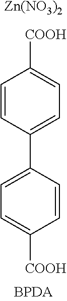 [SMILES: "Zn(NO3)2" ; O=C(O)c1ccc(-c2ccc(C(=O)O)cc2)cc1] | 3.0 mL DMF 0.5 mL H₂O 85° C. → | Colorless prismatic crystals of compound that exhibits a different powder x-ray diffraction pattern to that of por@MOM-4 |

C. Procedure for Preparation of por@MOM-4

Zn(NO₃)₂.6H₂O (Fisher Scientific, 59.5 mg, 0.20 mmol), 4,4′-biphenyldicarboxylic acid (BPDA) (Fisher Scientific, 24.2 mg, 0.10 mmol) and meso-tetra(N-methyl-4-pyridyl) porphine tetratosylate (TMPyP) (Frontier Scientific, 3.0 mg, 0.0033 mmol) were added to a 3.5 mL solution of DMF (3.0 mL) and H₂O (0.5 mL) in a 7.0 mL scintillation vial and heated at 85° C. for 48 hrs. The reaction mixture was cooled to room temperature and dark prism crystals of por@MOM-4 were harvested and washed with methanol. Yield=7.4 mg (˜8.8%, based on Zn(NO₃)₂). Crystals of por@MOM-4 were characterized by FT-IR spectroscopy (Nicolet Avatar 320 FTIR, diffuse reflectance), thermogravimetric analysis (Perkin Elmer STA 6000) and powder x-ray diffraction (a Bruker D8 Advance X-ray diffractometer at 20 kV, 5 mA for Cu_{kα} (λ=1.5418 Å). When this reaction was conducted under the same conditions but in the absence of TMPyP, colorless prismatic crystals of compound that exhibits a different PXRD pattern to that of por@MOM-4 were obtained.

D. Crystal Structure of por@MOM-4

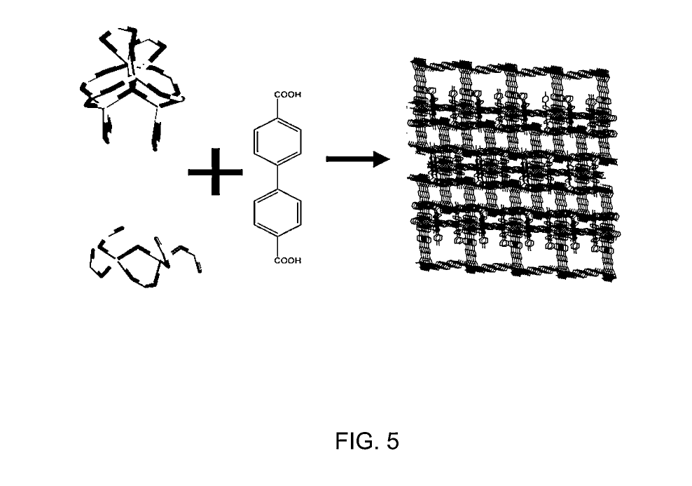

Data was collected for a single crystal of por@MOM-4 placed on a Bruker-AXS SMART APEX/CCD diffractometer using Cu_{kα} radiation (λ=1.5418 Å, T=100(2) K). Indexing was performed using APEX2. Data integration and reduction were performed using SaintPlus 6.01. Absorption correction was performed by multi-scan method implemented in SADABS. Space group was determined using XPREP implemented in APEX2. The crystal structure was solved using SHELXS-97, expanded using Fourier methods and refined on F² using nonlinear least-squares techniques with SHELXL-97 contained in APEX2 and WinGX v1.70.01 program packages. por@MOM-4 adopts the monoclinic space group P2/c and exhibits an interpenetrated structure (FIG. 5). There are two different zinc building blocks, [Zn₄(O)(COO)₈]²⁻ and [Zn₂(O)(COO)₅]³⁻, which can be simplified as 6- and 5-connected nodes that connect BPDA ligands into a two-dimensional 5,6-connected net. por@MOM-4 exhibits 2D to 3D parallel type of interpenetration. Metalloporphyrin molecules are located within cavities in the crystal lattice to balance the anionic framework.

### Example 5

### Templated Synthesis of POR@MOM-5

A. Reaction with Porphyrin as Template

| | | |
|---|---|---|
| 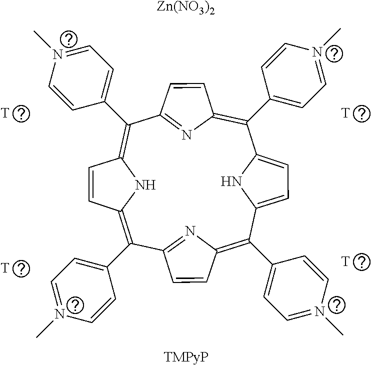 | 3.0 mL DEF 0.5 mL H₂O 85° C. → | por@MOM-5 [Zn₆(1,4-NPD)₈]•ZnTMPyP Crystal system = Orthorhombic Space group = Cmcm a = 20.525(15) Å; b = 21.985(17) Å c = 36.040(13) Å; V = 16263(22) Å³ |
| 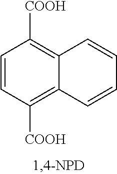 [SMILES: O=C(O)c1ccc(C(=O)O)c2ccccc12] | | |

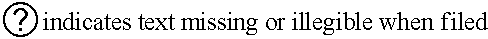

B. Reaction without Porphyrin

| | | |
|---|---|---|
| 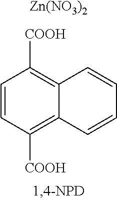 [SMILES: "Zn(NO3)2" ; O=C(O)c1ccc(C(=O)O)c2ccccc12] | 3.0 mL DEF 0.5 mL H₂O 85° C. → | Block colorless crystals of a compound that exhibits a different PXRD pattern to that of por@MOM-5 were obtained. |

C. Procedure for Preparation of por@MOM-5

Zn(NO₃)₂.6H₂O (Fisher Scientific, 59.5 mg, 0.20 mmol), 1,4-naphthalene dicarboxylate (1,4-NPD) (Fisher Scientific, 21.6 mg, 0.10 mmol) and meso-tetra(N-methyl-4-pyridyl) porphine tetratosylate (TMPyP) (Frontier Scientific, 3.0 mg, 0.0033 mmol) were added to a 3.5 mL solution of DEF (3.0 mL) and H₂O (0.5 mL) in a 7.0 mL scintillation vial and heated at 85° C. for 48 hrs. The reaction mixture was cooled to room temperature and dark prismatic crystals of por@MOM-5 were harvested and washed with methanol. Yield=2.8 mg (˜4.0%, based on Zn(NO₃)₂). Crystals of por@MOM-5 were characterized by FT-IR spectroscopy (Nicolet Avatar 320 FTIR, diffuse reflectance), thermogravimetric analysis (Perkin Elmer STA 6000) and powder x-ray diffraction (a Bruker D8 Advance X-ray diffractometer at 20 kV, 5 mA for Cu_{kR} (λ=1.5418 Å)). When this reaction was conducted under the same conditions but in the absence of TMPyP, block-shaped colorless crystals that exhibit a different PXRD pattern to that of Por@MOM-5 were observed.

D. Crystal Structure of por@MOM-5

Data was collected for a single crystal of por@MOM-5 placed on a Bruker-AXS SMART APEX/CCD diffractometer using Cu_{kR} radiation (λ=1.5418 Å, T=100(2) K). Indexing was performed using APEX2. Data integration and reduction were performed using SaintPlus 6.01. Absorption correction was performed by multi-scan method implemented in SADABS. Space group was determined using XPREP implemented in APEX2. The crystal structure was solved using SHELXS-97, expanded using Fourier methods and refined on F² using nonlinear least-squares techniques with SHELXL-97 contained in APEX2 and WinGX v1.70.01 program packages. por@MOM-5 adopts the orthorhombic space group Cmcm and exhibits a 3D structure that is based upon [Zn₃(COO)₈]²⁻ clusters (FIG. 6). This cluster serves as a 6-connected node to link the 1,4-NPD ligands into a pcu net. Metalloporphyrin molecules are located within the cavities of pcu network.

### Example 6

### Templated Synthesis and Catalytic Activity of CoTMPyP@HKUST-1-Co, POR@MOM-6

A. Reaction with Porphyrin as Template

| | | |
|---|---|---|
| 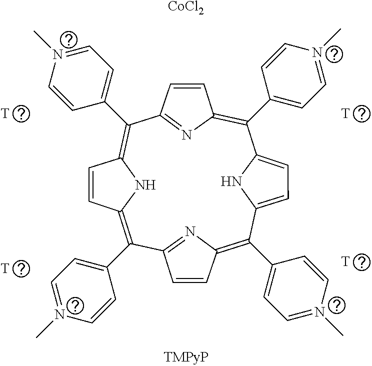 | 3.0 mL DMF 0.5 mL H₂O 85° C. → | CoTMPyP@HKUST-1-Co [Co₁₂(BTC)₈(S)₁₂]•xCoTMPyPCl₄ (S = H₂O or DMF, x = 0.05-1.00 depending upon the relative amount of porphyrin used during synthesis) Crystal system = Cubic Space group = Fm-3m a = 26.4292(11) Å, V = 18460.9(13) Å³ This compound is isostructural with HKUST-1-Cu which was previously reported by Williams et al.: Chui, S. S. Y.; Lo, S. M. F.; Charmant, J. P. H.; Orpen, A. G.; Williams, I. D. Science 1999, 283, 1148. |
| 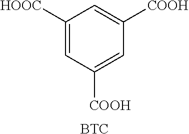 | | |

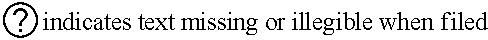

B. Reaction without Porphyrin

| | | |
|---|---|---|
| CoCl₂ | 3.0 mL DMF 0.5 mL H₂O 85° C. → | [Co₆(HCOO)(BTC)₂(DMF)₆]ₙ Crystal system = Trigonal Space group = P-3 a = 13.975(2) Å c = 8.165(1) Å, V = 1380.990 Å³ |
| 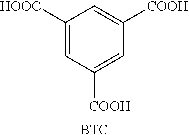 | | This product was previously reported by Xu et al.: He, J.; Zhang, Y.; Pan, Q.; Yu, J.; Ding, H.; Xu, R. Microporous Mesoporous Mater. 2006, 90, 145. |

C. Procedure for Preparation and Catalytic Activity of CoTMPyP@HKUST-1-Co

In a typical reaction CoCl₂.4H₂O (Fisher Scientific, 47.6 mg, 0.20 mmol), 1,3,5-benzenetricarboxylic acid (BTC) (Fisher Scientific, 1.0 mg, 0.10 mmol) and meso-tetra(N-methyl-4-pyridyl) porphine tetratosylate (TMPyP) (Frontier Scientific, 1.4 mg, 0.0015 mmol) were added to a 3.5 mL solution of DMF (3.0 mL) and H₂O (0.5 mL) in a 7.0 mL scintillation vial and heated at 85° C. for 12 hrs. The reaction mixture was cooled to room temperature and dark cubic crystals of CoTMPyP@HKUST-1-Co were harvested and washed with methanol. Yield=5.1 mg (˜15%, based on CoCl₂). Crystals of CoTMPyP@HKUST-1-Co were characterized by FT-IR spectroscopy (Nicolet Avatar 320 FTIR, diffuse reflectance), thermogravimetric analysis (Perkin Elmer STA 6000) and powder x-ray diffraction (a Bruker D8 Advance X-ray diffractometer at 20 kV, 5 mA for Cu_{kα} (λ=1.5418 Å)). When this reaction was conducted under the same conditions but in the absence of TMPyP crystals of [Co₆(HCOO)(BTC)₂(DMF)₆]ₙ were obtained. The identity of [Co₆(HCOO)(BTC)₂(DMF)₆]ₙ was confirmed by single crystal x-ray crystallography and powder x-ray diffraction.

The catalytic activity of CoTMPyP@HKUST-1-Co with respect to styrene oxidation was studied as follows: crystals of CoTMPyP@HKUST-1-Co (10.0 mg) were immersed in acetonitrile for 24 hrs, filtered and placed in a solution of 1 mmol styrene, 2 mmol t-BuOOH, 40 μL 1,2-dichlorobenzene (internal standard) and 5.0 mL acetonitrile. The reaction mixture was heated at 60° C. for 10 hrs and monitored by GC-MS (HP-5MS 5% PHENYL METHYL SILOXANE, 30 m×0.25 mm×0.25 μm; injector: 250° C.; Method: hold 1 min at 50° C., then rise to 120° C. with 7° C./min; Detector: 170° C.; Carrier gas: He (1.1 mL/min)): styrene=4.7 min; benzaldehyde=6.1 min; 1,2-dichlorobenzene=7.5 min; styrene oxide=8.2 min; benzoic acid=11.8 min. A control reaction without any catalyst was conducted under the same conditions and revealed <7% conversion (vs. 92% in the presence of CoTMPyP@HKUST-1-Co).

D. Crystal Structure of CoTMPyP@HKUST-1-Co

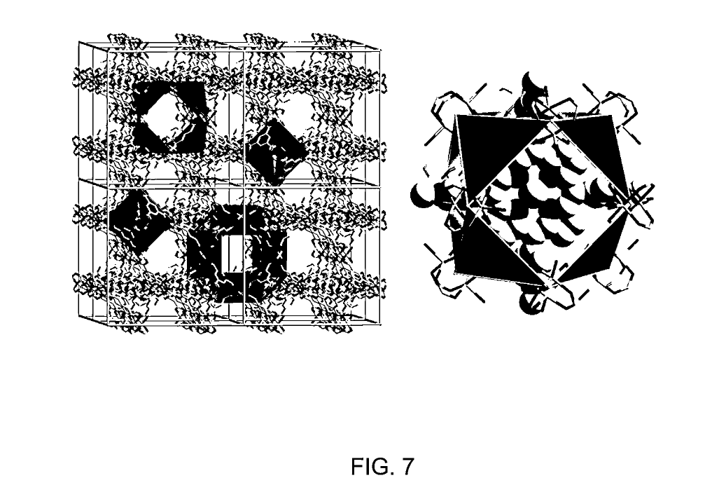

Data were collected for a single crystal of CoTMPyP@HKUST-Co at the Advanced Photon Source on beamline 151D-C of ChemMatCARS Sector 15 (λ=0.40663 Å, T=100(2) K). The crystal structure was solved using SHELXS-97, expanded using Fourier methods and refined on F² using nonlinear least-squares techniques with SHELXL-97 contained in APEX2 and WinGX v1.70.01 program packages. CoTMPyP@HKUST-1-Co adopts space group Fm-3m, a=26.4295(11) Å. It is isostructural with HKUST-1 and therefore exhibits tbo topology. The tbo structure can be interpreted from two viewpoints, the polyhedral approach or the net approach. With the former approach, the entire framework can be disassembled into three polyhedral cages of stoichiometry 1:1:2 as follows: small rhombihexahedron cage; cuboctahedral cage; tetrahedral cage (FIG. 7). The cuboctahedral cage is the only one of the three cages that is well-suited for encapsulation of tetrasubstituted porphyrin molecules since its Oₕ symmetry matches the porphyrin's D₄ₕ symmetry (as a subgroup) and the spherical cavity (diameter ˜13 Å) is a good size fit for the porphyrin ring (diameter ˜10 Å) of TMPyP. In addition, the structure can also be interpreted as consisting of dicobalt tetracarboxylate paddlewheels serving as pillars to link 2D square grid or kagomé nets into 3D networks with TMPyP molecules lying in the interlayer region in a sandwich fashion.

### Example 7

### Templated Synthesis and Catalytic Activity of FETMPYP@HKUST-1-FE, POR@MOM-7

A. Reaction with Porphyrin as Template

| | | |
|---|---|---|
| 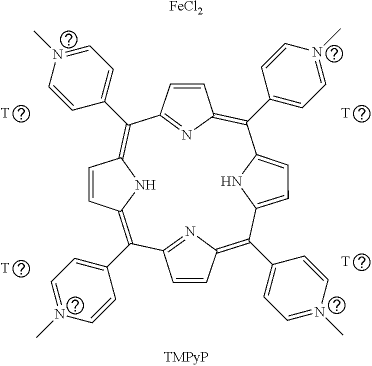 | 3.0 mL DMF 0.5 mL H₂O 85° C. → | FeTMPyP@HKUST-1-Fe [Fe₁₂(BTC)₈(S)₁₂]Cl₆•xFeTMPyPCl₅ (S = H₂O or DMF, x = 0.05- 1.00 depending upon the relative amount of porphyrin used during synthesis) Crystal system = Cubic Space group = Fm-3m a = 26.5717(17) Å, V = 18761(2) Å³ This compound is isostructural with HKUST-1-Cu which was previously reported by Williams et al.: Chui, S. S. Y.; Lo, S. M. F.; Charmant, J. P. H.; Orpen, A. G.; Williams, I. D. Science 1999, 283, 1148. |
| 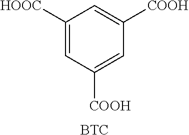 | | |

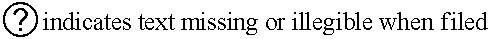

B. Reaction without Porphyrin

| | | |
|---|---|---|
| 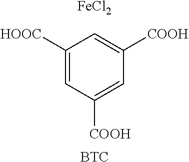 | 3.0 mL DMF 0.5 mL H₂O 85° C. → | Yellow precipitate of a compound that exhibits a different powder x-ray diffraction pattern to that of FeTMPyP@HKUST-1-Fe |

C. Procedure for Preparation of FeTMPyP@HKUST-1-Fe

In a typical reaction FeCl₂.4H₂O (Fisher Scientific, 39.8 mg, 0.20 mmol), 1,3,5-benzenetricarboxylic acid (BTC) (Fisher Scientific, 21.0 mg, 0.10 mmol) and meso-tetra(N-methyl-4-pyridyl) porphine tetratosylate (TMPyP) (Frontier Scientific, 1.4 mg, 0.0015 mmol) were added to a 3.5 mL solution of DMF (3.0 mL) and H₂O (0.5 mL) in a 7.0 mL scintillation vial and heated at 85° C. for 12 hrs. The reaction mixture was cooled to room temperature and dark cubic crystals of FeTMPyP@HKUST-1-Fe were harvested and washed with methanol. Yield=13.1 mg (˜30.9% based on FeCl₂). Crystals of FeTMPyP@HKUST-1-Fe were characterized by FT-IR spectroscopy (Nicolet Avatar 320 FTIR, diffuse reflectance), thermogravimetric analysis (Perkin Elmer STA 6000) and powder x-ray diffraction (a Bruker D8 Advance X-ray diffractometer at 20 kV, 5 mA for Cu_{kα} (λ=1.5418 Å)). When this reaction was conducted under the same conditions but in the absence of TMPyP, a yellow precipitate of a compound that exhibits a different powder x-ray diffraction pattern to that of FeTMPyP@HKUST-1-Fe was obtained.

The catalytic activity of FeTMPyP@HKUST-1-Fe with respect to styrene oxidation was studied as follows: Crystals of FeTMPyP@HKUST-1-Fe (10.0 mg) were immersed in acetonitrile for 24 hrs, filtered and placed in a solution of 1 mmol styrene, 2 mmol t-BuOOH, 40 μL 1,2-dichlorobenzene (internal standard) and 5.0 mL acetonitrile. The reaction mixture was heated at 60° C. for 10 h and monitored by GC-MS (HP-5MS 5% PHENYL METHYL SILOXANE, 30 m×0.25 mm×0.25 μm; injector: 250° C.; Method: hold 1 min at 50° C., then rise to 120° C. with 7° C./min; Detector: 170° C.; Carrier gas: He (1.1 mL/min)): styrene=4.7 min; benzaldehyde=6.1 min; 1,2-dichlorobenzene=7.5 min; styrene oxide=8.2 min; benzoic acid=11.8 min. After the catalytic reaction was concluded the reaction solution was filtered and the filtrant was recycled to evaluate whether or not it had retained its catalytic activity. Even after seven 10 hr cycles >55% conversion of styrene was observed. Two control reactions were conducted for comparison purposes: a homogeneous reaction with an equivalent molar amount of commercially available FeTMPyP; a homogenous reaction without any catalyst. When these control reactions were conducted using the same solvent system, temperature and duration <7% and ca. 35% conversion of styrene, respectively, were observed.

D. Crystal Structure of FeTMPyP@HKUST-1-Fe

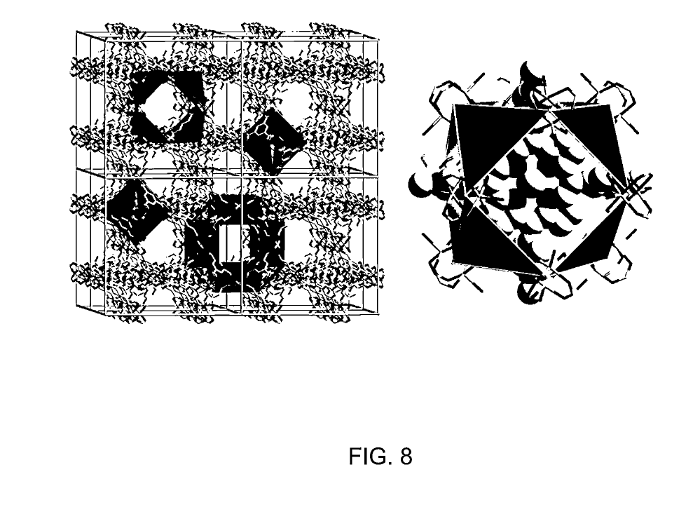

Data were collected for a single crystal of FeTMPyP@HKUST-Fe placed on a Bruker-AXS SMART APEX/CCD diffractometer using Cu_{kα} radiation (λ=1.5418 Å, T=100(2) K). Indexing was performed using APEX2. Data integration and reduction were performed using SaintPlus 6.01. Absorption correction was performed by multi-scan method implemented in SADABS. Space group was determined using XPREP implemented in APEX2. The crystal structure was solved using SHELXS-97, expanded using Fourier methods and refined on F² using nonlinear least-squares techniques with SHELXL-97 contained in APEX2 and WinGX v1.70.01 program packages. FeTMPyP@HKUST-1-Fe adopts space group Fm-3m, a=26.5717(17) Å. It is isostructural with HKUST-1 and therefore exhibits tbo topology. The tbo structure can be interpreted from two viewpoints, the polyhedral approach or the net approach. With the former approach, the entire framework can be disassembled into three polyhedral cages of stoichiometry 1:1:2: small rhombihexahedron cage, cuboctahedral cage, and tetrahedral cage (FIG. 8). The cuboctahedral cage is the only one of the three cages that is well-suited for encapsulation of tetrasubstituted porphyrin molecules since its Oₕ symmetry matches the porphyrin's D₄ₕ symmetry (as a subgroup) and the spherical cavity (diameter ˜13 Å) is a good size fit for the porphyrin ring (diameter ˜10 Å) of TMPyP. In addition, the structure can also be interpreted as consisting of diiron tetracarboxylate paddlewheels serving as pillars to link 2D square grid or kagomé nets into 3D networks with TMPyP molecules lying in the interlayer region in a sandwich fashion.

### Example 8

### Templated Synthesis and Catalytic Activity of MNTMPYP@HKUST-1-MN, POR@MOM-8

A. Reaction with Porphyrin as Template

| | | |
|---|---|---|
| 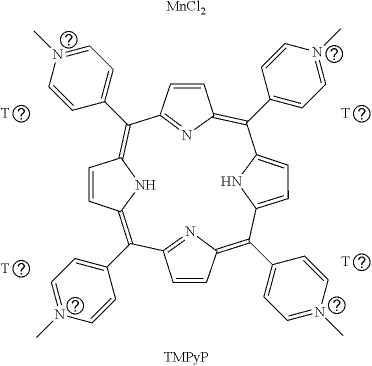 | 3.0 mL DMF 0.5 mL H₂O 85° C. → | MnTMPyP@HKUST-1-Mn [Mn₁₂(BTC)₈(S)₁₂]•xMnTMPyPCl₅ (S = H₂O or DMF, x = 0.05-1.00 depending upon the relative amount of porphyrin used during synthesis) Crystal system = Cubic Space group = Fm-3m a = 26.597(2) Å, V = 18460.9(13) Å³ This compound is isostructural with HKUST-1-Cu which was previously reported by Williams et al.: Chui, S. S. Y.; Lo, S. M. F.; Charmant, J. P. H.; Orpen, A. G.; Williams, I. D. Science 1999, 283, 1148. |
| 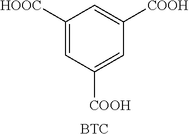 | | |

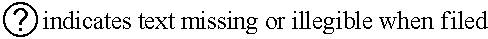

B. Reaction without Porphyrin

| | | |
|---|---|---|
| 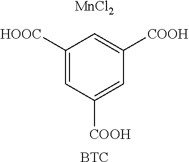 | 3.0 mL DMF 0.5 mL H₂O 85° C. → | [Mn₆(HCOO)(BTC)₂(DMF)₆]ₙ Crystal system = Trigonal Space group = P-3 a = 13.90 Å c = 8.11 Å, V = 1434.454 Å³ This product was previously reported by Kitagawa et al.: Chen, J.; Ohba, M.; Kitagawa, S. Chem. Lett. 2006, 35, 526. |

C. Procedure for Preparation of MnTMPyP@HKUST-1-Mn

In a typical reaction MnCl₂.4H₂O (Fisher Scientific, 38.4 mg, 0.20 mmol), 1,3,5-benzenetricarboxylic acid (BTC) (Fisher Scientific, 21.0 mg, 0.10 mmol) and meso-tetra(N-methyl-4-pyridyl) porphine tetratosylate (TMPyP) (Frontier Scientific, 1.4 mg, 0.0015 mmol) were added to a 3.5 mL solution of DMF (3.0 mL) and H₂O (0.5 mL) in a 7.0 mL scintillation vial and heated at 85° C. for 12 hrs. The reaction mixture was cooled to room temperature and dark cubic crystals of MnTMPyP@HKUST-1-Mn were harvested and washed with methanol. Yield=2.5 mg (˜6.0%, based on MnCl₂). Crystals of MnTMPyP@HKUST-1-Mn were characterized by FT-IR spectroscopy (Nicolet Avatar 320 FTIR, diffuse reflectance, thermogravimetric analysis (Perkin Elmer STA 6000) and powder x-ray diffraction (a Bruker D8 Advance X-ray diffractometer at 20 kV, 5 mA for Cu_{kα} (λ=1.5418 Å)). When this reaction was conducted under the same conditions but in the absence of TMPyP crystals of [Mn₆(HCOO)(BTC)₂(DMF)₆]ₙ were obtained. The identity of [Mn₆(HCOO)(BTC)₂(DMF)₆]ₙ was confirmed by both of single crystal x-ray crystallography and powder x-ray diffraction. The catalytic activity of MnTMPyP@HKUST-1-Mn with respect to styrene oxidation was studied as follows: Crystals of MnTMPyP@HKUST-1-Mn (10.0 mg) were immersed in acetonitrile for 24 hrs, filtered and placed in a solution of 1 mmol styrene, 2 mmol t-BuOOH, 40 μL 1,2-dichlorobenzene (internal standard) and 5.0 mL acetonitrile. The reaction mixture was heated at 60° C. for 10 hrs and monitored by GC-MS (HP-5MS 5% PHENYL METHYL SILOXANE, 30 m×0.25 mm×0.25 μm; injector: 250° C.; Method: hold 1 min at 50° C., then rise to 120° C. with 7° C./min; Detector: 170° C.; Carrier gas: He (1.1 mL/min)): styrene=4.7 min; benzaldehyde=6.1 min; 1,2-dichlorobenzene=7.5 min; styrene oxide=8.2 min; benzoic acid=11.8 min. A control reaction was conducted for comparison purposes: a homogeneous reaction with an equivalent molar amount of commercially available MnTMPyP was conducted using the same solvent system, temperature and duration. <64% conversion of styrene was observed (vs. 81% for reaction conducted in the presence of MnTMPyP@HKUST-1-Mn).

D. Crystal Structure of MnTMPyP@HKUST-1-Mn

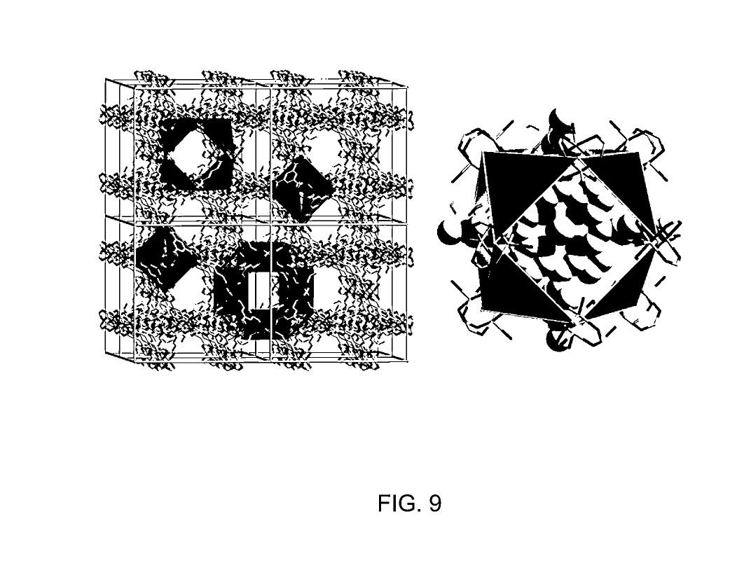

Data were collected for a single crystal of MnTMPyP@HKUST-1-Mn at the Advanced Photon Source on beamline 151D-C of ChemMatCARS Sector 15 (λ=0.40663 Å, T=100(2) K). The crystal structure was solved using SHELXS-97, expanded using Fourier methods and refined on F² using nonlinear least-squares techniques with SHELXL-97 contained in APEX2 and WinGX v1.70.01 program packages. MnTMPyP@HKUST-1-Mn adopts space group Fm-3m, a=26.597(2) Å. It is isostructural with HKUST-1 and therefore exhibits tbo topology. The tbo structure can be interpreted from two viewpoints, the polyhedral approach or the net approach. With the former approach, the entire framework can be disassembled into three polyhedral cages of stoichiometry 1:1:2 as follows: small rhombihexahedron cage; cuboctahedral cage; tetrahedral cage (FIG. 9). The cuboctahedral cage is the only one of the three cages that is well-suited for encapsulation of tetrasubstituted porphyrin molecules since its Oₕ symmetry matches the porphyrin's D₄ₕ symmetry (as a subgroup) and the spherical cavity (diameter ˜13 Å) is a good size fit for the porphyrin ring (diameter ˜10 Å) of TMPyP. In addition, the structure can also be interpreted as consisting of dimanganese tetracarboxylate paddlewheels serving as pillars to link 2D square grid or kagomé nets into 3D networks with TMPyP molecules lying in the interlayer region in a sandwich fashion.

### Example 9

### Templated Synthesis of NiTMPyP@HKUST-2-Ni, POR@MOM-9

A. Reaction with Porphyrin as Template

| | | |
|---|---|---|
| 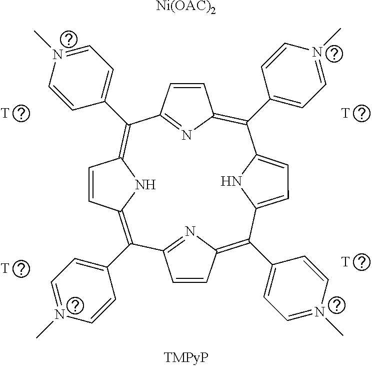 | 2.0 mL DMF 0.4 mL H₂O 85° C. → | NiTMPyP@HKUST-2-Ni [Ni₁₀(BTC)₈(H₂O)₁₂(S)₈]•xNiTMPyP (S = H₂O or DMF, x = 0.05-1.00 depending upon the relative amount of porphyrin used during synthesis) Crystal system = Cubic Space group = Fm-3m a = 27.4849(8) Å, V = 20747(3) Å³ |
| 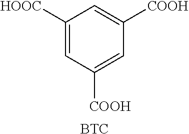 | | |

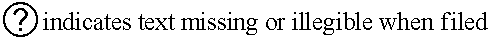

B. Reaction without porphyrin

| | | |
|---|---|---|
| 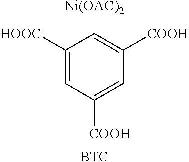 | 2.0 mL DMF 0.4 mL H₂O 85° C. → | Prismatic light green crystals of a compound that exhibits a different powder x-ray diffraction pattern to that of NiTMPyP@HKUST-2-Ni were obtained. |

C. Procedure for Preparation of NiTMPyP@HKUST-2-Ni

In a typical reaction Ni(OAC)₂.4H₂O (Fisher Scientific, 8.3 mg, 0.03 mmol), 1,3,5-benzenetricarboxylic acid (BTC) (Fisher Scientific, 10.5 mg, 0.05 mmol) and meso-tetra(N-methyl-4-pyridyl) porphine tetratosylate (TMPyP) (Frontier Scientific, 2.0 mg, 0.0022 mmol) were added to a 2.4 mL solution of DMF (2.0 mL) and H₂O (0.4 mL) in a 7.0 mL scintillation vial and heated at 85° C. for 48 hrs. The reaction mixture was cooled to room temperature and red cubic crystals of NiTMPyP@HKUST-2-Ni were harvested and washed with methanol. Yield=5.0 mg (˜66%, based on Ni(OAC)₂). Crystals of NiTMPyP@HKUST-2-Ni were characterized by FT-IR spectroscopy (Nicolet Avatar 320 FTIR, diffuse reflectance), thermogravimetric analysis (Perkin Elmer STA 6000) and powder x-ray diffraction (a Bruker D8 Advance X-ray diffractometer at 20 kV, 5 mA for Cu_{kα} (λ=1.5418 Å)). When this reaction was conducted under the same conditions but in the absence of TMPyP, prismatic light green crystals were obtained of a compound that exhibits a different powder x-ray diffraction pattern to that of NiTMPyP@HKUST-2-Ni.

D. Crystal Structure of NiTMPyP@HKUST-2-Ni

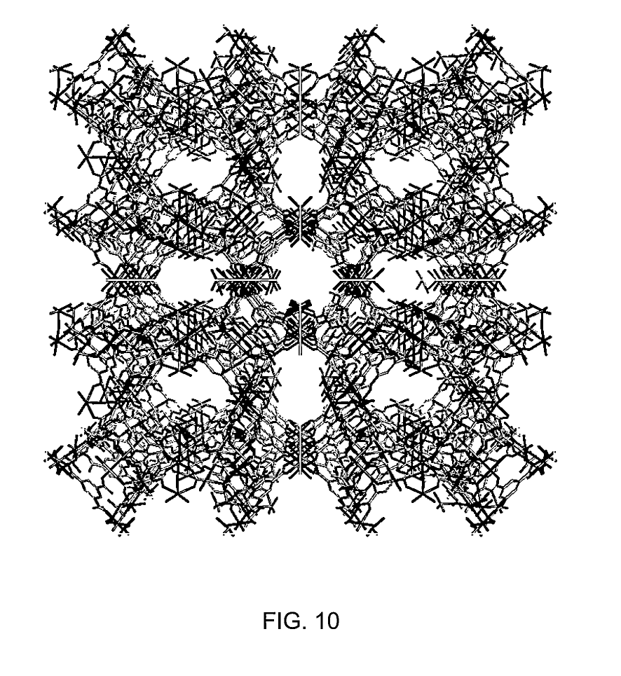

Data were collected for a single crystal of NiTMPyP@HKUST-2-Ni placed on a Bruker-AXS SMART APEX/CCD diffractometer using Cu_{kα} radiation (λ=1.5418 Å, T=100(2) K). Indexing was performed using APEX2. Data integration and reduction were performed using SaintPlus 6.01. Absorption correction was performed by multi-scan method implemented in SADABS. Space group was determined using XPREP implemented in APEX2. The crystal structure was solved using SHELXS-97, expanded using Fourier methods and refined on F² using nonlinear least-squares techniques with SHELXL-97 contained in APEX2 and WinGX v1.70.01 program packages. NiTMPyP@HKUST-2-Ni adopts space group Fm-3m, a=27.4849(8) Å. It has the same tbo topology to HKUST-1. However, the building blocks in NiTMPyP@HKUST-2-Ni are [Ni(H₂O)₂(COO)₄]²⁻ and [Ni₂(H₂O)₄(COO)₄]. The tbo structure (FIG. 10) can be disassembled into three polyhedral cages of stoichiometry 1:1:2: small rhombihexahedron cage, cuboctahedral cage, and tetrahedral cage. The cuboctahedral cage is the only one of the three cages that is well-suited for encapsulation of tetrasubstituted porphyrin molecules since its Oₕ symmetry matches the porphyrin's D₄ₕ symmetry (as a subgroup) and the spherical cavity is a good size fit for the porphyrin ring of TMPyP.

### Example 10

### Templated Synthesis of MGTMPYP@HKUST-2-MG, POR@MOM-10

A. Reaction with Porphyrin as Template

| Mg(OAC)₂ | | |
|---|---|---|
| 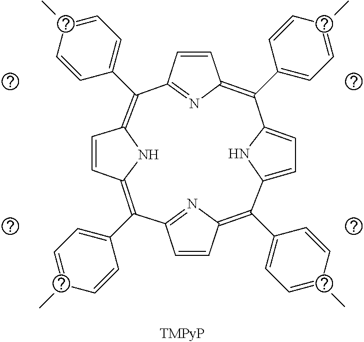 | 2.0 mL DMF 0.4 mL H₂O 85° C. → | MgTMPyP@HKUST-2-Mg [Mg₁₀(BTC)₈(H₂O)₁₂(S)₈] · xMgTMP yP (S = H₂O or DMF, x = 0.05- 1.00 depending upon the relative amount of porphyrin used during synthesis) |
| 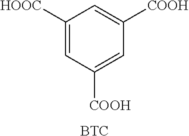 | | |

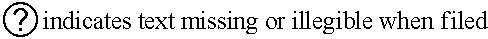

B. Reaction without Porphyrin

| Mg(OAC)₂ | | |
|---|---|---|
| 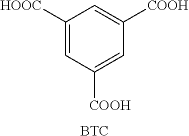 | 2.0 ml DMF 0.4 ml H₂O 85° C. → | Prismatic colorless crystals of a compound that exhibits a different powder x-ray diffraction pattern to that of MgTMPyP@HKUST- 2-Mg were obtained. |

C. Procedure for Preparation of MgTMPyP@HKUST-2-Mg

In a typical reaction Mg(OAC)₂.4H₂O (Fisher Scientific, 6.4 mg, 0.03 mmol), 1,3,5-benzenetricarboxylic acid (BTC) (Fisher Scientific, 10.5 mg, 0.05 mmol) and meso-tetra(N-methyl-4-pyridyl) porphine tetratosylate (TMPyP) (Frontier Scientific, 2.0 mg, 0.0022 mmol) were added to a 2.4 mL solution of DMF (2.0 mL) and H₂O (0.4 mL) in a 7.0 mL scintillation vial and heated at 85° C. for 48 hrs. The reaction mixture was cooled to room temperature and dark red cubic crystals of MgTMPyP@HKUST-2-Mg were harvested and washed with methanol. Yield=2.1 mg (˜30.3%, based on Mg(OAC)₂). Crystals of MgTMPyP@HKUST-2-Mg were characterized by FT-IR spectroscopy (Nicolet Avatar 320 FTIR, diffuse reflectance), thermogravimetric analysis (Perkin Elmer STA 6000) and powder x-ray diffraction (a Bruker D8 Advance X-ray diffractometer at 20 kV, 5 mA for Cu_{kα} (λ=1.5418 Å)). When this reaction was conducted under the same conditions but in the absence of TMPyP, prismatic colorless crystals were obtained of a compound that exhibits a different powder x-ray diffraction pattern to that of MgTMPyP@HKUST-2-Mg.

D. Crystal Structure of MgTMPyP@HKUST-2-Mg

The experimental PXRD pattern of MgTMPyP@HKUST-2-Mg matches the calculated PXRD pattern of NiTMPyP@HKUST-2-Ni indicating that MgTMPyP@HKUST-2-Mg is isostructural with NiTMPyP@HKUST-2-Ni.

### Example 11

### Templated Synthesis of POR@MOM-11

A. Reaction with Porphyrin as Template

| CdCl₂ | | |
|---|---|---|
| 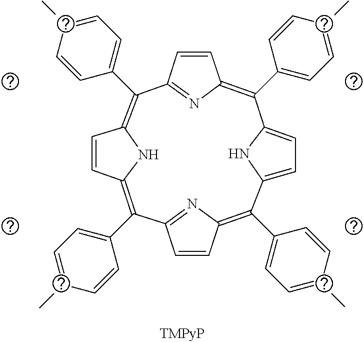 | 2.0 mL DMF 0.5 mL H₂O 85° C. → | Por@MOM-11 [Cd₆(BPT)₄Cl₄(H₂O)₄] · [C₄₄H₃₆N₈CdCl] · [H₃O] · [solvent] Crystal system = Tetragonal Space group = P4/n a = b = 28.9318(4)Å; c = 10.3646(3) Å; α = β = γ = 90°; V = 8675.7(3)Å³ |
| 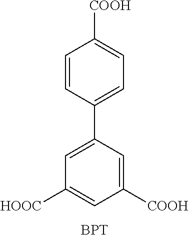 | | |

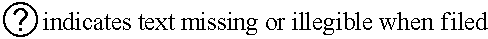

B. Reaction without Porphyrin

| CdCl₂ | | |
|---|---|---|
| 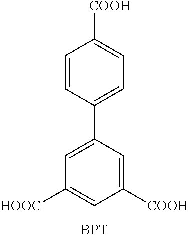 | 2.0 mL DMF 0.5 mL H₂O 85° C. → | Prism colorless crystals of a compound that exhibit a different PXRD pattern to that of Por@MOM-11 were obtained. |

C. Procedure for Preparation of Por@MOM-11

CdCl₂(Fisher Scientific, 91.7 mg, 0.50 mmol), biphenyl-3,4′,5-tricarboxylate (H₃BPT) (Fisher Scientific, 14.8 mg, 0.05 mmol) and meso-tetra(N-methyl-4-pyridyl) porphine tetratosylate (TMPyP) (Frontier Scientific, 15.0 mg, 0.011 mmol) were added to DMF (2.0 mL) and H₂O (0.5 mL) in a 7.0 mL scintillation vial and heated at 85° C. for 12 hrs. The reaction mixture was cooled to room temperature and dark-red prism crystals of Por@MOM-11 were harvestedand washed with methanol. Crystals of Por@MOM-11 were characterized by thermogravimetric analysis (Perkin Elmer STA 6000) and powder x-ray diffraction (a Bruker D8 Advance X-ray diffractometer at 20 kV, 5 mA for Cu_{kR} (λ=1.5418 Å)). When this reaction was conducted under the same conditions but in the absence of TMPyP, prism colorless crystals of different PXRD pattern to Por@MOM-11 were obtained.

D. Crystal Structure of Por@MOM-11

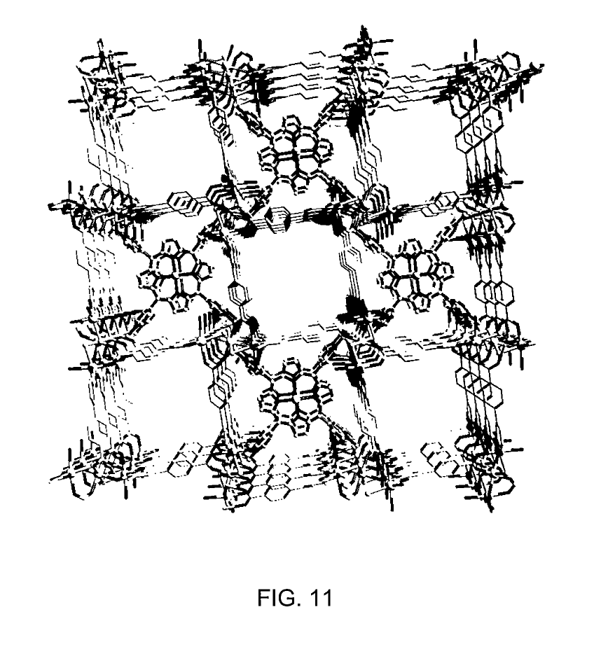

Data were collected for a single crystal of Por@MOM-11 on a Bruker-AXS SMART APEX/CCD diffractometer using Cu_{kα} radiation (λ=1.5418 Å, T=100(2) K). Data integration and reduction were performed using SaintPlus 6.01. Absorption correction was performed by multi-scan method implemented in SADABS. Space group was determined using XPREP implemented in APEX2. The crystal structure was solved using SHELXS-97, expanded using Fourier methods and refined on F² using nonlinear least-squares techniques with SHELXL-97 contained in APEX2 and WinGX v1.70.01 program packages. FIG. 11 reveals that the framework of Por@MOM-11 contains two independent Cd(II) cations, Cd1 and Cd2, one crystallographically independent BPT ligand and one crystallographically ordered CdTMPyP cation. Cd2 adopts a distorted octahedral geometry via coordination to four carboxylate oxygen atoms, an aqua ligand and a μ₂-chloride anion. Cd1 possesses distorted octahedral geometry through four carboxylate oxygen atoms and two μ₂-chloride anions. Cd—O bond distances range from 2.205(5) to 2.392(5) Å and Cd—Cl bond distances lie between 2.560(2) and 2.682(7) Å, both ranges being consistent with expected values. Cd1 and Cd2 thereby form a 6-connected trimetallic molecular building block (MBB), [Cd₃(Cl)₂(COO)₆]²⁻. These MBBs are linked by 3-connected BPT ligands to form a 3,6-connected network with Schläfli symbol {4.6²}₂{4²0.6¹⁰0.8³}. Projecting the structure along the c axis (FIG. 11) reveals that there is a 1:1 ratio of two types of square channel: (A) ˜12.6 Å×12.6 Å; (B) ˜11.9 Å×11.9 Å (after subtracting van der Waals radii). CdTMPyP cations stack in channel A separated by 10.3 Å whereas channel B is occupied by solvent molecules.

### Example 12

### Templated Synthesis of POR@MOM-12

A. Reaction with Porphyrin as Template

| Cd(NO₃)₂ | | |
|---|---|---|
| 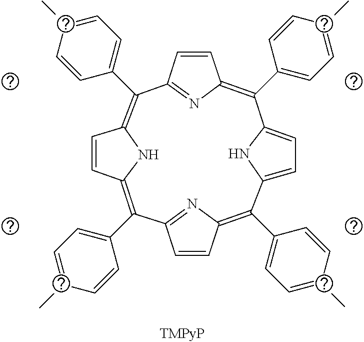 | 2.0 mL DMF 0.4 mL H₂O 85° C. → | Por@MOM-12 [Cd₄(BPT)₄] · [C₄₄H₃₆N₈Cd(solvent)] · [solvent]Crystal system = Triclinic Space group = P-1 a = 10.027(3) Å; b = 18.420(5)Å; c = 20.577(6)Å; α = 89.269(7)°; β = 84.180(7)°; γ = 88.402(6)°; V = 3779.3(19)Å³ |
| 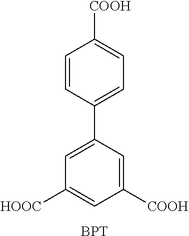 | | |

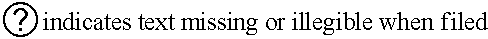

B. Reaction without Porphyrin

| Cd(NO₃)₂ | | |
|---|---|---|
| 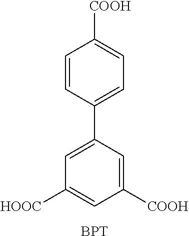 | 2.0 mL DMF 0.4 mL H₂O 85° C. → | Prism colorless crystals of a compound that exhibit a different PXRD pattern to that of Por@MOM-12 were obtained. |

C. Procedure for Preparation of Por@MOM-12

Cd(NO₃)₂.4H₂O (Fisher Scientific, 15.4 mg, 0.05 mmol), biphenyl-3,4′,5-tricarboxylate (H₃BPT) (Fisher Scientific, 14.8 mg, 0.05 mmol) and meso-tetra(N-methyl-4-pyridyl) porphine tetratosylate (TMPyP) (Frontier Scientific, 15.0 mg, 0.011 mmol) were added to DMF (2.0 mL) and H₂O (0.4 mL) in a 7.0 mL scintillation vial and heated at 85° C. for 12 hrs. The reaction mixture was cooled to room temperature and dark prism crystals of Por@MOM-12 were harvestedand washed with methanol. Crystals of Por@MOM-12 were characterized by thermogravimetric analysis (Perkin Elmer STA 6000) and powder x-ray diffraction (a Bruker D8 Advance X-ray diffractometer at 20 kV, 5 mA for Cu_{kR} (λ=1.5418 Å)). When this reaction was conducted under the same conditions but in the absence of TMPyP, prism colorless crystals of different PXRD pattern to Por@MOM-12 were obtained.

D. Crystal Structure of Por@MOM-12

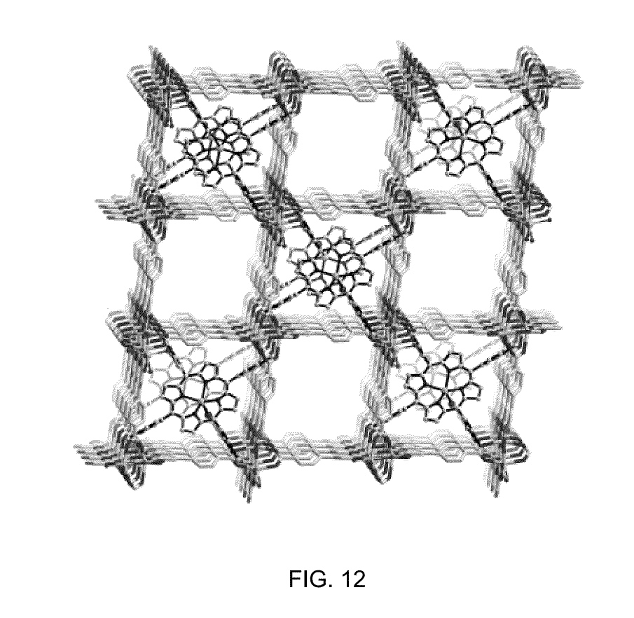

Crystallographic data were collected on a single crystal of Por@MOM-12 using a Bruker-AXS SMART APEX/CCD diffractometer and Cu_{kα} radiation (λ=1.5418 Å, T=100(2) K). Data integration and reduction were performed using SaintPlus 6.01. Absorption correction was performed by multi-scan method implemented in SADABS. Space group was determined using XPREP implemented in APEX2. The crystal structure was solved using SHELXS-97, expanded using Fourier methods and refined on F² using nonlinear least-squares techniques with SHELXL-97 contained in APEX2 and WinGX v1.70.01 program packages. Single crystal x-ray diffraction (SCXRD) reveals that por@MOM-12 is an anionic framework encapsulating cationic porphyrins in alternatingchannels (FIG. 12). FIG. 12 illustrates how the framework of por@MOM-12 contains two crystallographically independent Cd atoms (Cd1 and Cd2). Cd1 exhibits pentagonal bipyramidal geometry via coordination to five carboxylate moieties, two of which are bidentate. Cd2 adopts distorted octahedral coordination geometry through six carboxylate oxygen atoms from five carboxylate moieties, one of which is bidentate. Cd—O bond distances range from 2.241(4) Å to 2.598(4) Å, which is consistent with expected values. Both Cd1 and Cd2 exist as dimers that in effect serve as 6-connected molecular building blocks (MBBs), [Cd₂(COO)₆]²⁻. These MBBs serve as 6-connected nodes that are linked by 3-connected BPT³⁻ ligands to afford a (3,6)-connected rtl topology net.

### Example 13

### Templated Synthesis of POR@MOM-13

A. Reaction with Porphyrin as Template

| Cd(NO₃)₂ | | |
|---|---|---|
| 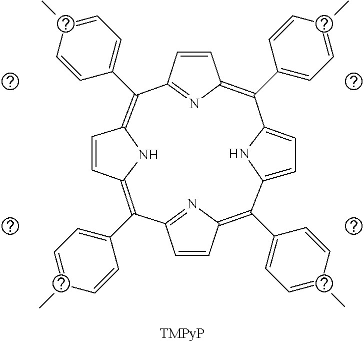 | 2.0 mL DMF 0.4 mL H₂O 85° C. → | Por@MOM-13 [Cd₄(TPT)₄] · [C₄₄H₃₆N₈Cd] · [solvent] Crystal system = Monoclinic Space group = P21/c a = 14.050(2)Å; b = 20.156(3)Å; c = 20.378(3)Å; α = γ = 90.00°; β = 101.717(6)°; V = 5650.6(14)Å³ |
| 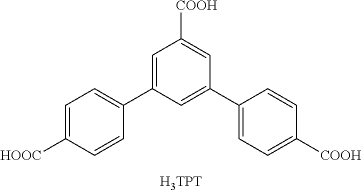 [SMILES: O=C(O)c1ccc(-c2cc(C(=O)O)cc(-c3ccc(C(=O)O)cc3)c2)cc1 ; "H3TPT"] | | |

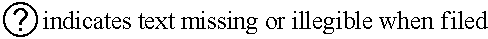

B. Reaction without Porphyrin

| Cd(NO₃)₂ | | |
|---|---|---|
| 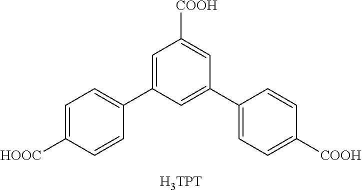 [SMILES: O=C(O)c1ccc(-c2cc(C(=O)O)cc(-c3ccc(C(=O)O)cc3)c2)cc1 ; "H3TPT" ; "HH3"] | 2.0 mL DMF 0.4 mL H₂O 85° C. → | Prism colorless crystals of a compound that exhibits a different PXRD pattern to that of Por@MOM-13 were obtained. |

C. Procedure for Preparation of Por@MOM-13

Cd(NO₃)₂.4H₂O (Fisher Scientific, 15.4 mg, 0.05 mmol), [1,1′:3″,1″-Terphenyl]-4,4″,5″-tricarboxylate(H₃TPT) (Fisher Scientific, 20.0 mg, 0.05 mmol) and meso-tetra(N-methyl-4-pyridyl) porphine tetratosylate (TMPyP) (Frontier Scientific, 15.0 mg, 0.011 mmol) were added to DMF (2.0 mL) and H₂O (0.4 mL) in a 7.0 mL scintillation vial and heated at 85° C. for 12 hrs. The reaction mixture was cooled to room temperature and dark prism crystals of Por@MOM-13 were harvested and washed with methanol. Crystals of Por@MOM-13 were characterized by thermogravimetric analysis (Perkin Elmer STA 6000) and powder x-ray diffraction (a Bruker D8 Advance X-ray diffractometer at 20 kV, 5 mA for Cu_{kR} (λ=1.5418 Å)). When this reaction was conducted under the same conditions but in the absence of TMPyP, prism colorless crystals of different PXRD pattern to Por@MOM-13 were obtained.

D. Crystal Structure of Por@MOM-13

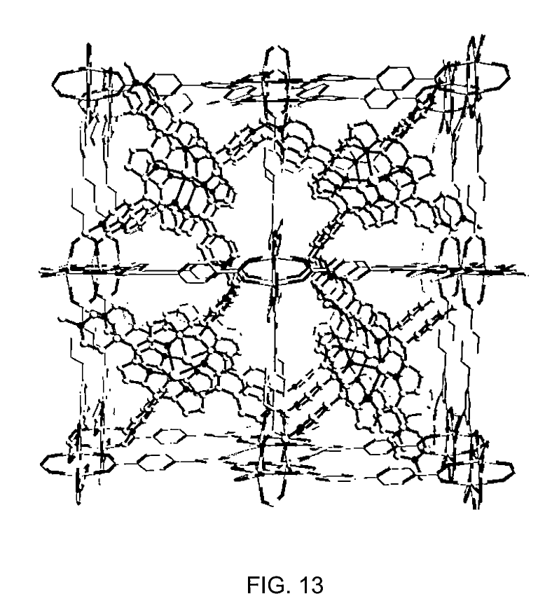

X-ray data were collected for a single crystal of Por@MOM-13 on a Bruker-AXS SMART APEX/CCD diffractometer using Cu_{kα} radiation (λ=1.5418 Å, T=100(2) K). Data integration and reduction were performed using SaintPlus 6.01. Absorption correction was performed by multi-scan method implemented in SADABS. Space group was determined using XPREP implemented in APEX2. The crystal structure was solved using SHELXS-97, expanded using Fourier methods and refined on F² using nonlinear least-squares techniques with SHELXL-97 contained in APEX2 and WinGX v1.70.01 program packages. Single crystal x-ray diffraction (SCXRD) reveals that por@MOM-13 is an anionic framework encapsulating cationic porphyrins in all channels (FIG. 13). Por@MOM-13 contains one crystallographically independent Cd atomwhich exhibits pentagonal bipyramidal geometry via coordination to five carboxylate moieties, two of which are bidentate. Each Cd exists as dimers that in effect serve as 6-connected molecular building blocks (MBBs), [Cd₂(COO)₆]². These MBBs serve as 6-connected nodes that are linked by 3-connected TPT³⁻ ligands to afford a (3,6)-connected rtl topology net.

### Example 14

### Templated Synthesis of POR@MOM-14

A. Reaction with Porphyrin as Template

| Zn(NO₃)₂ | | |
|---|---|---|
| 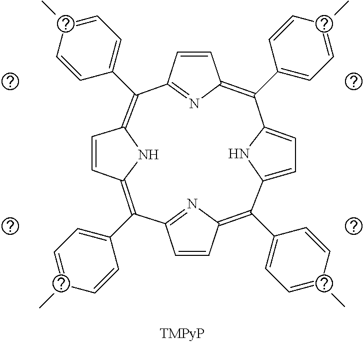 | 2.0 mL DMF 0.4 mL H₂O 85° C. → | Por@MOM-14 [Zn₆(BPT)₄(COO)₄] · [C₄₄H₃₆N₈Zn] · [solvent]Crystal system = Triclinic Space group = P-1 a = 10.1841(12)Å; b = 20.701 (3)Å; c = 20.951 (3)Å; α = 88.105(3)°; β = 76.861(3)°; γ = 81.722(3)°; V = 4256.5(10)Å³ |
| 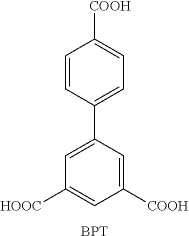 | | |

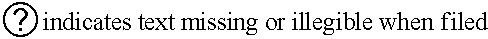

B. Procedure for Preparation of Por@MOM-14

Zn(NO₃)₂.6H₂O(Fisher Scientific, 29.7 mg, 0.10 mmol), biphenyl-3,4′,5-tricarboxylate (H₃BPT) (Fisher Scientific, 14.8 mg, 0.05 mmol) and meso-tetra(N-methyl-4-pyridyl) porphine tetratosylate (TMPyP) (Frontier Scientific, 10.0 mg, 0.0073 mmol) were added to DMF (2.0 mL) and H₂O (0.4 mL) in a 7.0 mL scintillation vial and heated at 85° C. for 24 hrs. The reaction mixture was cooled to room temperature and dark-red needle-like crystals of Por@MOM-14 were harvested and washed with methanol.

C. Crystal Structure of Por@MOM-14

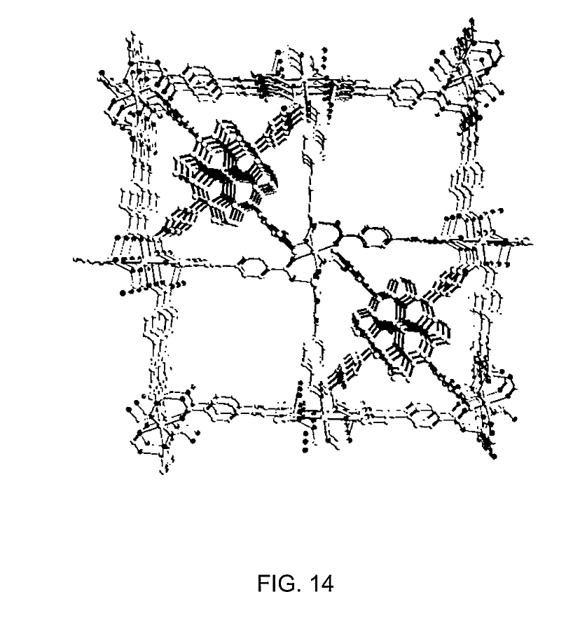

Data were collected for a single crystal of Por@MOM-14 at the Advanced Photon Source on beamline 151D-C of ChemMatCARS Sector 15(λ=0.40663 Å, T=100(2) K). The crystal structure was solved using SHELXS-97, expanded using Fourier methods and refined on F² using nonlinear least-squares techniques with SHELXL-97 contained in APEX2 and WinGX v1.70.01 program packages. The framework of Por@MOM-14 contains two independent Zn(II) cations which form a 6-connected trimetallic molecular building block (MBB), [Zn₃(COO)₈]²⁻. These MBBs are linked by 3-connected BPT ligands to form a 3,6-connected rtl network. Projecting the structure along the a axis (FIG. 14) reveals that there is a 1:1 ratio of two types of square channels, which are occupied by solvent molecules and ZnTMPyP cations respectively.

### Example 15

### Templated Synthesis of Por@MOM-15

A. Reaction with Porphyrin as Template

| ZnCl₂ | | |
|---|---|---|
| 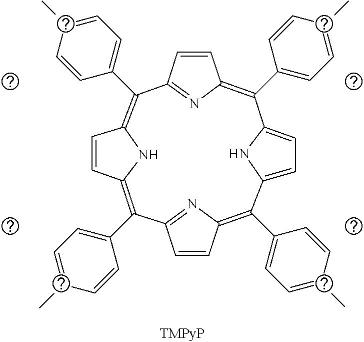 | 2.0 mL DMA 0.4 mL H₂O 85 C. → | Por@MOM-15 [Zn₆(BPT)₄(COO)₄] · [C₄₄H₃₆N₈Zn] · [solvent]Crystal system = Triclinic Space group = P-1 a = 9.288(3)Å; b = 27.370(8)Å; c = 28.665(8)Å; α = 86.759(6)°; β = 81.697(6)°; γ = 84.624(6)°; V = 7172(4)Å³ |
| 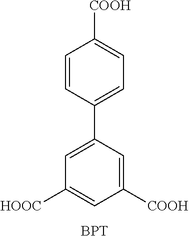 | | |

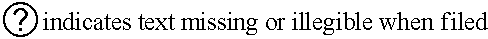

B. Procedure for Preparation of Por@MOM-15

ZnCl₂(Fisher Scientific, 29.7 mg, 0.10 mmol), biphenyl-3,4′,5-tricarboxylate (H₃BPT) (Fisher Scientific, 14.8 mg, 0.05 mmol) and meso-tetra(N-methyl-4-pyridyl) porphine tetratosylate (TMPyP) (Frontier Scientific, 10.0 mg, 0.0073 mmol) were added to DMA (2.0 mL) and H₂O (0.4 mL) in a 7.0 mL scintillation vial and heated at 85° C. for 24 hrs. The reaction mixture was cooled to room temperature and dark-red prism crystals of Por@MOM-15 were harvested and washed with methanol.

C. Crystal Structure of Por@MOM-15

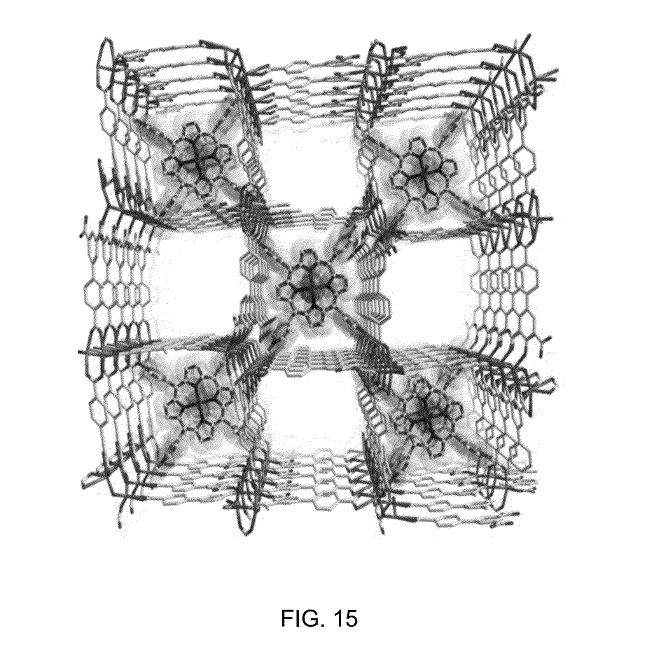

Data were collected for a single crystal of Por@MOM-15 at the Advanced Photon Source on beamline 151D-C of ChemMatCARS Sector 15(λ=0.40663 Å, T=100(2) K). The crystal structure was solved using SHELXS-97, expanded using Fourier methods and refined on F² using nonlinear least-squares techniques with SHELXL-97 contained in APEX2 and WinGX v1.70.01 program packages. The framework of Por@MOM-15 contains two molecular building blocks: five-connected [Zn₂(OH)(COO)₅]²⁻ and six-connected [Zn₂(COO)₆]²⁻. These MBBs are linked by 3-connected BPT ligands to form a 3,5-connected network. Projecting the structure along the a axis (FIG. 15) reveals that there is a 1:1 ratio of two types of square channels, which are occupied by solvent molecules and ZnTMPyP cations, respectively.

### Example 16

### Templated synthesis of Por@MOM-16

A. Reaction with Porphyrin as Template

| ZnCl₂ | | |
|---|---|---|
| 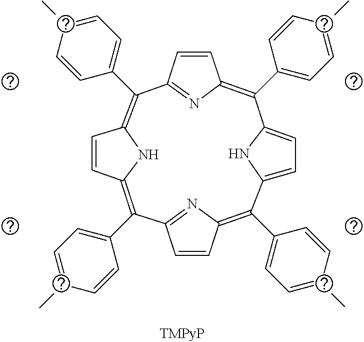 | 2.0 mL DMF 0.4 mL H₂O 85° C. → | Por@MOM-16 [Zn₄(2,6- NDC)₆] · [C₄₄H₃₆N₈Zn] · [solvent]Crystal system = Triclinic Space group = P-1 a = 10.294(4)Å; b = 19.495(8)Å; c = 20.640(8)Å; α = 108.767(7)°; β = 96.323(9)°; γ = 95.328(10)°; V = 3862(3)Å³ |
| 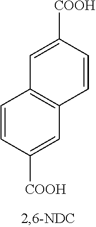 [SMILES: O=C(O)c1ccc2cc(C(=O)O)ccc2c1] | | |

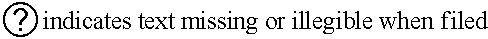

B. Procedure for Preparation of Por@MOM-16

ZnCl₂ (Fisher Scientific, 29.7 mg, 0.10 mmol), 2,6-naphthalene dicarboxylic acid (Fisher Scientific, 10.8 mg, 0.05 mmol) and meso-tetra(N-methyl-4-pyridyl) porphine tetratosylate (TMPyP) (Frontier Scientific, 10.0 mg, 0.0073 mmol) were added to DMF (2.0 mL) and H₂O (0.4 mL) in a 7.0 mL scintillation vial and heated at 85° C. for 24 hrs. The reaction mixture was cooled to room temperature and dark-red prism crystals of Por@MOM-16 were harvested and washed with methanol.

C. Crystal Structure of Por@MOM-16

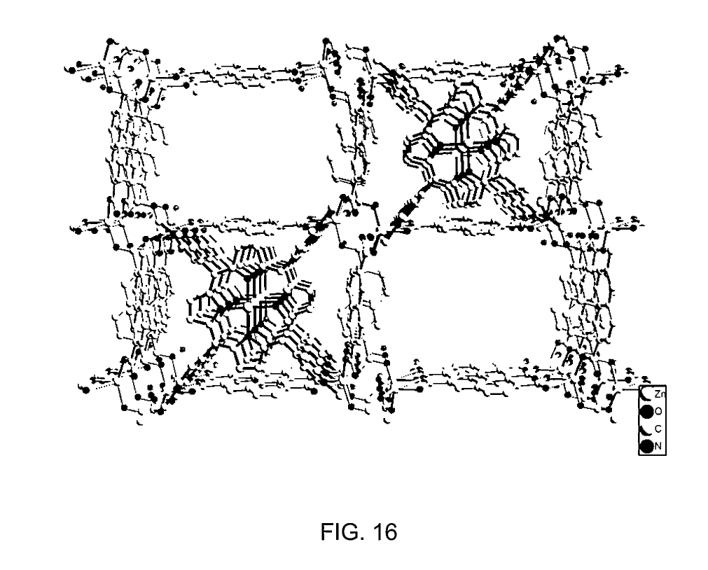

Data were collected for a single crystal of Por@MOM-16 on a Bruker-AXS SMART APEX/CCD diffractometer using Cu_{kα} radiation (λ=1.5418 Å, T=100(2) K). Data integration and reduction were performed using SaintPlus 6.01. Absorption correction was performed by multi-scan method implemented in SADABS. Space group was determined using XPREP implemented in APEX2. The crystal structure was solved using SHELXS-97, expanded using Fourier methods and refined on F² using nonlinear least-squares techniques with SHELXL-97 contained in APEX2 and WinGX v1.70.01 program packages. The framework reveals that Por@MOM-16 is based upon six-connected molecular building blocks of formula [Zn₂(COO)₆]²⁻. These MBBs are linked by 2-connected 2,6-NDC ligands to form a 6-connected pcu network. Projecting the structure along the a axis (FIG. 16) reveals that there is a 1:1 ratio of two types of square channel, which are occupied by solvent molecules and ZnTMPyP cations, respectively.

### Example 17

### Templated Synthesis of Por@MOM-17

A. Reaction with Porphyrin as Template

| CdCl₂ | | |
|---|---|---|
| 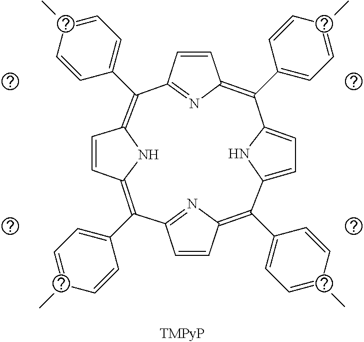 | 2.0 mL DMF 0.4 mL H₂O 85 C. → | Por@MOM-17 [Cd_{4.5}(BPT)₄Cl₄] · [C₄₄H₃₆N₈CdCl] · [solvent] Crystal system = Monoclinic Space group = P21 a = 10.294(4)Å; b = 21.763(6)Å; c = 21.183(6)Å; α = 90.00°; β = 96.273(7)°; γ = 90.00°; V = 4730(2)Å³ |
| 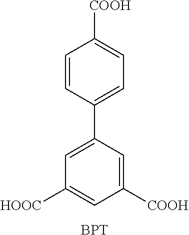 | | |

B. Procedure for Preparation of Por@MOM-17

CdCl₂(Fisher Scientific, 18.3 mg, 0.1 mmol), biphenyl-3,4′,5-tricarboxylate (H₃BPT) (Fisher Scientific, 14.8 mg, 0.05 mmol) and meso-tetra(N-methyl-4-pyridyl) porphine tetratosylate (TMPyP) (Frontier Scientific, 15.0 mg, 0.011 mmol) were added to DMF (2.0 mL) and H₂O (0.4 mL) in a 7.0 mL scintillation vial and heated at 85° C. for 12 hrs. After filtering the solid from solution, the filtrate was heated at 85° C. for 24 hrs. Prism dark-red crystals of Por@MOM-17 were harvested and washed with methanol.

C. Crystal Structure of Por@MOM-17

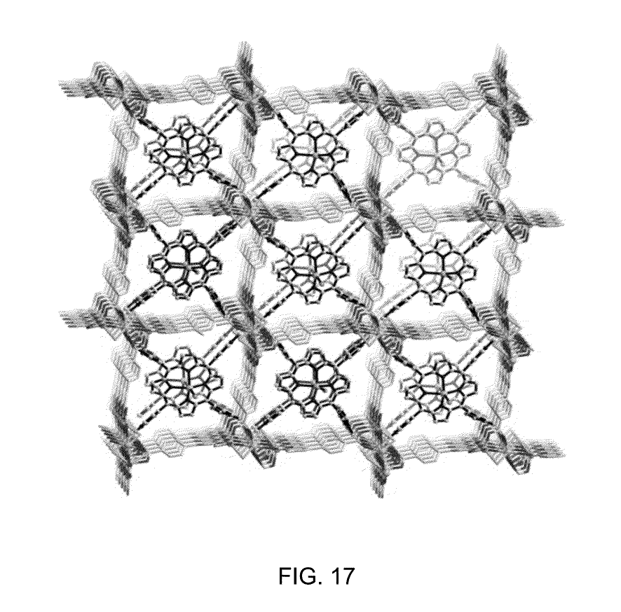

Data were collected for a single crystal of Por@MOM-17 on a Bruker-AXS SMART APEX/CCD diffractometer using Cu_{kα} radiation (λ=1.5418 Å, T=100(2) K). Data integration and reduction were performed using SaintPlus 6.01. Absorption correction was performed by multi-scan method implemented in SADABS. Space group was determined using XPREP implemented in APEX2. The crystal structure was solved using SHELXS-97, expanded using Fourier methods and refined on F² using nonlinear least-squares techniques with SHELXL-97 contained in APEX2 and WinGX v1.70.01 program packages. The framework of Por@MOM-17 is based upon six-connected building blocks of formula [Cd₃Cl₂(COO)₆]²⁻. These MBBs are linked by 3-connected BPT ligands to form a 3,6-connected rtl network. Projecting the structure along the a axis reveals that all square channels are occupied by CdTMPyP cations (FIG. 17).

### Example 18

### Templated Synthesis of Por@MOM-18

A. Reaction with Porphyrin as Template

| CoCl₂ | | |
|---|---|---|
| 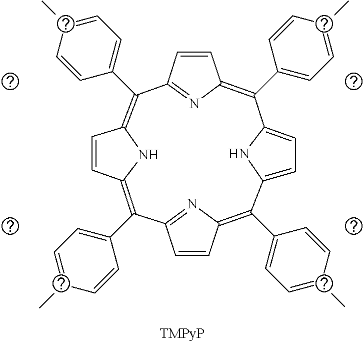 | 2.0 mL DMF 0.5 mL H₂O 85° C. → | Por@MOM-18 [Co₄(BPT)₄(solvent)₈] · [C₄₄H₃₆N₈Co] · [solvent] Crystal system = Monoclinic Space group = C2/c a = 30.984(11)Å; b = 20.524(7)Å; c = 18.948(7)Å; α = 90.00°; β = 101.818(10)°; γ = 90.00°; V = 11794(7)Å³ |
| 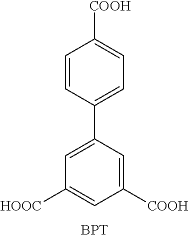 | | |

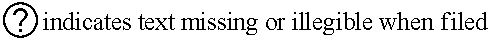

B. Procedure for Preparation of Por@MOM-18

CoCl₂.6H₂O(Fisher Scientific, 23.7 mg, 0.10 mmol), biphenyl-3,4′,5-tricarboxylate (H₃BPT) (Fisher Scientific, 14.8 mg, 0.05 mmol) and meso-tetra(N-methyl-4-pyridyl) porphine tetratosylate (TMPyP) (Frontier Scientific, 15.0 mg, 0.011 mmol) were added to a 2.5 mL solution of DMF (2.0 mL) and H₂O (0.5 mL) in a 7.0 mL scintillation vial and heated at 85° C. for 24 hrs. Prism dark-red crystals of Por@MOM-18 were harvested and washed with methanol.

C. Crystal Structure of Por@MOM-18

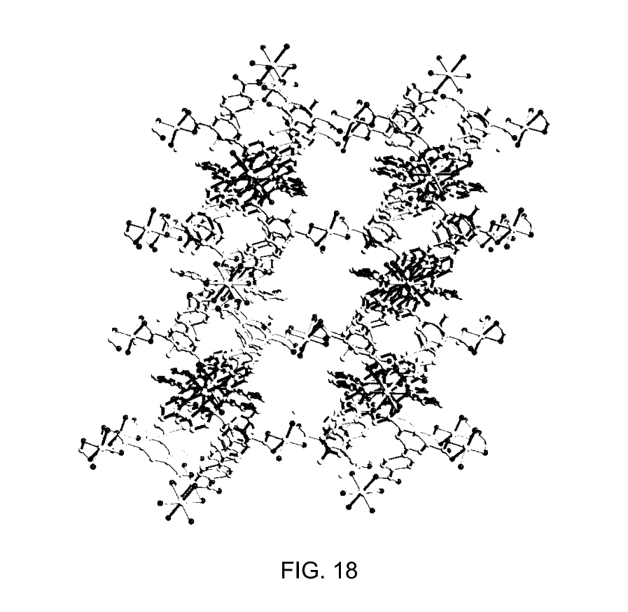

Data were collected for a single crystal of Por@MOM-18 on a Bruker-AXS SMART APEX/CCD diffractometer using Cu_{kα} radiation (λ=1.5418 Å, T=100(2) K). Data integration and reduction were performed using SaintPlus 6.01. Absorption correction was performed by multi-scan method implemented in SADABS. Space group was determined using XPREP implemented in APEX2. The crystal structure was solved using SHELXS-97, expanded using Fourier methods and refined on F² using nonlinear least-squares techniques with SHELXL-97 contained in APEX2 and WinGX v1.70.01 program packages. The framework of Por@MOM-18 contains two molecular building blocks: two-connected [Co(COO)₂(H₂O)₂]; six-connected [Co(COO)₄(H₂O)₂]²⁻. These MBBs are linked by BPT ligands to form a 6-connected pts network. FIG. 18 illustrates how CoTMPyP cations arrange in the channels along the b axis.

### Example 19

### Templated Synthesis of Por@MOM-19

A. Reaction with Porphyrin as Template

| ZnCl₂ | | |
|---|---|---|
| 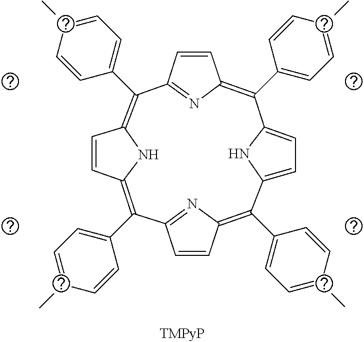 | 2.0 mL DMF 0.4 mL H₂O 85° C. → | Por@MOM-19 [Zn₄(BPT)₄(solvent)₄] · [C₄₄H₃₆N₈Zn] · [solvent] Crystal system = Tetragonal Space group = P4(2)/ncm a = b = 22.4530(3)Å; c = 42.0940(4)Å; α = β = γ = 90.00°; |
| 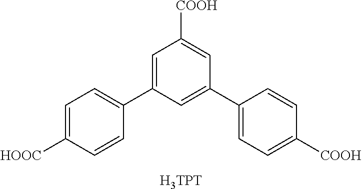 [SMILES: O=C(O)c1ccc(-c2cc(C(=O)O)cc(-c3ccc(C(=O)O)cc3)c2)cc1 ; "H3TPT"] | | |

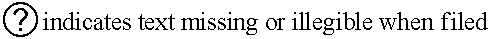

B. Procedure for Preparation of Por@MOM-19

ZnCl₂ (Fisher Scientific, 29.7 mg, 0.10 mmol), [1,1′:3′,1″-Terphenyl]-4,4″,5′-tricarboxylate(H₃TPT) (Fisher Scientific, 20.0 mg, 0.05 mmol) and meso-tetra(N-methyl-4-pyridyl) porphine tetratosylate (TMPyP) (Frontier Scientific, 15.0 mg, 0.011 mmol) were added to DMF (2.0 mL) and H₂O (0.4 mL) in a 7.0 mL scintillation vial and heated at 85° C. for 24 hrs. The reaction mixture was cooled to room temperature and black prism crystals of Por@MOM-19 were harvested and washed with methanol.

C. Crystal Structure of Por@MOM-19

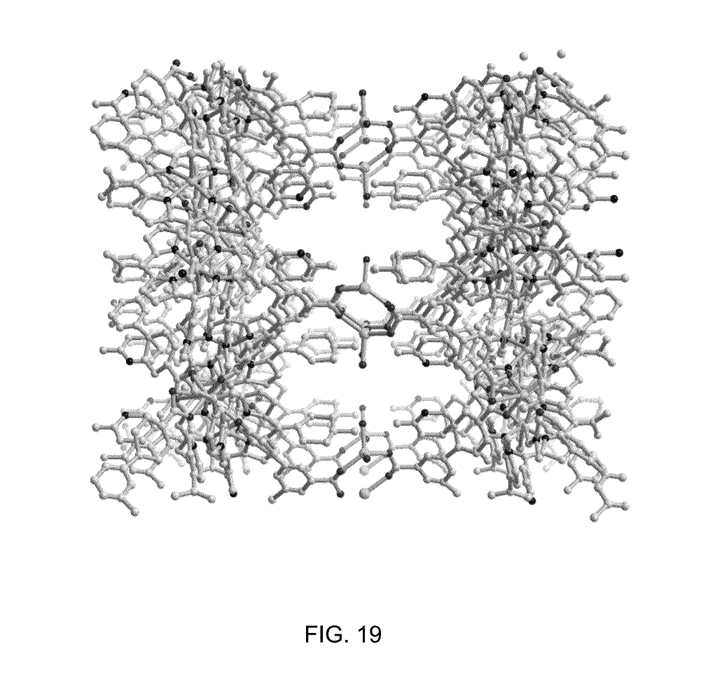

Data were collected for a single crystal of Por@MOM-19 on a Bruker-AXS SMART APEX/CCD diffractometer using Cu_{kα} radiation (λ=1.5418 Å, T=100(2) K). Data integration and reduction were performed using SaintPlus 6.01. Absorption correction was performed by multi-scan method implemented in SADABS. Space group was determined using XPREP implemented in APEX2. The crystal structure was solved using SHELXS-97, expanded using Fourier methods and refined on F² using nonlinear least-squares techniques with SHELXL-97 contained in APEX2 and WinGX v1.70.01 program packages. The framework of Por@MOM-19 contains two molecular building blocks: two-connected [Zn₂(COO)₂(H₂O)₄]²⁺ and six-connected [Zn(COO)₄]²⁻. These MBBs are linked by TPT ligands to form a 6-connected pts network. FIG. 19 illustrates how ZnTMPyP cations arrange in the channels along the b axis.

### Example 20

### Templated Synthesis of Por@MOM-20

A. Reaction with Porphyrin as Template

| CdCl₂ | | |
|---|---|---|
| 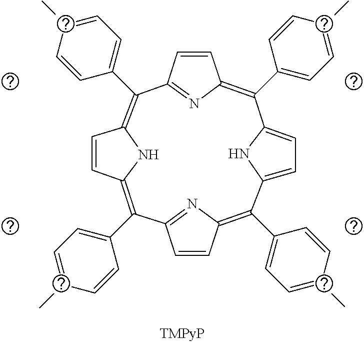 | 2.0 mL DMF 0.4 mL H₂O 85° C. → | Por@MOM-20 [Cd(BTB)₂] · [C₄₄H₃₆N₈CdCl] · [H₃O] · [solvent] Crystal system = Tetragonal Space group = Pnca a = b = 22.767(6)Å; c = 41.732(10)Å; α = β = γ = 90.00°; V = 4730(2)Å³ |
| 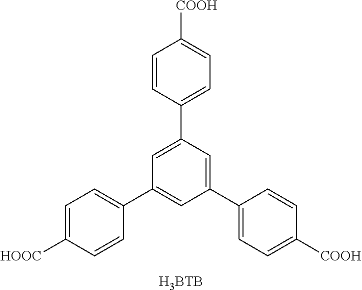 [SMILES: O=C(O)c1ccc(-c2cc(-c3ccc(C(=O)O)cc3)cc(-c3ccc(C(=O)O)cc3)c2)cc1 ; "H3BTB"] | | |

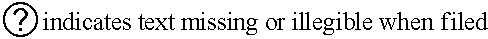

B. Procedure for Preparation of Por@MOM-20

CdCl₂ (Fisher Scientific, 36.6 mg, 0.20 mmol), H₃BTB(Fisher Scientific, 23.3 mg, 0.05 mmol) and meso-tetra(N-methyl-4-pyridyl) porphine tetratosylate (TMPyP) (Frontier Scientific, 10.0 mg, 0.0073 mmol) were added to DMF (2.0 mL) and H₂O (0.4 mL) in a 7.0 mL scintillation vial and heated at 85° C. for 12 hrs. After filtering the solid from solution, the filtrate was heated at 85° C. for 24 hrs. Black crystals of Por@MOM-20 were harvested and washed with methanol.

C. Crystal Structure of Por@MOM-20

Data were collected for a single crystal of Por@MOM-20 on a Bruker-AXS SMART APEX/CCD diffractometer using Cu_{kα} radiation (λ=1.5418 Å, T=100(2) K). Data integration and reduction were performed using SaintPlus 6.01. Absorption correction was performed by multi-scan method implemented in SADABS. Space group was determined using XPREP implemented in APEX2. The crystal structure was solved using SHELXS-97, expanded using Fourier methods and refined on F² using nonlinear least-squares techniques with SHELXL-97 contained in APEX2 and WinGX v1.70.01 program packages. The framework of Por@MOM-20 contains one four-connected molecular building block of formula [Cd(COO)₄]²⁻. Projecting the structure along the b axis reveals that CdTMPyP cations are located within the channels.

### REFERENCES

1. Meunier, B. Metalloporphyrins as versatile catalysts for oxidation reactions and oxidative DNA cleavage. Chem. Rev. 92, 1411-1456 (1992).
2. Batten, S. R., Neville, S. M. & Turner, D. R. Coordination Polymers: Design, Analysis and Application (Royal Society of Chemistry, Cambridge, UK, 2009).
3. MacGillivary, L. R. Metal Organic Frameworks (Wiley, 2010).
4. Furukawa, H. et al. Ultra-high porosity in metal-organic frameworks, Science 239, 424-428 (2010).
5. Moulton, B. & Zaworotko, M. J. From molecules to crystal engineering: Supramolecular isomerism and polymorphism in network solids. Chem. Rev. 101, 1629-1658 (2001).
6. Kitagawa, S., Kitaura, R. & Noro, S. Functional porous coordination polymers. Angew. Chem. Int. Ed. 43, 2334-2375 (2004).
7. Rosseinsky, M. J. Enlightened pores. Nature Mater. 9, 609-610 (2010).
8. Seo, J. S. et al. A homochiral metal-organic porous material for enantioselective separation and catalysis. Nature 404, 982-986 (2000).
9. Ono, K., Yoshizawa, M., Kato, T., Watanabe, K. & Fujita, M. Porphine Dimeric Assemblies in Organic-Pillared Coordination. Angew. Chem. 119, 1835-1838 (2007).
10. Perry IV, J. J., Perman, J. A. & Zaworotko, M. J. Design and synthesis of metal-organic frameworks using metal-organic polyhedra as molecular building blocks. Chem. Soc. Rev. 38, 1400-1417 (2009).
11. Chui, S. S.-Y., Lo, S. M.-F., Charmant, J. P. H., Guy Orpen, A. & Williams, I. D. A chemically functionalizable nanoporous material [Cu₃(TMA)₂(H₂O)₃]ₙ. Science 283, 1148-1150 (1999).
12. Farha, O. F., Shultz, A. M., Sarjeant, A. A., Nauyen, S. T. & Hupp, J. T. Active-site-accessible, porphyrinic metal-organic framework materials. J. Am. Chem. Soc. 133, 5652-5655 (2011).
13. Larsen, R. W. et al. Metal-organic materials that selectively encapsulate metalloporphyrins, MOMZymes: A new paradigm for heme biomimetic catalysis. J. Am. Chem. Soc. Accepted for publication May 2011.
14. Alkordi, M. H. et al. Zeolite-like metal-organic frameworks as platforms for applications: On metalloporphyrin-based catalysts. J. Am. Chem. Soc. 130, 12639-12641 (2008).
15. Lu, J. J., Mondal, A., Moulton, B. & Zaworotko, M. J. Polygons and faceted polyhedra and nanoporous networks. Angew. Cheme. Int. Ed. 40, 2113-2116 (2001).
16. Xie, L. et al. Mixed-Valence Iron (II, III) Trimesates with Open Frameworks Modulated by Solvents. Inorg. Chem. 46, 7782-7788 (2007).
17. Maniam, P. & Stock, N. Investigation of porous Ni-based metal-organic frameworks containing paddle-wheel yype inorganic building units via high-throughput methods. Inorg. Chem. DOI: 10.1021/ic200381f (2011).
18. Sun, C.-Y. et al. Highly Stable Crystalline Catalysts Based on a Microporous Metal-Organic Framework and Polyoxometalates. J. Am. Chem. Soc. 131, 1883-1888 (2009).
19. Sazou, D. et al. The use of an electrogenerated cobalt(I) porphyrin for the homogeneous catalytic reduction of dioxygen in dimethylformamide. Reactions of [(TMpyP)CoII]4+ and [(TMpyP)CoI]3+ where TMpyP=meso-tetrakis(1-methylpyridinium-4-yl)porphyrin. J. Am. Chem. Soc. 112, 7879-7886 (1990).
20. Adam, W. et al. Selective Reactions of Metal Activated Molecules (Vieweg, Braunschweig, 1992).
21. Maurya, M. R. et al. Zeolite-encapsulated copper (II) complexes of pyridoxal-based tetradentate ligands for the oxidation of styrene, cyclohexene and methyl phenyl sulfide. Eur. J. Inorg. Chem. 5720-5734 (2007).
22. Martens, J. A. et al. Simple synthesis recipes of porous materials. Micropor. Mesopor. Mater. 140, 2-8 (2011).
23. Zhao, D. et al. Triblock copolymer synthesis of mesoporous silica with periodic 50 to 300 Å pores. Science 279, 548-552 (1998).
24. Bajpe, S. R. et al. Direct observation of molecular-level template action leading to self-assembly of a porous framework. Chem. Eur. J. 16, 3926-3932 (2010).
25. Spek, A. L. Acta Cryst. A46, C34 (1990).

What is claimed is:

1. A process for the preparation of a heterocyclic macrocycle-templated supramolecular metal organic material, the process comprising preparing a mixture containing a metal, a heterocyclic macrocycle, and organic ligands and forming, in the mixture, a heterocyclic macrocycle-templated metal organic material comprising the metal, the heterocyclic macrocycle and the ligands by template-directed synthesis with the heterocyclic macrocycle serving as the template.

2. The process of claim 1 wherein the heterocyclic macrocycle is a porphyrin, a porphyrazin, a chlorin, a corrin, or a porphyrinogen.

3. The process of claim 1 wherein the heterocyclic macrocycle is a metalated porphyrin, a metalated porphyrazin, a metalated chlorin, a metalated corrin, or a metalated porphyrinogen.

4. The process of claim 1 wherein the heterocyclic macrocycle is a metalated porphyrin, a metalated porphyrazin, a metalated chlorin, a metalated corrin, or a metalated porphyrinogen and the metal coordinated by the metalated porphyrin, metalated porphyrazin, metalated chlorin, metalated corrin, or metalated porphyrinogen is Sc, Ti, V, Cr, Mn, Fe, Co, Ni, Cu, Zn, Y, Zr, Nb, Mo, Tc, Ru, Rh, Pd, Ag, Cd, Lu, Hf, Ta, W, Re, Os, Ir, Pt, Au or Hg.

5. The process of claim 1 wherein the heterocyclic macrocycle is a metalated porphyrin, a metalated porphyrazin, a metalated chlorin, a metalated corrin, or a metalated porphyrinogen and the metal coordinated by the metalated porphyrin, metalated porphyrazin, metalated chlorin, metalated corrin, or metalated porphyrinogen is selected from Co, Cd, Mn, Zn, Fe, Ni, and combinations thereof.

6. The process of claim 1 wherein the organic ligand is linear, branched or cyclic and has the capacity to coordinate at least two metals.

7. The process of claim 1 wherein the organic ligand is a linker, containing two metal coordinating groups.

8. The process of claim 1 wherein the organic ligand contains at least 3 metal coordinating groups.

9. The process of claim 1 wherein the metal coordinating groups are selected from among carboxylates, nitrogen-containing heterocycles, phenoxy groups, and combinations thereof.

10. The process of claim 1 wherein the organic ligand corresponds to Formula (1):
R₁-L₁-AL₃-R₃)ₙ (1)
wherein
A is a bond or a monocyclic ring or polycyclic ring system;
L₁ and each L₃ is a linker moiety;
n is at least 1; and
R₁ and each R₃ is independently a functional group capable of coordinately bonding to at least one metal ion.

11. The process of claim 10 wherein n is at least 2.

12. The process of claim 10 wherein R₁ and each R₃ is selected from among carboxylates, nitrogen-containing heterocycles, phenoxy groups, and combinations thereof.

13. The process of claim 10 wherein R₁ and each R₃ is selected from among —CO₂H, —CS₂H, —NO₂, —SO₃H, —Si(OH)₃, —Ge(OH)₃, —Sn(OH)₃, —Si(SH)₄, —Ge(SH)₄, —Sn(SH)₃, —PO₃H, —AsO₃H, —AsO₄H, —P(SH)₃, —As(SH)₃, —CH(SH)₂, —C(SH)₃, —CH(NH₂)₂, —C(NH₂)₂, —CH(OH)₂, —C(OH)₃, —CH(CN)₂ and —C(CN)₃, —CH(RSH)₂, —C(RSH)₃, —CH(RNH₂)₂, —C(RNH₂)₃, —CH(ROH)₂, —C(ROH)₃, —CH(RCN)₂, —C(RCN)₃, and combinations thereof wherein each R is independently an alkyl or alkenyl group having from 1 to 5 carbon atoms, or an aryl group consisting of 1 to 2 phenyl rings.

14. The process of claim 10 wherein A is a ring selected from benzene, pyridine, pryridinium, pyrimidine, pyrimidinium, triazine, triazinium, pyrylium, boroxine, diborabenzene, and triborabenzene rings.

15. The process of claim 10 wherein A is 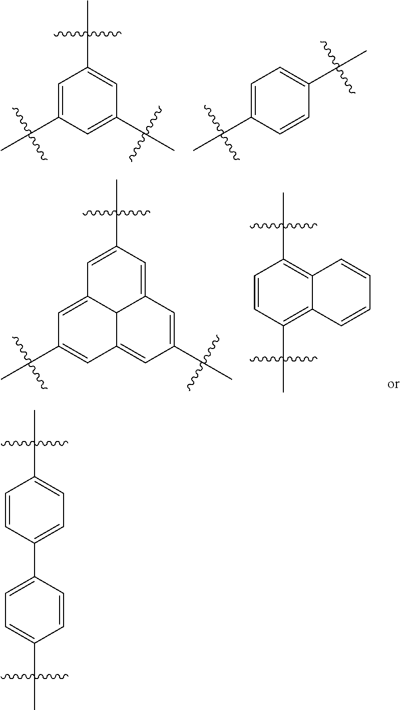 [SMILES: *c1cc(*)cc(*)c1 ; *c1ccc(*)cc1 ; *C1=CC2=CC(*)=CC3=CC(*)=CC(=C1)C23 ; *c1ccc(*)c2ccccc12 ; *c1ccc(-c2ccc(*)cc2)cc1]
and the wavy lines represent the attachment point of the A ring to the remainder of the organic ligand.

16. The process of claim 1 wherein the metal comprised by the mixture is a metal selected from Group 1, 2, 3, 4, 5, 6, 7, 8, 9, 10, 11, 12, 13, 14, 15, and 16 of the Periodic Table (according to the IUPAC Group numbering format).

17. The process of claim 1 wherein the metal comprised by the mixture is a metal selected from the group consisting of the alkali metals, alkaline earth metals, transition metals, Lanthanides, and Actinides.

18. The process of claim 1 wherein the metal comprised by the mixture is a transition metal.

19. The process of claim 1 wherein the metal comprised by the mixture is Ag⁺, Al³⁺, Au⁺, Cu²⁺, Cu⁺, Fe²⁺, Fe³⁺, Hg²⁺, Li⁺, Mn³⁺, Mn²⁺, Nd³⁺, Ni²⁺, Ni⁺, Pd²⁺, Pd⁺, Pt²⁺, Pt⁺, TI³⁺, Yb²⁺ or Yb³⁺.

20. The process of claim 1 wherein the metal comprised by the mixture is metal ion selected from the group consisting of copper, chromium, iron and zinc ions.

21. The process of claim 1 wherein the supramolecular metal organic material comprises a molecular building block selected from the group consisting of square paddle wheel, octahedral, trigonal, and octahedron molecular building blocks.

22. A process for the preparation of a heterocyclic macrocycle-templated supramolecular metal organic material comprising (i) preparing a reaction mixture containing a metalated heterocyclic macrocycle, organic ligands and a metal, the metalated heterocyclic macrocycle coordinating a first metal, (ii) forming a metalated heterocyclic macrocycle-templated supramolecular metal organic material comprising the metal, the metalated heterocyclic macrocycle and the ligands in the reaction mixture by template-directed synthesis with the metalated heterocyclic macrocycle serving as the template, and (iii) exchanging the first metal coordinated by the metalated heterocyclic macrocycle of the metalated heterocyclic macrocycle-templated supramolecular metal organic material with a second metal, the first and second metals being different.

23. The process of claim 22 wherein the heterocyclic macrocycle is a porphyrin, a porphyrazin, a chlorin, a corrin, or a porphyrinogen.

24. The process of claim 22 wherein the heterocyclic macrocycle is a metalated porphyrin, a metalated porphyrazin, a metalated chlorin, a metalated corrin, or a metalated porphyrinogen.

25. The process of claim 22 wherein the first metal is cadmium and the second metal is a transition metal.
